(19) United States
(12) Patent Application Publication
(10) Pub. No.: US 2008/0298207 A1
(43) Pub. Date: Dec. 4, 2008

(54) Reproduction Device and Reproduction Method

(75) Inventors: Yoshiyuki Teraoka, Kanagawa (JP); Tsuguhiro Abe, Chiba (JP); Tatsumi Noguchi, Kanagawa (JP); Toshimasa Aoki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SONY CORPORATION, Tokyo (JP)

(21) Appl. No.: 11/662,736

(22) PCT Filed: Jul. 14, 2006
(86) PCT No.: PCT/JP06/14065

§ 371 Date: Nov. 21, 2007

(30) Foreign Application Priority Data
Jul. 14, 2005 (JP) 2005-205441
Jul. 19, 2005 (JP) 2005-208052
Aug. 26, 2005 (JP) 2005-245681
Sep. 20, 2005 (JP) 2005-272017
Sep. 28, 2005 (JP) 2005-281437

(51) Int. Cl. G11B 7/00

(52) U.S. Cl. 369/103; G9B/7

(57) ABSTRACT

Reproduction reference light is irradiated on a hologram recording medium on which imaged digital data are recorded as a plurality of element holograms in the form of interference fringes obtained by interference between object light of the digital data and recording reference light. Then, a reproduction image obtained from the hologram recording medium by the irradiation of the reproduction reference light is detected. Then, readout data are produced based on the detected reproduction image. Thereafter, it is discriminated whether or not the readout data should be stored into a memory, and the readout data are stored into the memory in response to a result of the discrimination. Where a predetermined amount or more of the data is accumulated in the memory, reproduction data are produced from the readout data accumulated in the memory and then reproduced.

### TECHNICAL FIELD

This invention relates to a reproduction apparatus and a reproduction method for a hologram recording medium wherein object light of an image according to data and reference light interfere with each other to record data as interference fringes.

### BACKGROUND ART

A hologram recording medium is known on which various data are recorded as interference fringes of object light and reference light. Also it is known that a hologram recording medium improves the recording density remarkably and allows remarkable increase in recording capacity. It is expected that a hologram recording medium is useful as a large capacity storage medium, for example, for computer data, AV (Audio-Visual) content data such as audio data and video data and so forth.

When data is to be recorded on a hologram recording medium, the data is imaged into two-dimensional page data. Then, the imaged data is displayed on a liquid crystal panel or the like, and light transmitted through the liquid crystal panel is used as object light. Thus, the object light which is to make an image of the two-dimensional page data is irradiated upon the hologram recording medium. In addition, reference light is irradiated upon the hologram recording medium from a predetermined angle. At this time, interference fringes formed by the object light and reference light are recorded as a dot-shaped or rectangular element hologram. In other words, one element hologram is a record of one two-dimensional page data.

[Patent Document 1] Japanese Patent No. 3596174

[Patent Document 2] Japanese Patent No. 3498878

[Patent Document 3] Japanese Patent Laid-Open No. 2001-183108

[Patent Document 4] Japanese Patent Laid-Open No. 2005-173646

[Patent Document 5] Japanese Patent Laid-Open No. Hei 11-312215

### DISCLOSURE OF THE INVENTION

### Problem to be Solved by the Invention

Incidentally, a hologram memory typically having a sheet-like shape is considered. Further, a system is considered wherein computer data, AV content data or some other data is recorded on the hologram memory and a general user can use a reproduction apparatus as a hologram reader to acquire the data recorded on the hologram memory.

A hologram memory having a sheet-like shape is a recording medium wherein a large number of element holograms are recorded in a spread manner over a plane as the surface of the medium. A hologram reader is disposed in an opposing relationship to the surface of the medium such that it successively reads data recorded as the element holograms on the surface of the medium.

Where such a system as just described is considered, it is necessary to take the following items into consideration in accordance with the form of use and the system configuration of the system:
provision of the hologram reader at a low price to a user and simple and easy apparatus configuration therefor;
stable data reproduction performance of the hologram reader;
improvement in usability in reading by the hologram reader; and
assurance of a certain capacity for storage of content data and so forth as a hologram memory.

Taking the foregoing viewpoints described above into consideration, it is an object of the present invention to implement a reproduction apparatus and a reproduction method suitable for use, for example, with a system wherein a user can acquire data from a hologram recording medium.

### Means for Solving the Problems

The reproduction apparatus of the present invention is a reproduction apparatus for reproducing, from a hologram recording medium on which imaged digital data are recorded as a plurality of element holograms in the form of interference fringes obtained by interference between object light of the digital data and recording reference light. The reproduction apparatus includes reference light irradiation means configured to irradiate reproduction reference light on the hologram recording medium, readout means configured to detect a reproduction image obtained from the element holograms by the irradiation of the reproduction reference light and produce readout data based on the detected reproduction image, storage means configured to store the readout data produced by the readout means, discrimination means configured to discriminate whether or not storage of the readout data produced by the readout means into the storage means is to be permitted, reproduction data production means configured to produce reproduction data from the readout data stored in the storage means, and control means configured to control so that, where the storage of the readout data into the storage means is permitted by the discrimination means, the readout data are stored into the storage means and control the reproduction data production means to produce reproduction data from the readout data stored in the storage means.

Where it is decided by the discrimination means that the readout data are not stored in the storage means as yet, the control means controls so that the readout data are stored into the storage means.

The readout data have predetermined discrimination information applied thereto.

The discrimination means discriminates based on the discrimination information whether or not the readout data are readout data stored already in the storage means.

A user moves the reproduction apparatus to displace the relative position of the reproduction apparatus relative to the hologram recording medium so that the reproduction reference light is successively irradiated from the reference light irradiation means upon the hologram recording medium, and it is discriminated by the discrimination means whether or not the storage of the readout data produced from a reproduction image of the element hologram upon which the reproduction reference light is irradiated into the storage means is to be permitted.

The readout data include redundancy data such that different readout data can be produced based on the redundancy data of a plurality of ones of the readout data.

The reproduction apparatus further includes readout data production means configured to produce different readout data based on the redundancy data of a plurality of ones of the redundancy data stored in the storage means and write the produced readout data into the storage means.

The reproduction apparatus further includes reproduction data production means configured to produce, where it is decided that the amount of the readout data stored in the storage means exceeds a predetermined amount, reproduction data based on the readout data stored in the storage means.

The reproduction apparatus further includes readout ratio calculation means configured to calculate a ratio of the readout data stored in the storage means to the predetermined amount with which the production of the reproduction data is to be started, and a presentation means configured to perform presentation based on a result of the calculation by the readout ratio calculation means.

The reproduction apparatus further includes display means configured to display a map of the hologram recording medium, and the displaying means displays the map on which substantial positions of the readout data stored in the storage means can be discriminated.

A plurality of element holograms of the same data substance are recorded on the hologram recording medium.

The display means displays the map on which also substantial positions of the element holograms, on which the same data as the readout data are recorded, can be discriminated.

The reproduction apparatus further includes error rate comparison means configured to compare the error rate of the readout data produced by the readout means and the error rate of the readout data stored already in the storage means, and the discrimination means discriminates, based on a result of the comparison by the error rate comparison means, whether or not storage of the readout data produced by the readout means into the storage means is to be permitted.

The hologram recording medium has recorded thereon first element holograms which are formed using recording reference light irradiated at a first angle and second element holograms which are formed using recording reference light irradiated at a second angle, and the reproduction apparatus further includes reference light irradiation angle control means configured to change over the irradiation angle of the reproduction reference light by the reference light irradiation means between the first angle and the second angle, and besides the readout means detects the reproduction image obtained from the first element holograms when the reproduction reference light of the first angle is irradiated from the reference light irradiation means, but detects the reproduction image obtained from the second element holograms when the reproduction reference light of the second angle is irradiated from the reference light irradiation means.

The hologram recording medium has recorded thereon first element holograms which are formed using recording reference light irradiated at a first angle and second element holograms which are formed using recording reference light irradiated at a second angle, and the reproduction apparatus further includes notification means configured to issue a notification for urging the user to change the irradiation angle of the reproduction reference light from the reference light irradiation means to the hologram recording medium, the reference light irradiation means being configured so as to irradiate the reproduction reference light at an angle, the readout means being operable to detect the reproduction image obtained from the first element holograms when the reproduction reference light of the first angle is irradiated from the reference light irradiation means, but detect the reproduction image obtained from the second element holograms when the reproduction reference light of the second angle is irradiated from the reference light irradiation means.

The reproduction method of the present invention is a reproduction method for reproducing, from a hologram recording medium on which imaged digital data are recorded as a plurality of element holograms in the form of interference fringes obtained by interference between object light of the digital data and recording reference light, and includes a step of irradiating reproduction reference light on the hologram recording medium, a step of detecting a reproduction image obtained from the hologram recording medium by the irradiation of the reproduction reference light and producing readout data based on the detected reproduction image, a step of discriminating whether or not storage of the produced readout data into a memory is to be permitted, a step of storing the produced readout data into the memory when the storage into the memory is permitted, and a step of producing reproduction data from the readout data stored in the memory.

Where it is decided that the readout data are not stored in the memory as yet, the readout data are stored into the memory.

Where it is decided that the amount of the readout data stored in the memory exceeds a predetermined amount, reproduction data are produced based on the readout data stored in the memory.

The readout data include redundancy data such that different readout data can be produced based on the redundancy data of a plurality of ones of the readout data, and the reproduction method further includes a step of producing different readout data based on the redundancy data of a plurality of ones of the readout data stored in the memory and writing the produced readout data into the memory.

The reproduction apparatus of the present invention is a reproduction apparatus wherein reproduction reference light is irradiated on a hologram recording medium on which imaged digital data are recorded as a plurality of element holograms in the form of interference fringes obtained by interference between object light of the digital data and recording reference light, a reproduction image obtained from the hologram recording medium by the irradiation of the reproduction reference light is detected, readout data are produced based on the detected reproduction image, the readout data are stored into a memory where there is the necessity to store the produced readout data into the memory, and, where a predetermined amount or more of the data is accumulated in the memory, reproduction data are produced from the readout data accumulated in the memory and then reproduced.

A comparatively large-capacity storage media system which can provide, for example, computer data or AV content data can be implemented by successively reading out, from a hologram recording medium on which element holograms each formed from two-dimensional page data obtained by imaging data to be reproduced are recorded, the element holograms by means of the reproduction apparatus to obtain reproduction data.

Here, according to the reproduction apparatus and the reproduction method, it is determined in response to a discrimination of the discrimination means whether or not storage of readout data from each of the element holograms on a hologram recording medium into the storage means is to be permitted. For example, when readout data which is not stored in the storage means as yet is obtained, the readout data is stored into the storage means. Where readout data which is stored already in the storage means is obtained, the readout data is not stored but is, for example, abandoned. Then, at a point of time at which a predetermined amount of readout data is prepared in the storage means, reproduction data are re-constructed and produced.

This does not define the readout order of the element holograms and permits readout data of a certain element holograms to be read out in an overlapping relationship. In other words, the degree of freedom in reading out scanning of element holograms is raised, and also the degree of freedom can be raised in terms of the method of forming element holograms on a hologram recording medium.

This is preferable also to such a reproduction system that a scanning mechanism is not provided in a reproduction apparatus and a user holds and moves the reproduction apparatus on a hologram recording medium to read the element holograms.

It is to be noted that the predetermined amount mentioned hereinabove is a predetermined amount signifying that a state wherein data necessary for re-construction of reproduction data is acquired successfully, but does not necessarily signify that all element holograms on the hologram recording medium are read out. Naturally, if all element holograms on the hologram recording medium are read out, then it is considered that a predetermined amount of readout data of element holograms necessary for re-construction of reproduction data are obtained. However, in such a case that data of the same substance is recorded on a plurality of element holograms, even if readout of all element holograms is not performed, the state wherein the predetermined amount of readout data necessary for re-construction of reproduction data is obtained may be established.

### EFFECTS OF THE INVENTION

According to the present invention, there is no necessity for the reproduction apparatus side to include a precise scanning mechanism for performing reading out of element holograms of a hologram recording medium. Particularly where the user moves the reproduction apparatus in an opposing relationship to the hologram recording medium (for example, swings the reproduction apparatus leftwardly and rightwardly), the scanning mechanism is unnecessary. Consequently, the reproduction apparatus can be simplified significantly in configuration and can be provided as a small-size low-price apparatus to a user.

Further, where the reproduction apparatus includes a simple scanning mechanism or a manual scanning mechanism by a user and is moved to perform reading of a hologram recording medium, reading out of the element holograms is performed stochastically. However, by successively storing obtained readout data into the storage means and re-constructing and producing reproduction data at a point of time at which a predetermined amount of readout data is prepared, the reproduction data can be obtained appropriately.

Further, where a plurality of element holograms of data of the same substance are recorded on the hologram recording medium, the probability in reading of the data is raised, and this is suitable for enhancement of the reading performance and reduction of the reading time.

Further, where presentation of a progress situation of data reading, that is, a ratio of readout data read already, is performed by the presentation means and map display of indicating the position of each of element holograms corresponding to readout data read already is performed by the display means, improvement of the usability and efficient scanning can be promoted.

Also where data reading out is to be performed from the first and second element holograms multiplexed recorded with the recording reference lights of the first and second angles, it can be coped with by setting the angle of reproduction reference light to any of the angles corresponding to the first and second element holograms, that is, to the same angle as that of the reference light upon recording. This can be implemented without inviting complication of the apparatus configuration by changing over the light source for the reproduction reference light or requesting the user to change the angle upon scanning (for example, requesting the user to change the manner of holding of the reproduction apparatus). As a result, also increase in capacity of the hologram recording medium can be coped with.

Further, by discriminating whether or not storage of produced readout data into the storage means is to be permitted based on a result of comparison between the error rate of readout data produced by the readout means and the error rate of readout data stored already in the storage means, readout data of higher quality can be stored. As a result, reproduction data of high quality can be obtained.

Further, by producing different readout data based on redundant data (parities) of a plurality of readout data, readout data of an element hologram which is not read out as yet can be obtained. Consequently, the time required for scanning can be reduced, and rapid data acquisition from a hologram recording medium can be achieved.

From the foregoing, according to the present invention, effects of a simple and low-cost apparatus configuration of the reproduction apparatus, a stabilized data reproduction performance, assurance of a certain capacity of a hologram recording medium and efficient reading out of data from a hologram recording medium can be achieved. For example, where a system is supposed wherein hologram recording media on which computer data, AV content data or the like are recorded are distributed widely such that a general user can use a reproduction apparatus to acquire data recorded on the hologram recording medium, the system can be formed as a very preferable apparatus.

### BRIEF DESCRIPTION OF THE DRAWINGS

FIG. 1A is a view illustrating a recording and reproduction principle of a hologram memory according to an embodiment of the present invention.

FIG. 1B is a view illustrating the recording and reproduction principle of the hologram memory according to the embodiment of the present invention.

FIG. 1C is a view illustrating the recording and reproduction principle of the hologram memory according to the embodiment of the present invention.

FIG. 2 is a schematic view of an element hologram of a hologram memory of the embodiment.

FIG. 3 is a schematic view of a two dimensional image recorded on the element hologram of the embodiment.

FIG. 4A is a view illustrating an example of a manual scanning motion of a hologram reader of the embodiment.

FIG. 4B is a view illustrating an example of a manual scanning motion of the hologram reader of the embodiment.

FIG. 5 is a view illustrating an example of a manual scanning motion of the hologram reader of the embodiment.

FIG. 6 is a block diagram of a first example of a configuration of the hologram reader of the embodiment.

FIG. 7 is a flow chart of a reproduction process of the hologram reader of the embodiment.

FIG. 8A is a schematic view of a reading progress situation display of the embodiment.

FIG. 8B is a schematic view of a reading progress situation display of the embodiment.

FIG. 8C is a schematic view of a reading progress situation display of the embodiment.

FIG. 8D is a schematic view of a reading progress situation display of the embodiment.

FIG. 9 is a schematic view of an example of a hologram memory of the embodiment wherein a plurality of element holograms of the same data substance are stored.

FIG. 10 is a schematic view of an example of a hologram memory of the embodiment wherein element holograms of the same data substance are stored collectively.

FIG. 11 is a schematic view of an example of a hologram memory of the embodiment wherein element holograms of the same data substance are stored collectively.

FIG. 12 is a schematic view of an example of a hologram memory of the embodiment in which element holograms of the same data substance are stored collectively.

FIG. 13A is a view illustrating a relationship between the arrangement of element holograms and crosstalk.

FIG. 13B is a view illustrating a relationship between the arrangement of element holograms and crosstalk.

FIG. 14A is a schematic view showing imager detection positions of adjacent element holograms.

FIG. 14B is a schematic view showing an imager detection positions of adjacent element holograms.

FIG. 15 is a schematic view of an example of a hologram memory of the embodiment wherein element holograms of the same data substance are collectively recorded in a closely contacting relationship with each other.

FIG. 16 is a schematic view of an example of a hologram memory of the embodiment wherein element holograms of the same data substance are collectively recorded in a closely contacting relationship with each other.

FIG. 17 is a schematic view of an example of a hologram memory of the embodiment wherein element holograms of the same data substance are collectively recorded in a closely contacting relationship with each other.

FIG. 18 is a schematic view of an example of a hologram memory of the embodiment wherein element holograms of the same data substance are collectively recorded in a closely contacting relationship with each other.

FIG. 19 is a schematic view of an example of a hologram memory of the embodiment wherein element holograms of the same data substance are collectively recorded in a closely contacting relationship with each other.

FIG. 20A is a schematic view of a hologram memory of an embodiment which has map information storing element holograms.

FIG. 20B is a schematic view of the hologram memory of the embodiment which has map information storing element holograms.

FIG. 21A is a schematic view of an example of arrangement of map information storing element holograms of the embodiment.

FIG. 21B is a schematic view of an example of arrangement of map information storing element holograms of the embodiment.

FIG. 22A is a schematic view of an example of arrangement of map information storing element holograms of the embodiment.

FIG. 22B is a schematic view of an example of arrangement of map information storing element holograms of the embodiment.

FIG. 23 is a flow chart of a reproduction process of the hologram reader of the embodiment.

FIG. 24A is a view showing a reading map display of the embodiment.

FIG. 24B is a view showing a reading map display of the embodiment.

FIG. 25 is a schematic view of an example of a hologram memory of the embodiment on which a plurality of element holograms of the same data substance are recorded and which has map information storing element holograms.

FIG. 26 is a view illustrating map information where a plurality of element holograms of the same data substance of the embodiment are recorded.

FIG. 27 is a schematic view showing a reading map display where a plurality of element holograms of the same data substance of the embodiment are recorded.

FIG. 28 is a view illustrating a scanning motion corresponding to a reading map display where a plurality of element holograms of the same data substance of the embodiment are recorded.

FIG. 29 is a flow chart of an example of a process for executing scan marker display of the embodiment.

FIG. 30 is a schematic view of a scan marker display of the embodiment.

FIG. 31 is a block diagram of a second example of a configuration of a hologram reader of the embodiment.

FIG. 32 is a flow chart of a process including presentation by a sound output of the embodiment.

FIG. 33A is a view illustrating angle multiplexed recording on the hologram memory of the embodiment.

FIG. 33B is a view illustrating angle multiplexed recording on the hologram memory of the embodiment.

FIG. 33C is a view illustrating angle multiplexed recording on the hologram memory of the embodiment.

FIG. 34 is a schematic view of the angle multiplexed recorded hologram memory of the embodiment.

FIG. 35A is a view illustrating a reproduction motion for an angle multiplexed recorded hologram memory of the embodiment.

FIG. 35B is a view illustrating a reproduction motion for an angle multiplexed recorded hologram memory of the embodiment.

FIG. 36 is a block diagram of a third example of a configuration of the hologram reader of the embodiment.

FIG. 37 is a flow chart of a reproduction process of the hologram reader of the embodiment.

FIG. 38A is a schematic view showing a reading progress situation display of the embodiment.

FIG. 38B is a schematic view showing a reading progress situation display of the embodiment.

FIG. 38C is a schematic view showing a reading progress situation display of the embodiment.

FIG. 38D is a schematic view showing a reading progress situation display of the embodiment.

FIG. 39 is a view illustrating a reading motion with a single reference light source of the embodiment.

FIG. 40A is a view illustrating manual scanning upon reading with the single reference light source of the embodiment.

FIG. 40B is a view illustrating manual scanning upon reading by the single reference light source of the embodiment.

FIG. 41 is a flow chart of a reproduction process of the hologram reader of the embodiment where reproduction is performed with a single reference light source.

FIG. 42 is a block diagram of a fourth example of a configuration of the hologram reader of the embodiment.

FIG. 43 is a flow chart of a reproduction process of the hologram reader of the embodiment.

FIG. 44 is a view illustrating reading in of the same element hologram of the embodiment.

FIG. 45 is a schematic view where element holograms of the same substance of the embodiment are read in.

FIG. 46A is a schematic view showing an external parity block of an element hologram of the embodiment.

FIG. 46B is a schematic view showing an external parity block of an element hologram of the embodiment.

FIG. 46C is a schematic view showing an external parity block of an element hologram of the embodiment.

FIG. 46D is a schematic view showing an external parity block of an element hologram of the embodiment.

FIG. 46E is a schematic view showing a yet further external parity block of an element hologram of the embodiment.

FIG. 46F is a schematic view showing an external parity block of an element hologram of the embodiment.

FIG. 47 is a view illustrating data recorded on element holograms of the embodiment.

FIG. 48 is a view illustrating a manner of a progress of scanning where external parities are not added.

FIG. 49 is a view illustrating a manner of a progress of scanning where external parities are added.

FIG. 50 is a block diagram of a fifth example of a configuration of the hologram reader of the embodiment.

FIG. 51 is a flow chart of a reproduction process of the hologram reader of the embodiment.

FIG. 52 is a flow chart of a decoding process of the embodiment.

FIG. 53 is a view illustrating the decoding process of the embodiment.

FIG. 54 is a flow chart illustrating a decoding process wherein external parities of the embodiment are used.

FIG. 55A is a view illustrating a scanning time reduction effect of the embodiment.

FIG. 55B is a view illustrating a scanning time reduction effect of the embodiment.

### BEST MODE FOR CARRYING OUT THE INVENTION

In the following, a hologram reader and action of the hologram reader as an embodiment of a reproduction apparatus and a reproduction method of the present invention are described. The description is given in the following order.

[1. Recording and Reproduction of the Hologram Memory]

[2. First Example of a Configuration of the Hologram Reader and a Reproduction Process Including Reading Progress Situation Display]

[3. Arrangement and Configuration of Element Holograms]

[4. Reproduction Process Including Map Display]

[5. Second Example of a Configuration of the Hologram Reader and a Reproduction Process Including Reading Progress Situation Sound Presentation]

[6. Angle Multiplexed Recording and Reproduction of the Hologram Memory]

[7. Third Example of a Configuration of the Hologram Reader and a Reproduction Process for Angle Multiplexed Recording]

[8. Fourth Example of a Configuration of the Hologram Reader and a Reproduction Process Including a Mixing Strategy]

[9. Fifth Example of a Configuration of the Hologram Reader and a Reproduction Process Including an External Parity Process]

[1. Recording and Reproduction of the Hologram]

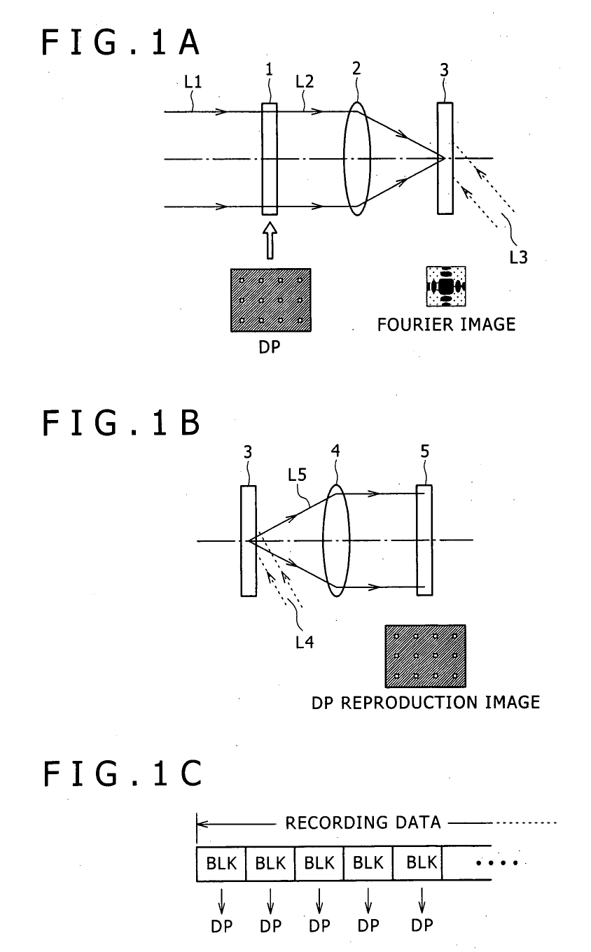

First, a basic recording and reproduction action of a hologram memory 3 is described with reference to FIGS. 1A to 1C.

FIG. 1A illustrates a manner of data recording on the hologram memory 3.

Upon recording, in addition to a liquid crystal panel 1 and a condenser lens 2, a light source and required optical system elements not shown are disposed as a recording optical system. Further, reference light for recording (hereinafter referred to as recording reference light L3) is irradiated in a predetermined angular state upon the hologram memory 3.

For example, where recording data such as, for example, audio/video content data or a computer program are to be recorded on the hologram memory 3, the recording data are divided into data blocks BLK of a predetermined byte as a unit of one two-dimensional page data (two-dimensional image DP) as seen in FIG. 1C. Then, data of each of the data blocks BLK is encoded into one two-dimensional image DP.

It is to be noted that, to the two-dimensional image DP produced from each data block BLK, address information for identifying the data block BLK such as a data block number, a data size of the data block, a data name of the entire recorded data, a data size, a number of data blocks obtained by the division, a data attribute (data type, modulation method, compression method and so forth) and so forth are added as header information. In short, the data of each data block BLK is converted into a two-dimensional image DP after header information including the various kinds of information mentioned above is added thereto.

As seen in FIG. 1A, the two-dimensional image DP is displayed on the liquid crystal panel 1.

A laser beam L1 outputted from a predetermined light source and converted typically into parallel light is transmitted through the liquid crystal panel 1 on which the two-dimensional image DP is displayed so that it is converted into object light L2 as an image of the two-dimensional image DP.

The object light L2 is condensed by the condenser lens 2 and focused as a spot on the hologram memory 3.

At this time, the recording reference light L3 is irradiated at a predetermined angle upon the hologram memory 3. Consequently, the object light L2 and the reference light L3 interfere with each other, and an interference fringe of them is recorded as a dot-shaped element hologram.

It is to be noted that, where the condenser lens 2 is used in this manner, data recorded as an element hologram becomes a Fourier image of the image of the recording data by a Fourier conversion action of the condenser lens 2.

An element hologram is recorded on the hologram memory 3 in this manner. In this instance, data of each of the data blocks BLK which form the recorded data of FIG. 1C is converted similarly into a two-dimensional image DP and displayed on the liquid crystal panel 1 so that it is recorded individually as an element hologram.

Upon recording of each element hologram, the position of the hologram memory 3 (hologram material) is fed (or the recording optical system is fed) by a feed mechanism not shown so that the recording position of an element hologram is successively displaced a little on the plane of the hologram memory 3. Consequently, recording is performed such that a large number of element holograms are disposed in the direction of the plane of the hologram memory 3 on the hologram memory 3 which is, for example, in the form of a sheet.

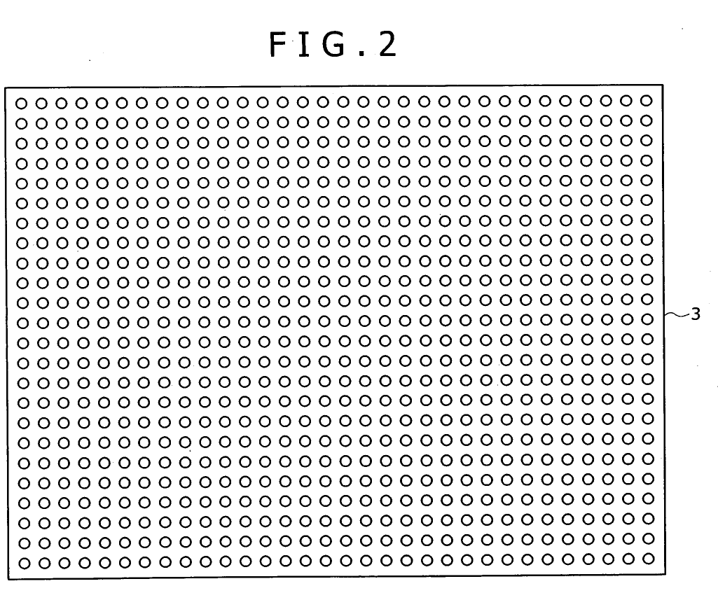

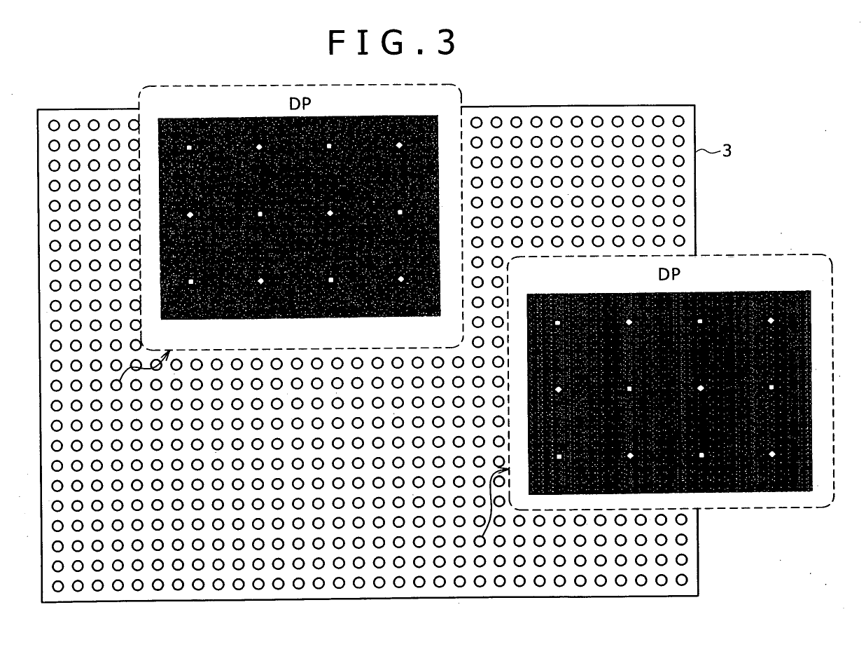

For example, in FIG. 2, one element hologram is represented by ◯, and a large number of element holograms are formed on the plane in this manner.

FIG. 2 shows an example wherein 32 element holograms are disposed in a horizontal direction and 24 element holograms are disposed in a vertical direction on the plane of the hologram memory 3. On each element hologram, for example, a two-dimensional image DP of 512×384 picture elements (pixels) is recorded as seen in FIG. 3.

The hologram memory 3 on which element holograms are recorded in such a manner as described above is reproduced in such a manner as seen in FIG. 1B. A collimator lens 4 and an imager 5 shown in FIG. 1B are provided in a reproduction apparatus as a hologram reader.

Reproduction reference light L4 is irradiated at an irradiation angle equal to that upon recording on the hologram memory 3. When the reproduction reference light L4 is irradiated, a reproduction image recorded as an element hologram is obtained. In short, an image of two-dimensional page data appears at a place conjugate with that of the liquid crystal panel 1 upon recording. This may be read by the imager 5.

In particular, reproduction image light L5 from the hologram memory 3 is converted into parallel light by the collimator lens 4 and enters the imager 5 which is formed, for example, from a CCD image pickup element array, a CMOS image pickup element array or the like. A Fourier image on the hologram memory 3 is inverse Fourier transformed into an image of two-dimensional page data, and therefore, a reproduction image as the two-dimensional image DP is read by the imager 5.

The imager 5 generates a reproduction image signal as an electric signal corresponding to the reproduction image. The reproduction image signal is subject to a decoding process so that original data, that is, data before conversion into the two dimensional data for recording, are obtained.

By successively performing data reading out similarly from the large number of element holograms on the hologram memory 3, the recorded original content data or the like can be reproduced.

The hologram memory 3 on which data are recorded as element holograms as described above can be duplicated in a mass readily by copying by close contact.

Accordingly, the hologram memory 3 having element holograms recorded on a hologram material in such a manner as seen in FIG. 1A may be used as it is as a hologram memory to be provided to a general user. However, the hologram memory 3 may otherwise be used as a master medium for use to duplicate a large number of hologram memories by copying by close contact.

For example, where a system is supposed wherein hologram recording media on which computer data, AV content data or the like are recorded are distributed widely such that a general user can use a reproduction apparatus (hologram reader 6 hereinafter described) to acquire data recorded on the hologram memory 3, it is suitable to produce a hologram master medium in such a manner as seen in FIG. 1A and distribute hologram memories duplicated from the master medium such that the data are read out by operation of FIG. 1B by the user side.

Further, the hologram memory 3 itself may be sold and provided in the form of a package medium such as a CD or a DVD which is distributed generally at present as a providing medium of computer data, AV content data and so forth to a user. Or the hologram memory 3 may be adhered or formed by printing on a poster or a book such that a user can acquire various data and so forth using a hologram reader.

A hologram reader 6 as a reproduction apparatus of the present embodiment hereinafter described performs scanning of irradiating the reproduction reference light L4 on the hologram memory 3 to successively read the element holograms. As the method for scanning, a manual scanning method in which scanning is executed by a user and an automatic scanning method in which scanning is executed mechanically by the hologram reader 6 are available.

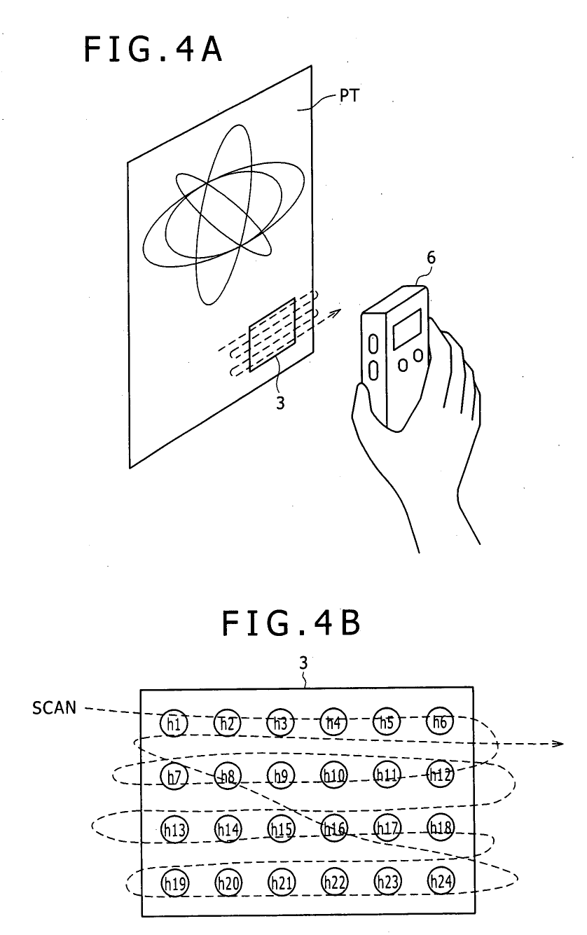

An example of the manual scanning method is illustrated in FIGS. 4A and 4B. In FIG. 4A, a state wherein the hologram memory 3 on which data such as audio content data are recorded is adhered to a poster PT or the like is shown. The hologram reader 6 is formed as an apparatus which is so small and light that it can be grasped by a hand of the user. A light source for outputting such reproduction reference light L4 as described above and a lens system for fetching reproduction image light from the hologram memory 3 are formed on one face of a housing of the hologram reader 6.

The user would hold and operate the hologram reader 6 in such a manner as seen in the figure such that one face side of the housing of the hologram reader 6 is positioned in the proximity of and in an opposing relationship to the hologram memory 3 and then swing the hologram reader 6 in an arbitrary direction. At this time, a reproduction image of element holograms on which the reproduction reference light L4 is successively irradiated at a predetermined angle is successively read by the hologram reader 6.

It is to be noted that, although FIG. 4A illustrates a manner in which the hologram reader 6 is swung leftwardly or rightwardly by the user while the hologram reader 6 is spaced away from the hologram memory 3, also another scanning method may possibly be used. In particular, the hologram reader 6 may be swung upwardly, downwardly, leftwardly or rightwardly in a state wherein part of the housing of the hologram reader 6 is held in contact with the surface of the hologram memory 3, that is, in a sliding manner.

FIG. 4B schematically shows the hologram memory 3 on which a large number of element holograms h1, h2, . . . , h24 are recorded. If the user arbitrarily swings the hologram reader 6, for example, leftwardly and rightwardly, then the locus of the reading out scanning on the hologram memory 3 (locus of a spot of the reproduction reference light L4) may be such as indicated by a broken line in FIG. 4B.

Since it is quite indefinite in what manner the user actually moves the hologram reader 6, the spot of the reproduction reference light L4 is irradiated quite irregularly and unstably on the element holograms on the hologram memory 3. In this state, a reproduction image of element holograms upon which the spot of the reproduction reference light L4 is irradiated is read successively by the hologram reader 6. In other words, reading out of the element holograms h1, h2, . . . , h24 is performed stochastically. The element holograms read by the hologram reader 6 are successively decoded and cumulatively stored in the read order as readout data by the hologram reader 6 side. Then at a point of time when a required amount of readout data is decoded successfully, the hologram reader 6 may re-construct the reproduction data.

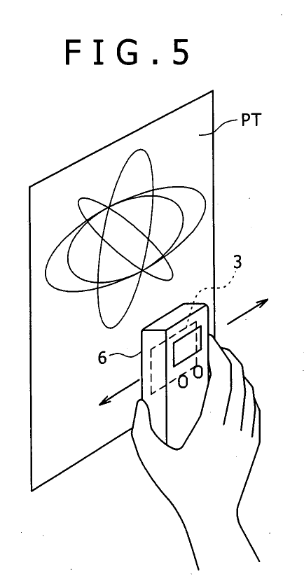

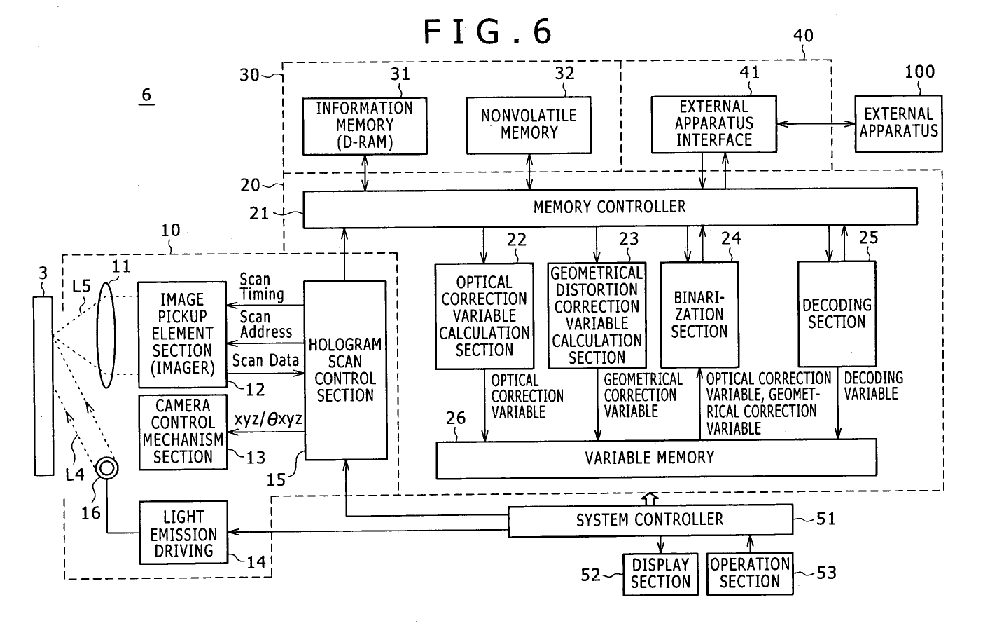

On the other hand, in the automatic scanning method, the element holograms on the hologram memory 3 are successively read by the hologram reader 6 in such a manner that the irradiation position of the reproduction reference light L4 is moved or a unit which holds the collimator lens 4 and the imager 5 thereon is moved, for example, by action of an internal scanning mechanism. For example, automatic scanning may be performed in a state wherein the hologram reader 6 is opposed to the hologram memory 3 adhered to a poster or the like as seen in FIG. 5. In this instance, only it is necessary for the user to merely keep the hologram reader 6 in front of the hologram memory 3. Thus, the irradiation position of the reproduction reference light L4 and the lens system are moved by the scanning mechanism to perform scanning of the element holograms on the hologram memory 3.

Or, for example, a medium wherein a sheet as the hologram memory 3 is adhered to a substrate section in the form of a card may be formed and loaded into the hologram reader 6 such that scanning action is performed in the hologram reader 6 to successively read the element holograms.

[2. First Example of a Configuration of the Hologram Reader and a Reproduction Process Including Reading Progress Situation Display]

A first example of a configuration as an example of a configuration of the hologram reader 6 of the embodiment is described with reference to FIG. 6.

The hologram reader 6 includes four blocks of an image pickup section 10, a signal processing section 20, a memory section 30 and an external apparatus IF section 40. The blocks mentioned individually perform required action under the control of a system controller 51.

The system controller 51 is formed typically from a microcomputer and controls the components of the hologram reader 6 in order to execute action to read data from the hologram memory 3.

Further, the system controller 51 supervises operation information of an operation section 53 and performs necessary control in response to an operation of the operation section 53 by the user.

Furthermore, the system controller 51 controls a display section 52 to display various kinds of information to be presented to the user.

The display section 52 is formed from a liquid crystal display unit provided, for example, on the housing of the hologram reader 6 and a driving circuit for the liquid crystal display panel, and performs display of an action state or a reading out situation under the display control of the system controller 51. For example, as the display of the reading out situation, progress situation display of indicating by what percent reading of recorded data such as content data is completed while the manual scanning described above is performed or display of a position presentation image (map image) which indicates the position of an element hologram with regard to read out data is performed.

The image pickup section 10 is a block for picking up a two-dimensional image reproduced from an element hologram of the hologram memory 3. The image pickup section 10 includes a collimator lens 11, an image pickup device section (imager) 12, a camera control mechanism section 13, a light emission driving section 14, a hologram scan control section 15, and a reference light source 16.

The collimator lens 11 and the image pickup device section 12 correspond to the collimator lens 4 and the imager 5 described hereinabove with reference to FIG. 1B, respectively. The image pickup device section 12 is an apparatus which detects a two-dimensional image and is formed from a CMOS image sensor, a CCD image sensor or the like.

The camera control mechanism section 13 is an apparatus for controlling the positional relationship between the image pickup device section 12 (or reference light source 16) and the hologram memory 3 and has a function of controlling a movable section manually or automatically. It is to be noted that, where such a manual scanning system as described hereinabove with reference to FIGS. 4A, 4B and 5 is adopted, the camera control mechanism section 13 is not required.

The reference light source 16 is disposed on the housing of the hologram reader 6 such that it irradiates reproduction reference light L4 upon the hologram memory 3 at an angle equal to that of the recording reference light L3 upon recording illustrated in FIGS. 1A to 1C. The reference light source 16 which is formed from, for example, an LED (light emitting diode) or a semiconductor laser, it is driven by the light emission driving section 14 to emit light. When reproduction of the hologram memory 3 is performed by the hologram reader 6, the light emission driving section 14 drives the reference light source 16 to emit light in accordance with an instruction of the system controller 51.

The hologram scan control section 15 determines an image pickup timing and a readout pixel in hologram scanning based on a state of a two-dimensional image read from the image pickup device section 12 and a scanning situation till then stored in a variable memory 26 hereinafter described. Then, the hologram scan control section 15 provides a scanning timing signal and a scanning address signal to the image pickup device section 12 to control image pickup action of the image pickup device section 12. Further, the hologram scan control section 15 processes a two-dimensional image signal obtained by the image pickup device section 12.

The signal processing section 20 is a block for performing signal processes for a series of two-dimensional images picked up by the image pickup section 10. The signal processing section 20 includes a memory controller 21, an optical correction variable calculation section 22, a geometrical distortion correction variable calculation section 23, a binarization section 24, a decoding section 25, and a variable memory 26.

The memory controller 21 performs arbitration in writing/reading out of data into/from the memory section 30 among the hologram scan control section 15, optical correction variable calculation section 22, geometrical distortion correction variable calculation section 23, binarization section 24 and decoding section 25.

The optical correction variable calculation section 22 detects a luminance dispersion state within a two-dimensional image and determines an optical correction variable.

The geometrical distortion correction variable calculation section 23 detects geometrical distortion within a two-dimensional image and determines a geometrical correction variable.

The binarization section 24 binarizes a two-dimensional image based on such an optical correction variable and a geometrical correction variable as mentioned above.

The decoding section 25 decodes data binarized by the binarization section 24 to obtain readout data from the hologram memory 3.

The variable memory 26 stores an optical correction variable calculated by the optical correction variable calculation section 22 and a geometrical correction variable calculated by the geometrical distortion correction variable calculation section 23.

The memory section 30 is an apparatus which has a function of storing a two-dimensional image transferred thereto from the hologram scan control section 15, another function of storing an intermediate result of the signal process executed by the signal processing section 20 and a further function of storing information decoded by the decoding section 25 (readout data produced by decoding an image of an element hologram). The memory section 30 includes an information memory 31 and a nonvolatile memory 32.

The information memory 31 is formed typically from a DRAM (dynamic random access memory) and serves as a storage region for storing a two-dimensional image transferred from the hologram scan control section 15. The stored two-dimensional image is read out for processing by the optical correction variable calculation section 22, geometrical distortion correction variable calculation section 23 and binarization section 24.

The nonvolatile memory 32 serves as a storage region for information decoded by the decoding section 25, for example, for read out data as audio/video information or the like. It is to be noted that the storage region for readout data is assured in the information memory 31.

The external apparatus IF section 40 is an apparatus which transmits audio/video information or some other information read out by the hologram reader 6 to an external apparatus 100 and includes an external apparatus interface 41.

Action of the components of the hologram reader 6 when data are read out from the hologram memory 3 is described.

When scanning of the hologram memory 3 is to be performed, the light emission driving section 14 drives the reference light source 16 to emit light. Reproduction image light of an element hologram is obtained from the hologram memory 3 upon which the reproduction reference light L4 is irradiated. The reproduction image light forms an image on the image pickup device section 12 through the collimator lens 4. The two-dimensional image formed on the image pickup device section 12 is converted into an electric signal and transferred to the hologram scan control section 15.

The hologram scan control section 15 controls action of the image pickup device section 12 and processes a two-dimensional image signal obtained by the image pickup device section 12.

In particular, the hologram scan control section 15 supplies a scanning timing signal, a scanning address signal and other necessary signals to the image pickup device section 12. Consequently, two-dimensional image signals successively obtained from the solid-state image pickup device array by image pickup action are successively outputted and transferred. Then, the hologram scan control section 15 performs a sampling process, an AGC process, an A/D conversion process and other necessary processes for each of the two-dimensional signals successively transferred thereto, and outputs a resulting signal.

The two-dimensional image signal in the form of digital data outputted from the hologram scan control section 15 is stored into the information memory 31 under the control of the memory controller 21.

From the two-dimensional image signals stored in the information memory 31, an optical correction variable is calculated by the optical correction variable calculation section 22. In particular, each two-dimensional image signal is transferred from the information memory 31 to the optical correction variable calculation section 22. Thus, the optical correction variable calculation section 22 calculates a correction variable for correction of optical distortion and adjustment of the brightness which are variations of data values provided by optical causes. The optical correction variable calculation section 22 stores the calculated optical correction variable into the variable memory 26.

It is to be noted that the optical correction variable calculation section 22 does not actually perform an optical correction process for a two-dimensional image signal but only performs a process of calculating and storing an optical correction variable into the variable memory 26. In other words, action of correcting a two-dimensional image signal and transferring the corrected two-dimensional image signal to the information memory 31 so as to update the information memory 31 into a state wherein the two-dimensional image is corrected is not performed.

Further, from the two-dimensional image signals stored in the information memory 31, a geometrical correction variable is calculated by the geometrical distortion correction variable calculation section 23. In particular, each two-dimensional image signal is transferred from the information memory 31 to the geometrical distortion correction variable calculation section 23. Thus, the geometrical distortion correction variable calculation section 23 calculates a correction variable for geometrical correction such as image position displacement correction and image rotation displacement correction. The geometrical distortion correction variable calculation section 23 stores the calculated geometrical correction variable into the variable memory 26.

It is to be noted that also the geometrical distortion correction variable calculation section 23 does not actually perform a geometrical correction process for a two-dimensional image signal but only performs a process of calculating and storing a geometrical correction variable into the variable memory 26. In other words, action of correcting a two-dimensional image and transferring the corrected two-dimensional image signal to the information memory 31 so as to update the information memory 31 into a state wherein the two-dimensional image is corrected is not performed.

The two-dimensional image signal with regard to which the optical correction variable and the geometrical correction variable are stored into the variable memory 26 by the processes of the optical correction variable calculation section 22 and the geometrical distortion correction variable calculation section 23 is transferred from the information memory 31 to and binarized by the binarization section 24. The two-dimensional image signal is obtained as picked up image data having gradations by the image pickup device section 12, and the binarization section 24 performs a binarization process for converting the two-dimensional image signal into two values of white and black (bright and dark). This is because data to be read from the hologram memory 3 are two-dimensional page data obtained by converting original recording data into binary data of white and black.

The binarization section 24 performs, upon binarization, a process using the optical correction variable and the geometrical correction variable stored in the variable memory 26 with regard to the two-dimensional image signal. In particular, the binarization section 24 adjusts coordinates upon reading in of the two-dimensional image signal from the information memory 31 based on the geometrical correction variable and sets a threshold value for binarization based on the optical correction variable.

Since the binarization process is performed by the binarization section 24 using the optical correction variable and the geometrical correction variable, the binarized two-dimensional image signal is placed in a state wherein optical correction and geometrical distortion correction are executed already.

The two-dimensional image signal binarized by the binarization section 24 is transferred to the decoding section 25 directly or through the information memory 31.

The decoding section 25 performs a decoding process and an error correction process for the binarized two-dimensional image signal, that is, for data obtained from one element hologram, to decode the original data.

The decoding section 25 passes the decoded data as readout data from one element hologram to the memory controller 21. The memory controller 21 stores the readout data into the nonvolatile memory 32.

Or, as hereinafter described, where read data of the same data blocks BLK (data whose data substance is same) exist in the nonvolatile memory 32 already, the memory controller 21 abandons the readout data decoded by the decoding section 25 in the present cycle.

Readout data obtained by successively decoding the two-dimensional image signals obtained from individual element holograms of the hologram memory 3 by means of the decoding section 25 are successively accumulated into the nonvolatile memory 32. Consequently, the original data recorded on the hologram memory 3 such as, for example, AV contents data, computer data or the like are constructed in the nonvolatile memory 32 finally.

For example, if the hologram memory 3 in which the element holograms h1, h2, . . . , h24 are recorded as seen in FIG. 4B is assumed, then as scanning proceeds, a state wherein readout data read out individually from the element holograms h1, h2, . . . , h24 are stored in the nonvolatile memory 32 is reached. The memory controller 21 re-arranges the stored readout data into a predetermined address order of the original data blocks BLK to re-construct the original data blocks BLK thereby to produce the recorded original data, for example, computer data or content data.

The data re-constructed on the nonvolatile memory 32 are transferred as reproduction data from the hologram memory 3 to the external apparatus 100 such as, for example, a personal computer, an AV apparatus such as an audio player or a video player, or an external apparatus such as a portable telephone set through the external apparatus interface 41. The external apparatus interface 41 may be, for example, a USB interface or the like. Naturally, the external apparatus interface 41 may be an interface of any other standards than the USB standards. The user can utilize the reproduction data from the hologram memory 3 on the external apparatus 100 side. For example, the user can utilize computer data on a personal computer or reproduce AV content data on an AV apparatus or a portable telephone set.

Though not shown in the figure, a medium drive for recording data on a predetermined recording medium may be provided so that reproduction data may be recorded on the recording medium.

The recording medium may typically be an optical disk, a magneto-optical disk or the like. In particular, various disks which can be recorded by various systems such as, for example, a CD (Compact Disc) system, a DVD (Digital Versatile Disc) system, a blue ray disk (Blu-Ray Disc (registered trademark)) system and a mini disk (Mini Disc) system can be used as the recording medium. Where any of such disks is used as the recording medium, the medium drive performs an encoding process, an error correction code process, a compression process and so forth suitable for the type of the disk to record the reproduced data on the disk.

Also a hard disk may possibly be used as the recording medium. In this instance, the medium drive is formed as an HDD (hard disk drive).

Further, the recording medium may be implemented also as a portable memory card in which a solid-state memory is built or as a built-in type solid-state memory. In this instance, the medium drive is constructed as a recording apparatus section for the memory card or the built-in type solid-state memory and performs a necessary signal process to record reproduced data.

Furthermore, also it is a possible idea, for example, to provide a sound reproduction outputting system and an image reproduction outputting system which reproduce AV content data and so forth recorded on the recording medium using the medium drive and decode and output the reproduced AV content data.

Also it is possible to transfer data reproduced by the medium drive to an external apparatus through the external apparatus interface 41.

Furthermore, where data are recorded on a portable recording medium such as a CD, a DVD, a Blu-ray disk, a mini disk or a memory card mentioned hereinabove, the user can utilize reproduction data read out from the hologram memory 3 by causing the external apparatus to reproduce the recording medium.

It is to be noted that basically the reproduction action (data downloading action) of performing scanning of the hologram memory 3 to read out data and the action of transferring the resulting data such as audio/video data to the external apparatus 100 or reproducing and outputting the data by means of a reproduction outputting system as described hereinabove are not performed simultaneously. Therefore, the memory configuration can be simplified by replacing either one or both of the information memory 31 and the nonvolatile memory 32 of the memory section 30 with some other storage section provided in the reproduction apparatus.

For example, if decoded data are recorded on a recording medium such as an optical disk or an HDD as described above, then the nonvolatile memory 32 can be eliminated by storing the data in the information memory 31 before reproduction data re-construction.

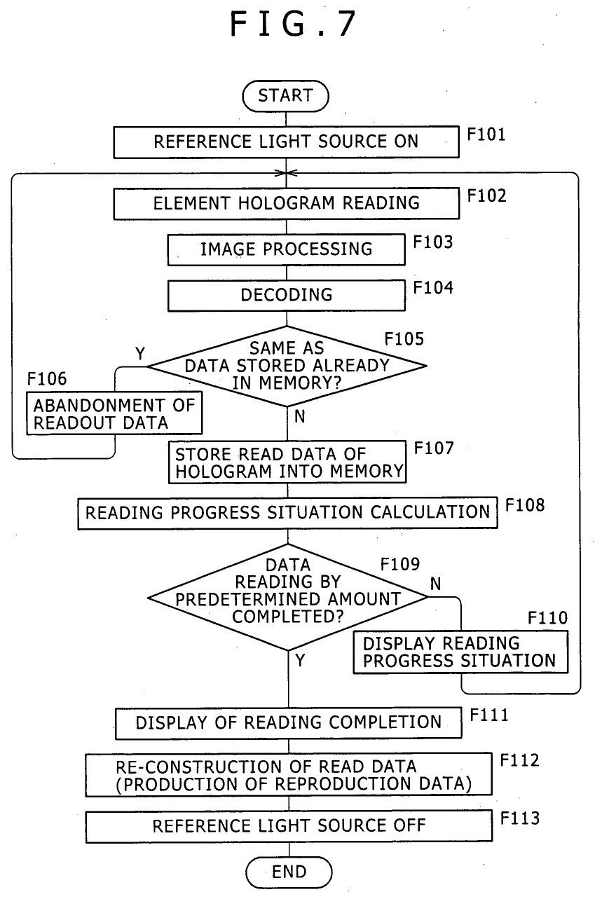

A process when the hologram reader 6 performs data reproduction from hologram memory 3 is described with reference to FIG. 7. FIG. 7 illustrates a process executed under the control of the system controller 51 upon data reproduction.

For example, after the user performs an operation to start reproduction from the operation section 53, the user would arbitrarily move the hologram reader 6 in an opposing relationship to the hologram memory 3 as seen in FIG. 4A, 4B or 5.

If the system controller 51 detects the reproduction starting operation using the operation section 53, then it issues an instruction to the light emission driving section 14 to cause the reference light source 16 to emit light at step F101 of FIG. 7. In other words, a state wherein the reproduction reference light L4 can be irradiated upon the hologram memory 3 is established.

In this state, if the user moves the hologram reader 6 in an opposing relationship to the hologram memory 3, then the reproduction image light L5 of the element holograms is successively detected by the imager 12.

It is to be noted that, where the hologram reader 6 is configured such that it includes the camera control mechanism section 13 such that the scanning position is controlled by the camera control mechanism section 13, the system controller 51 issues, upon starting of scanning, an instruction to the hologram scan control section 15 to start action of the camera control mechanism section 13. In the following description, it is assumed that the manual scanning method is used as the scanning method and the camera control mechanism section 13 is not provided.

At step F102, the reproduction image light L5 of a certain element hologram is fetched by action of the imager 12 and the hologram scan control section 15, and digital data as a reproduction image signal are obtained. A reproduction image signal (two-dimensional image signal) of a certain element hologram outputted from the hologram scan control section 15 is stored into the information memory 31 by the memory controller 21.

The system controller 51 confirms fetching of a two-dimensional image signal of an element hologram as action at step F102, and thereafter, the system controller 51 executes an image process at step F103 and a decoding process at step F104.

In particular, at step F103, the system controller 51 controls the optical correction variable calculation section 22 and the geometrical distortion correction variable calculation section 23 to execute respective processes for the two-dimensional image signal fetched in the information memory 31.

Further, at step F104, the system controller 51 controls the binarization section 24 and the decoding section 25 to execute respective processes for the two-dimensional image signal to obtain decoded data (readout data from the element hologram).

After readout data regarding one certain element hologram are decoded at step F104, the memory controller 21 decides, at step F105, in response to an instruction of the system controller 51, whether or not the readout data is already stored in the nonvolatile memory 32.

For example, the memory controller 21 may confirm an address, a data block number and so forth included in the readout data and confirm whether or not readout data of an address and a data block number same as the confirmed address and data block number are already stored in the nonvolatile memory 32.

The case wherein the same readout data are already stored in the nonvolatile memory 32 is a case wherein the element hologram read-in in the present cycle has been read in formerly. This is because, since reading out of element holograms from the hologram memory 3 is performed by manual scanning of the user as described above, the same element hologram may possibly be read out by a plural number of times. Or, since a plurality of element holograms recorded may have data of the same substance (data of the same data block) as hereinafter described, readout data same as the readout data in the present cycle may be stored already.

On the contrary, the case wherein readout data same as the readout data obtained in the present cycle are not stored in the nonvolatile memory 32 is a case wherein readout data are obtained for the first time from a certain data block BLK.

If the memory controller 21 decides at step F105 that the readout data obtained in the present cycle are not stored in the nonvolatile memory 32 as yet, then the processing advances to step F107. At step F107, the memory controller 21 stores the readout data as data read out from a certain element hologram into the nonvolatile memory 32.

At step F108, the system controller 51 calculates a progress situation of the data reading.

While, upon data reading out from the hologram memory 3, data of one data block BLK is read out from one element hologram, the reading out action is performed until after data of all of the data blocks BLK as the original recording data illustrated in FIG. 1C are read out. In other words, at a point of time when data of all of the data blocks BLK which form the original recording data are decoded and stored successfully into the nonvolatile memory 32 by the process at step F107, the data reading out is completed by 100% successfully.

Then, the calculation of a progress situation at step F108 is calculation of by what percent the data is decoded and stored into the nonvolatile memory 32 at the point of time.

As described hereinabove, in the header information of data recorded in the element holograms upon recording, the data size of the entire recorded data (for example, entire content data) and the number of data blocks obtained by division are recorded. Accordingly, at a point of time at which data from a certain one of the element holograms is successfully decoded first, the system controller 51 can confirm the data size and the data block number of the entire data to be readout.

Therefore, by the calculation of the progress situation, what percent the progress situation is can be determined from the data size of the entire readout data stored in the nonvolatile memory 32 already and the data size of the entire data to be reproduced (size of the entire original recording data).

Or, what percent the progress situation of reading out is can be determined from the number of the data blocks of the entire data and the number of the readout data (that is, one data block) stored in the nonvolatile memory 32.

It is to be noted that the decision at step F108 that reading of all necessary element holograms is completed, that is, that the progress situation of data reading becomes completion by 100%, is made on condition of whether or not the data of all data blocks BLK which form the reproduction data (=original recording data) are read successfully as described above, but it is not necessary to make a decision of whether or not reading of all of the element holograms of the hologram memory 3 is completed. This is because a plurality of element holograms having the same data substance may be recorded as hereinafter described.

At step F109, the system controller 51 decides whether or not data reading by a predetermined amount necessary for data reproduction is completed, that is, whether or not the predetermined amount of readout data is stored in the nonvolatile memory 32. This is a decision of whether or not the progress situation of reading calculated at step F108 is 100%.

If the data reading from element holograms does not reach the state of completion by 100%, then the processing advances to step F110, at which the system controller 51 controls the display section 52 to display the reading progress situation. In this instance, display according to the reading progress situation calculated at step F108 is executed.

Then, the processing returns to step F102, at which a process for an element hologram read out as reproduction image light is executed similarly.

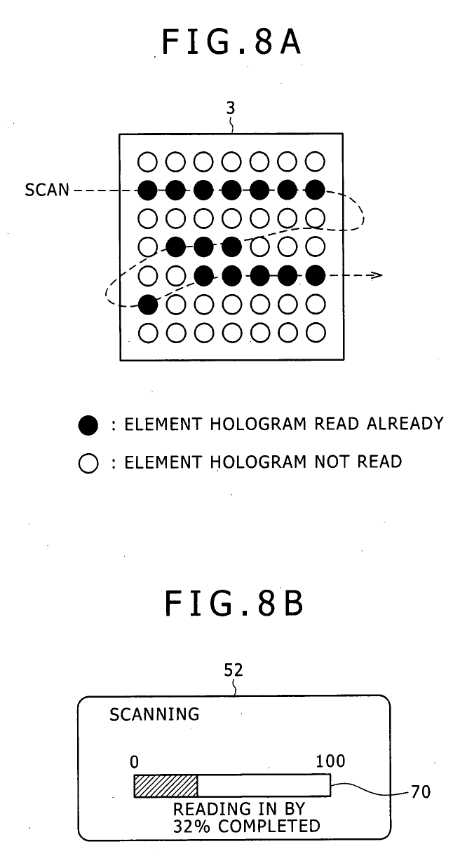

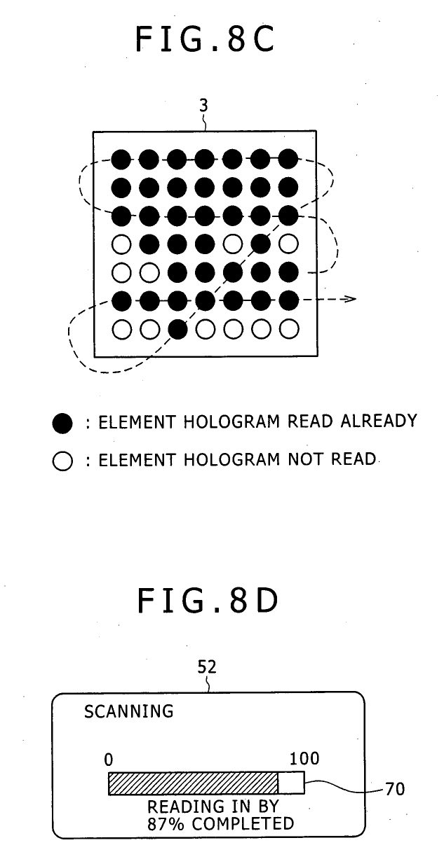

Examples of the display of the reading progress situation at step F110 are shown in FIGS. 8A to 8D. In FIG. 8A, element holograms on the hologram memory 3 are indicated by ◯ and . Further, a locus of manual scanning of the user is indicated by a broken line.

Where the manual scanning is performed as indicated by the broken line, element holograms indicated by are read. If it is assumed that data divided into 49 data blocks BLK are recorded as 49 element holograms indicated by ◯ and on the hologram memory 3, then at a point of time when reading of the 16 element holograms indicated by is completed as seen in FIG. 8A, that is, at a point of time when the 16th readout data is stored into the nonvolatile memory 32 at step F107, the reading progress situation calculated at step F108 is 32%.

In this instance, at step F110, a progress situation bar 70 is displayed on the display section 52, for example, as seen in FIG. 8B so as to present the situation of completion of reading in by 32% to the user.

Further, it is assumed that manual scanning is performed as indicated by a broken line in FIG. 8C continuously to the manual scanning in FIG. 8A. At this point of time, those element holograms indicated by whose data reading out is completed reach 87%, and therefore, data reading out by 87% of the data to be reproduced is completed. In this instance, a displaying state that the progress situation bar 70 and the display numerical value on the display section 52 are completion of reading in by 87% as seen in FIG. 8D.

In other words, as the manual scanning and the actions at steps F102 to F108 are successively performed repetitively, the percentage display of the progress situation bar 70 proceeds on the display section 52, and by observing the percentage display, the user can recognize how much the user must further perform manual scanning.

If it is decided at F105 of FIG. 7 that readout data obtained by the decoding are already stored in the nonvolatile memory 32, then the processing advances to step F106, at which the system controller 51 abandons the decoded data, that is, the readout data from the certain element hologram. Thereafter, the processing returns to step F102. In other words, this is a case wherein reading out of the same element hologram has been performed already. Or, this is a case wherein, where a plurality of element holograms having the same data substance recorded thereon as hereinafter described are recorded on the hologram memory 3, the same readout data have been read out already from an element hologram different from the element hologram read out in the present cycle.

It is to be noted that, though not illustrated in FIG. 7, the decoding at step F104 may result in error. For example, even where a reproduction image signal of a certain element hologram is obtained, good reading may not be performed from such a reason that the scanning position is not appropriate, resulting in failure in appropriate decoding. In such an instance, the data should be abandoned and the processing should be returned to step F102.

As the process till now is repeated, the element holograms on the hologram memory 3 are read out in a random order in accordance with the manual scanning of the user, and data of the data blocks BLK of FIG. 1C are accumulated in a random order.

If it is calculated at step F108 that the reading progress situation is 100% and it is decided at step F109 that reading out of the predetermined amount of data from the hologram memory 3 is completed, then the system controller 51 controls the display section 52 to perform reading completion display at step F111. In other words, the progress situation bar 70 and the numerical value are displayed in a state of completion by 100%. Further, at this time, a message for causing the user to end the manual scanning may be displayed as completion of scanning.

Then at step F112, the system controller 51 issues an instruction to the memory controller 21 to re-construct the readout data stored in the nonvolatile memory 32. In particular, the memory controller 21 extracts data of the data blocks BLK and re-arranges the data in the order of the data block number to produce reproduction data. For example, the memory controller 21 produces reproduction data as content data. The reproduction data are outputted later, for example, from the external apparatus interface 41 to the external apparatus 100.

Since the reproduction from the hologram memory 3 is completed therewith, the system controller 51 controls the light emission driving section 14 at step F113 to turn off the reference light source 16 to end the irradiation of the reproduction reference light L4. The reproduction process is ended therewith.

As can be recognized from the process described above, the hologram reader 6 in the present example successively stores readout data of the element holograms on the hologram memory 3 into the nonvolatile memory 32 beginning with those element holograms which have been read successfully irrespective of the order of reading in. At this time, the progress situation of scanning (data reading) is successively displayed on the display section 52.

Then, at a point of time when reading out of the predetermined amount of element holograms is completed, data are re-constructed to produce original data such as content data, that is, reproduction data.

By performing such a process as described above, data reproduction from the hologram memory 3 can be performed by such manual scanning as described hereinabove with reference to FIGS. 4A, 4B and 5.

This eliminates the necessity for provision of a scanning mechanism in a detection system for reproduction image light by the reference light source 16, collimator lens 11 and imager 12, and they may be disposed fixedly in the apparatus. Accordingly, the hologram reader 6 can be implemented in a simplified configuration and at a low cost.

It is to be noted that, also where a configuration of variably controlling the scanning position by means of the camera control mechanism section 13 is adopted in order to obtain an apparatus which performs automatic scanning, the scanning accuracy is not required strictly, but the apparatus can be implemented in a simple configuration and the degree of freedom in variably controlling action can be increased.

Further, although reading out of element holograms is performed stochastically, reproduction data can be obtained appropriately by performing a process of storing obtained readout data into the nonvolatile memory 32 or, where same readout data are obtained, abandoning the readout data and then re-constructing and producing reproduction data at a point of time when a required amount of readout data is obtained.

Further, to the user, when the user wants to perform reproduction, only it is necessary to merely move the hologram reader 6 in an opposing relationship to the hologram memory 3, and this is easy in sense and does not require a difficult operation. Therefore, the hologram reader 6 is superior in usability.

Furthermore, it is very effective in improvement in usability that it can be grasped from a progress situation display to which degree scanning is completed or how much manual scanning should be performed further. While, for example, to continue manual scanning immoderately provides a poor feeling of use to the user, this is eliminated as the user can grasp the progress situation.

Further, even where automatic scanning is performed, naturally a display of the scanning progress situation is useful to the user.

Those matters are preferable to implementation of a system wherein the hologram memory 3 on which, for example, computer data, AV content data or the like are recorded is distributed widely such that a general user can use the hologram reader 6 to acquire the data recorded on the hologram memory 3.

Further, in the present example, correction variables for geometrical distortion correction, optical correction and so forth for a two-dimensional image stored in the information memory 31 are calculated and stored into the variable memory 26. Then, when binarization is performed by the binarization section 24, the process is performed based on the correction variables stored in the variable memory 26 to implement information reproduction in a state wherein geometrical correction and optical correction are performed for the information. In this instance, since a correction process for geometrical distortion correction or optical correction is not successively performed directly for the two-dimensional image stored in the information memory 31, also writing of the two-dimensional image into the information memory 31 after the correction process does not occur. Accordingly, accessing process burden to the information memory 31 necessary where geometrical distortion correction and optical distortion correction are successively executed and processing time burden by the accessing process burden can be eliminated, and enhancement in efficiency of the reproduction process can be implemented.

Further, from the fact that the correction process is not performed for the two-dimensional image itself until the binarization process is executed, also an advantage of suppression of arithmetic operation error caused by correction is obtained.

[3. Arrangement and Configuration of Element]

Subsequently, the hologram memory 3 which is suitable where the hologram reader 6 which performs reproduction by manual scanning as described hereinabove is used is described. Particularly, the following description relates to an arrangement configuration of element holograms recorded on the hologram memory 3.

While the state wherein the element holograms h1, h2, . . . , h24 are recorded on the hologram memory 3 is illustrated as a schematic example in FIG. 4B, it is described above that this is a state wherein, for example, data of the 24 data blocks BLK into which original data are divided are recorded individually as the 24 element holograms h1, h2, . . . , h24. It is to be noted that naturally the number 24 is a mere example simplified for the description and a greater number of element holograms can be recorded.

For example, in such an instance as just described, the time at which it is decided at step F109 of FIG. 7 that data reading out of the predetermined amount is completed is a point of time at which acquisition of readout data regarding all of the 24 element holograms h1, h2, . . . , h24 is completed.

Here, where it is taken into consideration that the hologram reader 6 which performs reproduction by manual scanning stochastically reads out the element holograms h1, h2, . . . , h24, it is sometimes difficult to fetch all of the element holograms h1, h2, . . . , h24 on the hologram memory 3 without exception.

In particular, since manual scanning is a motion of a user at all, when the user moves the hologram reader 6 arbitrarily, some element hologram may not be scanned readily. In other words, some element hologram may not be irradiated by the reproduction reference light L4. Then, for example, if the element hologram h5 is not read readily, then data of the data blocks BLK recorded on the element hologram h5 is not read in, and the state wherein it is not decided at step F109 that data reading of the predetermined amount is completed may continue, resulting in a situation that the user must continue the manual scanning for a long period of time.

Where this is taken into consideration, in a system wherein reproduction is performed by manual scanning, it is important to raise the reading probability of data of the data blocks BLK.

Then, in order to raise the reading probability of data, it is appropriate to record a plurality of element holograms of the same data substance on the hologram memory 3.

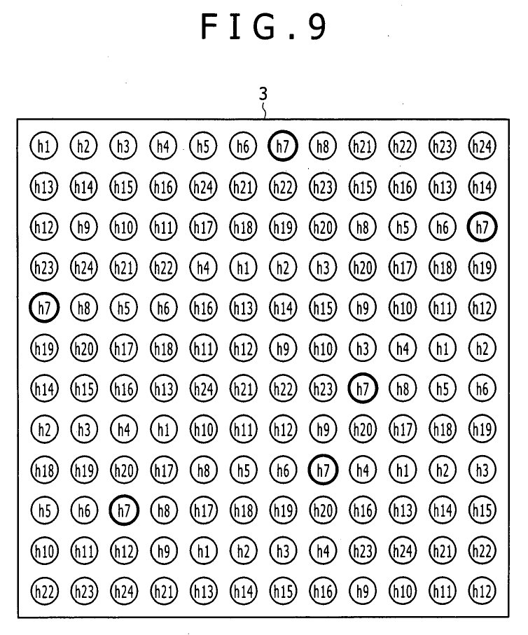

An example is shown in FIG. 9.

In the example shown, element holograms h1, h2, h24 are recorded on the hologram memory 3. Original recording data are divided into 24 data blocks BLK, and the data of the data blocks BLK are recorded individually as the element holograms h1, h2, . . . , h24. The element holograms h1, h2, . . . , h24 have data of the different data blocks BLK from each other recorded thereon and have different data substances to be read out from each other.

While FIG. 9 illustrates a state wherein 144 element holograms are recorded on the hologram memory 3, this is a state wherein each of the element holograms h1, h2, . . . , h24 is recorded at six different places. Those element holograms to which the same reference character is applied are element holograms of the same data substance. For example, the element holograms h1 have data of the first data block BLK of the original recording data recorded thereon.

For example, while each element hologram h7 in which data of the seventh data block BLK of the original recording data is indicated by a thick round mark, six such element holograms h7 are recorded discretely on the plane of the hologram memory 3.

Where a plurality of element holograms having the same data substance are recorded in this manner, when the element holograms are read out irregularly by manual scanning, the probability in reading out of the individual data is raised.

Consequently, the state wherein it is decided at step F109 of FIG. 7 that data reading out of the predetermined amount is completed can be reached quickly, and it can be prevented as soon as possible that the user continues manual scanning for a long period of time.

How many element holograms of the same data substance should be recorded or at which positions such element holograms should be disposed on a plane may be determined in response to the size of recording data, that is, the number of data blocks BLK and the number of element holograms which can be recorded on the hologram memory 3.

Further, the element holograms may be disposed regularly or disposed at random. Naturally, such arrangement that the reading probability is raised in random manual scanning is preferable.

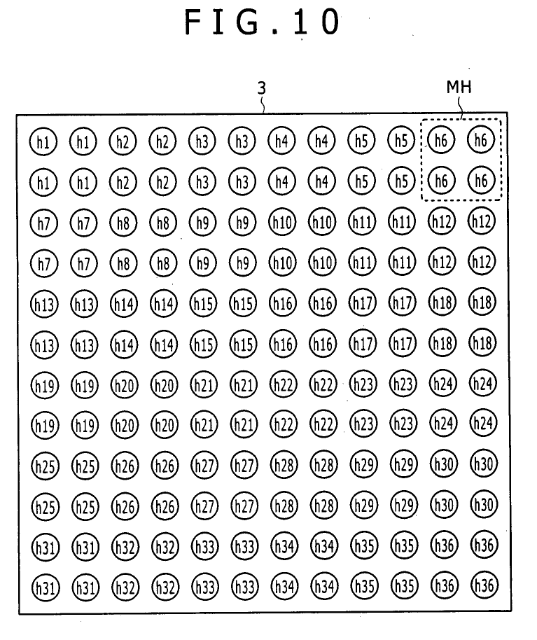

In an example of FIG. 10, a plurality of element holograms of the same data substance are recorded collectively in position on the hologram memory 3. Particularly, this is a case wherein a plurality of element holograms of the same data substance are collected so as to be adjacent each other in the vertical and horizontal directions.

In this example of FIG. 10, while element holograms h1, h2, . . . , h36 of different data substances are recorded on the hologram memory 3, four element holograms are recorded for each of the element holograms h1, h2, . . . , h36. In other words, each of the element holograms h1, h2, . . . , h36 of the same data substance is recorded at four places.

Then, if attention is paid, for example, to the element hologram h6 indicated by a broken line portion MH, then the four element holograms h6 having the same data substance are collected in the vertical and horizontal directions and disposed at the four vertex positions of a square. Also the other element holograms are disposed similarly, and each four element holograms are disposed collectively.

In the case of manual scanning, in addition to the fact that the scanning position is random as described above, also hand-shaking cannot be avoided. However, where such circumstances as described above are taken into consideration, if element holograms of the same data substance are disposed collectively, then even if hand-shaking occurs, the possibility that the reproduction reference light L4 may be irradiated upon one of the collected element holograms is high. Consequently, the reading probability of the data can be raised and the scanning time can be reduced. Accordingly, also it is suitable for reproduction to dispose element holograms of the same data substance collectively.

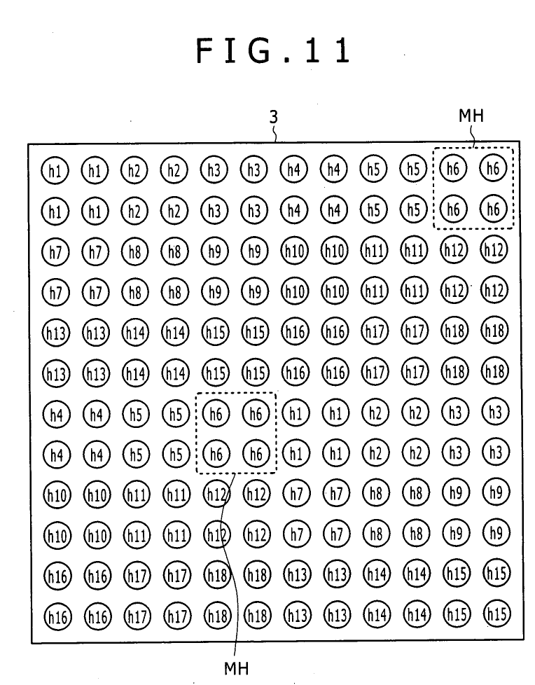

Also FIG. 11 shows an example wherein a plurality of element holograms of the same data substances are recorded on the hologram memory 3 such that each four ones of such element holograms are collected in position. In this instance, however, a unit of such collected element holograms is recorded at a plurality of places.

On the hologram memory 3 shown, element holograms h1, h2, . . . , h18 having different data substances from each other are recorded. Then, each of the element holograms h1, h2, . . . , h18 is recorded at eight places.

Then, for example, while element holograms h6 are indicated in a broken line portion MH, four element holograms h6 having the same data substance are collected in the vertical and horizontal directions and disposed at the vertex positions of a square. Then, a unit of such four element holograms is formed at two places on the plane of the hologram memory 3.

In other words, according to the present example, the reading out probability of data is raised against hand-shaking, and besides the reading probability is raised also against the randomness of the scanning locus.

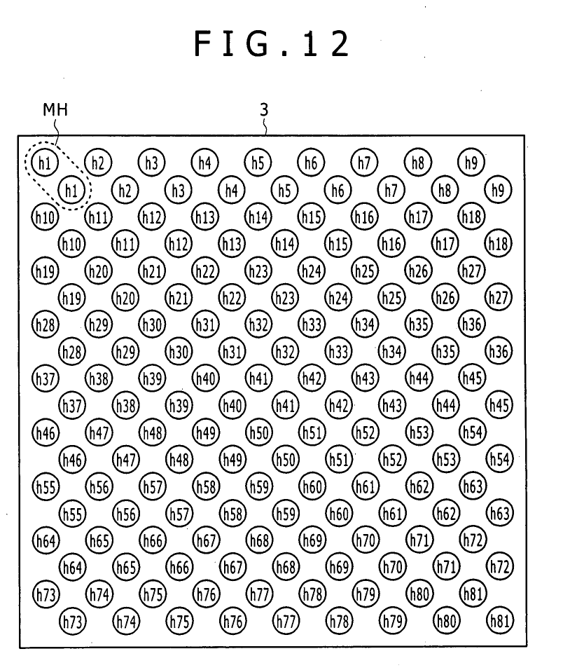

FIG. 12 illustrates an example wherein element holograms are disposed in an offset relationship in rows and columns.

On this hologram memory 3, element holograms h1, h2, . . . , h81 having different data substances from one another are recorded. Then, while, for example, two element holograms h1 are shown as a broken line portion MH, the element holograms h1, h2, . . . , h81 are recorded such that two element holograms positioned adjacent each other in an oblique direction are formed as element holograms of the same data substance.

Also in this instance, the reading out probability of data of the data blocks BLK can be raised against hand-shaking and the randomness of the scanning locus. Particularly, in whichever one of leftward and rightward directions and upward and downward directions the manual scanning is performed, while only each two element holograms have the same data substance, a reading out probability substantially equal to that by the example of FIG. 10 can be obtained.

In short, this example can anticipate increase of the storage capacity of the hologram memory 3 while minimizing the number of element holograms of the same data substance.

It is to be noted that, in a case wherein it is permitted to decrease the storage capacity of the hologram memory 3, if a group of two element holograms of the same data substance which are adjacent each other in an oblique direction as indicated by a broken line portion MH is provided at a plurality of places on the hologram memory 3, then the reading out probability of each data can be further raised.

According to the examples described above with reference to FIGS. 9 to 12 and modifications to them, while the reading out probability of data of the data blocks BLK can be raised and the time required for the manual scanning can be reduced, the spaced distance between the element holograms is set taking the following points into consideration.

Although, as the distance between the element holograms is reduced, the recording density increases and the storage capacity of the hologram memory 3 can be raised, if the reproduction reference light L4 upon reproduction is greater than the element holograms, also reproduction signals from adjacent element holograms are picked up, causing crosstalk.

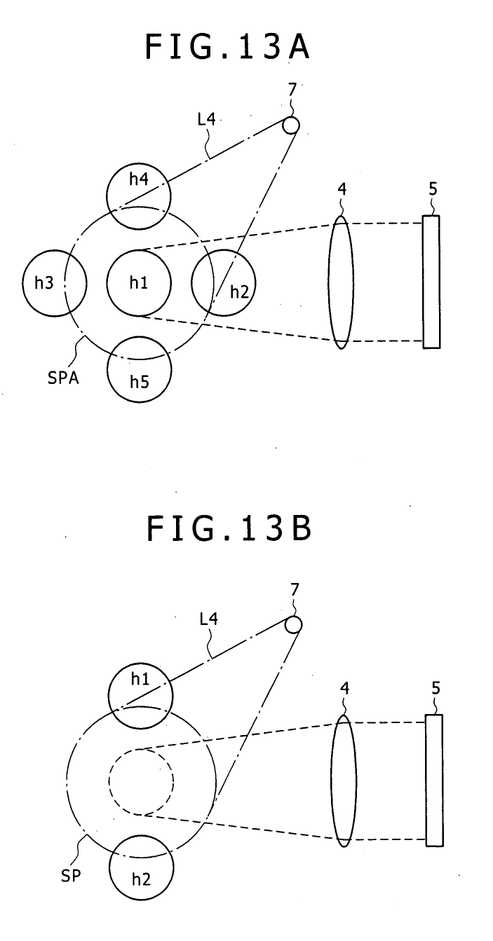

For example, FIG. 13A illustrates a state wherein element holograms h2, h3, h4 and h5 are disposed in a spaced relationship by a small distance around an element hologram h1. Then, a spot SP of the reproduction reference light L4 from the reference light source 7 has a diameter greater than the size of one element hologram.

In this instance, when the spot SP of the reproduction reference light L4 is positioned just on the element hologram h1 as seen in FIG. 13A, also the surrounding element holograms h2, h3, h4 and h5 are included in the spot SP. Consequently, also reproduction image light from part of the element holograms h2, h3, h4 and h5 is detected in addition to reproduction image light of the element hologram h1 by the imager 5 and causes crosstalk. Naturally, according to such a condition as just described, the reproduction image signal of the element hologram h1 is deteriorated. In short, the reproduction accuracy of data from the element holograms drops.

On the other hand, if the element holograms are disposed in a spaced relationship by a sufficient distance from each other so that crosstalk may not matter, then such a case that the reproduction reference light L4 upon scanning passes between element holograms occurs, and the probability that data may not be read increases. An example is shown in FIG. 13. For example, if a sufficient spaced distance with which no crosstalk occurs is provided between the element holograms h1 and h2, then the reproduction reference light L4 is sometimes irradiated such that the spot SP thereof passes between the element holograms h1 and h2 as seen in the figure. Naturally, the reading out probability of the element holograms upon manual scanning drops unfavorably.

Therefore, the spaced distance between the element holograms is set to an intermediate level between those in the cases of FIGS. 13A and 13B. In other words, the spaced distance between the element holograms is set to such a degree that, even if crosstalk occurs to some degree, it does not make an obstacle to decoding of the data.

At this time, it is not sure that, upon manual scanning, the spot SP just passes above each element hologram to read data with certainty. Therefore, address information indicative of data blocks BLK is embedded in two-dimensional page data (two-dimensional image DP) recorded on each element hologram and the user scans the entire hologram memory 3 in such a manner as to trace the hologram memory 3. Then, the system is configured such that the hologram reader 6 successively stores readout data regarding those element holograms from which data can be read into the nonvolatile memory 32 and, after data of a required amount of element holograms is read fully, the data on the nonvolatile memory 32 are re-constructed to obtain reproduction data.

If the distance between element holograms is increased to such a degree that crosstalk is sufficiently little, then the probability in which data can be read upon manual scanning decreases, and consequently, there is the possibility that the total scanning time may be long. As a countermeasure against this, although the total capacity decreases as a result of increase of the redundancy, a plurality of holograms in which the same data are written can be recorded at different places as in the examples described hereinabove to improve the reading out probability of data and reduce the scanning time.

Now, examples of arrangement of element holograms which are more effective in terms of reduction of the scanning time and in terms of the data reading performance are described.

Although crosstalk occurs if the spaced distance between element holograms is decreased as described above, if adjacent element holograms have the same data substance, then same images are formed on the imager 5. Therefore, if the images have no displacement, then they do not make a noise component. In other words, they may not cause crosstalk.

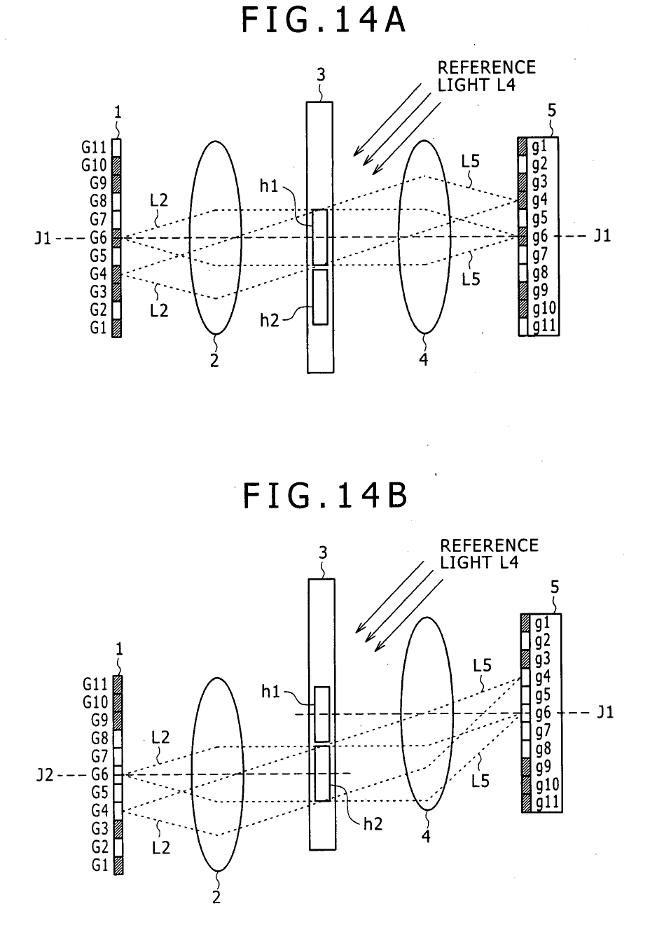

This is described with reference to FIGS. 14A and 14B.

FIGS. 14A and 14B schematically illustrate a relationship of the liquid crystal panel 1 used upon recording as described above with reference to FIGS. 1A to 1C, the condenser lens 2, the hologram memory 3 to be recorded and reproduced, and the collimator lens 4 and the imager 5 provided in the hologram reader 6 (collimator lens 11 and imager 12 in the example of FIG. 6).

FIG. 14A illustrates a manner upon recording and reproduction of the element hologram h1.

As a state wherein two-dimensional page data for recording of the element hologram h1 is displayed on the liquid crystal panel 1, LCD pixels G1, G2, . . . , G11 are shown. The positional relationship between the liquid crystal panel 1 and condenser lens 2 and the hologram memory 3 is indicated by an optical axis J1.

The object light L2 of the pattern of the LCD pixels G1, G2, . . . , G11 of the liquid crystal panel 1 is irradiated at the formation position of the element hologram h1 by the condenser lens 2. In this figure, the object light L2 is shown in a state wherein it is viewed from the LCD pixels G4 and G6, and this element hologram h1 is corresponds to the fact that position information of the LCD pixels G1, G2, . . . , G11 of the liquid crystal panel 1 is converted into and recorded as angle information of a flux of light as the object light L2.

Upon reproduction of the element hologram h1, the reproduction image light L5 from the element hologram h1 is detected by detection pixels g1, g2, . . . , g11 of the imager 5 as seen in the figures. In particular, a state is established wherein information of the LCD pixel G1 of the liquid crystal panel 1 is detected by the detection pixel g1, information of the LCD pixel G2 is detected by the detection pixel g2, . . . .

Here, a state wherein the positional relationship between the liquid crystal panel 1 and condenser lens 2 and the hologram memory 3 is shifted along an optical axis J2 as seen in FIG. 14B is considered. This is a case wherein the element hologram h2 adjacent the element hologram h1 is recorded.

Also this element hologram h2 corresponds to the fact that positional information of the LCD pixels G1, G2, . . . , G11 of the liquid crystal panel 1 is converted into and recorded as angle information of a flux of light as the object light L2. It is assumed that the reproduction reference light L4 upon reproduction of the element hologram h1 is irradiated upon the element hologram h2. Also the reproduction image light L5 obtained from the element hologram h2 upon reproduction of the element hologram h1 is placed into such a state that information of the LCD pixel G1 of the liquid crystal panel 1 is detected by the detection pixel g1 of the imager 5, information of the LCD pixel G2 is detected by the detection pixel g2, . . . .

FIGS. 14A and 14B show the LCD pixels G4 and G6 of the liquid crystal panel 1 with attention paid thereto. In particular, information detected by the detection pixel g6 of the imager 5 upon reproduction of the element hologram h1 is information of the LCD pixel G6 of the element hologram h1 as seen in FIG. 14A and simultaneously is information of the LCD pixel G6 of the element hologram h2 as seen in FIG. 14B.

Similarly, information detected by the detection pixel g4 of the imager 5 upon reproduction of the element hologram h1 is information of the LCD pixel G4 of the element hologram h1 and simultaneously is information of the LCD pixel G4 of the element hologram h2.

In short, since the arrangement is such that a flux of light having the same angle upon reproduction forms an image on the same detection element of the imager 5, if the adjacent element holograms h1 and h2 have different data substances from each other, then crosstalk arises.

However, if the element holograms h1 and h2 have the same data substance, then same information is detected from the element holograms h1 and h2 by the detection elements g1, g2, . . . , g11, and a problem of crosstalk does not arise.

Where it is considered that element holograms of the same data substance eliminate the necessity to take a problem of crosstalk into consideration as described above, the following arrangement is considered promising.

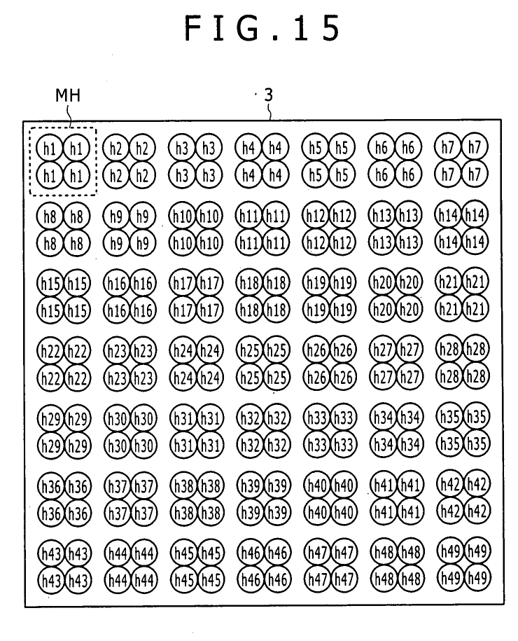

FIG. 15 shows an example wherein a plurality of element holograms of the same data substance are recorded such that they are collected in position in a close contacting state with each other. Particularly where element holograms are recorded such that they are arrayed in a vertical direction and a horizontal direction, a plurality of element holograms of the same data substance are recorded such that they are collected in a closely contacting relationship with each other in a vertical direction and a horizontal direction.

In FIG. 15, element holograms h1, h2, . . . , h49 of data substances different from one another are recorded on the hologram memory 3, and particularly, each of the element holograms h1, h2, . . . , h49 is recorded at four places closely contacting with each other. Like, for example, the four element holograms h1 indicated as a broken line portion MH, four element holograms of each same data substance are recorded in a closely contacting relationship with each other.

The four element hologram h1 of the same data substance are collected in the vertical and horizontal directions and individually disposed at the positions of the vertices of a square. Also the other element holograms are disposed similarly such that four elements are disposed collectively. Naturally, since four element holograms closely contacting with each other have the same data substance, they do not give rise to a problem of crosstalk.

Further, where element holograms of the same data substance are collectively disposed in a closely contacting relationship with each other in this manner, even if hand-shaking or the like occurs, the probability that data may be read from the collected element holograms is very high. Further, where element holograms of the same data substance are disposed in a closely contacting relationship to raise the recording density, the space on the hologram memory 3 can be used effectively to record a greater number of element holograms. Therefore, the arrangement is suitable also in terms of assurance or increase of the storage capacity of the hologram memory 3.

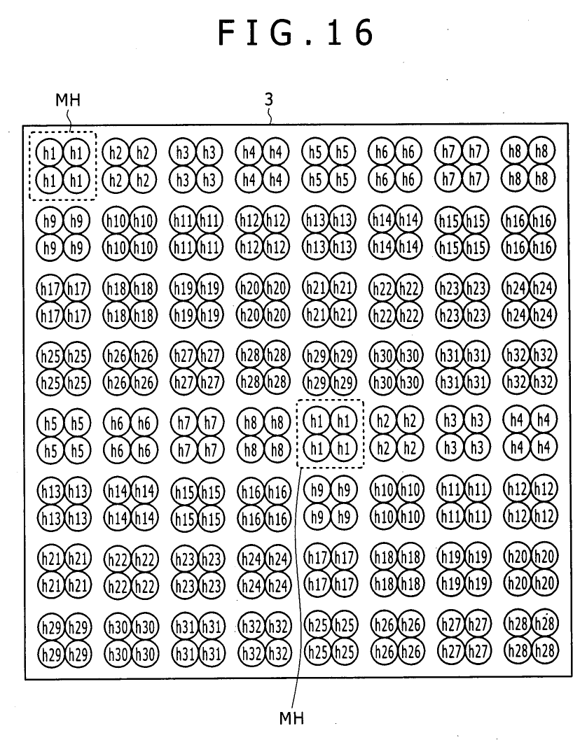

Also FIG. 16 shows an example wherein a plurality of element holograms are recorded on the hologram memory 3 such that each four element holograms of the same data substance are collected in a closely contacting relationship with each other. In this manner, a plurality of such collected units are disposed.

On the hologram memory 3 shown, element holograms h1, h2, . . . , h32 having different data substances from one another are recorded. Each of the element holograms h1, h2, . . . , h32 is disposed at eight places.

And, while a group of, for example, element holograms h1 are shown by a broken line portion MH, two groups in each of which four element holograms h1 of the same data substance are collected in a closely contacting relationship with each other in the vertical and horizontal directions are formed on the plane of the hologram memory 3.

In other words, the present example raises the reading out probability of data of the data blocks BLK against hand-shaking and raises the reading out probability also against randomness of the scanning locus.

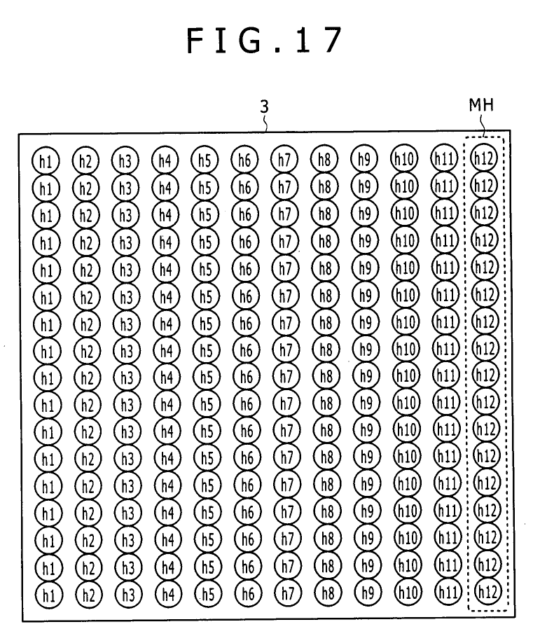

FIG. 17 shows an example wherein element holograms of the same data substance are disposed in a closely contacting relationship with each other in the vertical direction (column direction). Element holograms h1, h2, . . . , h12 having data substances different from one another are recorded on the hologram memory 3. Each of the element holograms h1, h2, . . . , h12 is formed at a large number of places disposed in a closely contacting relationship with each other in the vertical direction. For example, as indicated by a broken line portion MH with regard to the element holograms h12, the element holograms h12 of the same data substance form a column in a state wherein they closely contact with each other in the vertical direction.

Where this arrangement is used, if the user performs manual scanning so as to cross the hologram memory 3, then data of all of the element holograms h1, h2, . . . , h12 can be read almost without fail. In short, the reading probability of data of the data blocks BLK can be raised significantly and the time for manual scanning can be reduced.

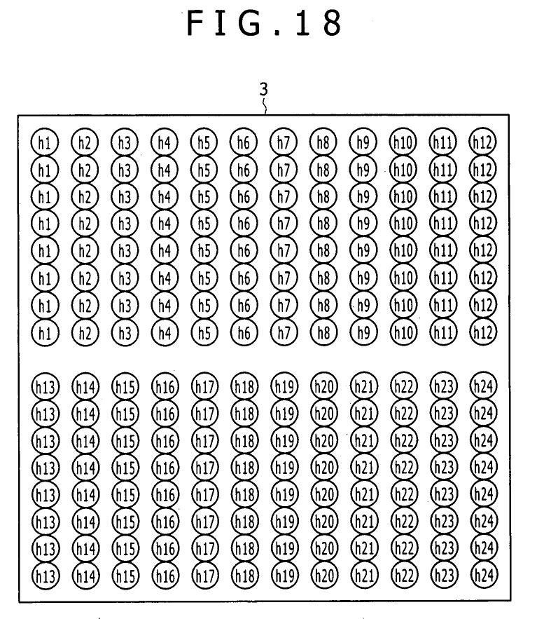

FIG. 18 shows an example wherein the storage capacity of the hologram memory 3 is raised from that of FIG. 17 and element holograms h1, h2, . . . , h24 are recorded. As seen in FIG. 18, each of the element holograms h1, h2, . . . , h24 is disposed continuously at a plurality of places closely contacting with each other in the vertical direction. It is considered that each of the columns in the example of FIG. 17 is divided into two portions in which different element holograms from each other are recorded.

The example of FIG. 18 is suitable where a sufficient storage capacity is not obtained if all of element holograms of the same data substance are disposed in a column direction as seen in FIG. 17.

Naturally, also such examples that each column is divided into three or more portions may be applicable.

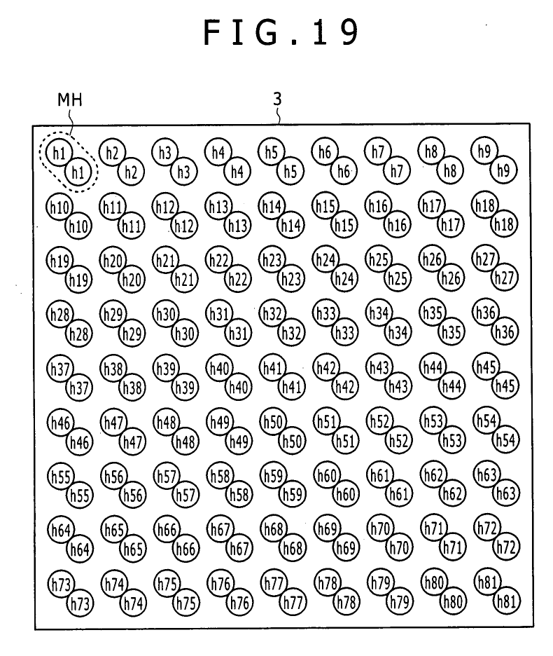

FIG. 19 shows an example wherein a plurality of element holograms of the same data substance are recorded collectively in a closely contacting relationship with each other in an oblique direction.

In FIG. 19, while element holograms h1, h2, . . . , h81 of different data substances are recorded on the hologram memory 3, each of the element holograms h1, h2, . . . , h81 is recorded at two places closely contacting with each other. For example, as seen from the element holograms h1 indicated by broken line portion MH, two element holograms h1 of the same data substance are disposed collectively in a closely contacting relationship with each other in an oblique direction.

Also in the case of the present example, even if hand-shaking or the like occurs, the probability in which data can be read from the collected element holograms can be further raised.

Further, though not shown, a group of element holograms of the same data substance, for example, like those of the broken line portion MH may be recorded at a plurality of places on the hologram memory 3 so that the reading probability may be raised against the randomness of the scanning locus.

While several arrangement examples of element holograms are described above, it is considered that further various particular arrangement examples where a plurality of element holograms of the same data substance are recorded are possible.

Actually, a particular arrangement scheme may be determined taking the reading probability into consideration together with the size of data to be recorded on the hologram memory 3.

Where manual scanning is used, also it is unnecessary to determine element holograms to a particular arrangement scheme, and therefore, an optimum arrangement scheme of element holograms may be determined based on data (content data or the like) to be recorded on the hologram memory 3.

For example, where content data of a small data size are to be recorded on the hologram memory 3, such arrangement as seen in FIG. 17 is used taking the reading probability into consideration, but where content data of a large data size are to be recorded, such arrangement as seen in FIG. 19 is used in order to assure the capacity. In this manner, the arrangement scheme may be determined flexibly.

It is to be noted that, also where a plurality of element holograms of the same data substance are provided as in the examples described above, reproduction action and progress situation display can be executed similarly by the process of FIG. 7.

Particularly at step F108, the reading progress situation may be calculated not from the number of read out element holograms but from the number of readout data stored in the nonvolatile memory 32 and the number of data blocks BLK of original recording data or from the size of all data stored in the nonvolatile memory 32 and the overall size of the original recording data. By the calculation, whatever number of element holograms of the same data substance are recorded and in whatever arrangement they are recorded, this has no influence on the progress situation display, and the reading progress situation can be presented correctly to the user.

[4. Reproduction Process Including Map Display]

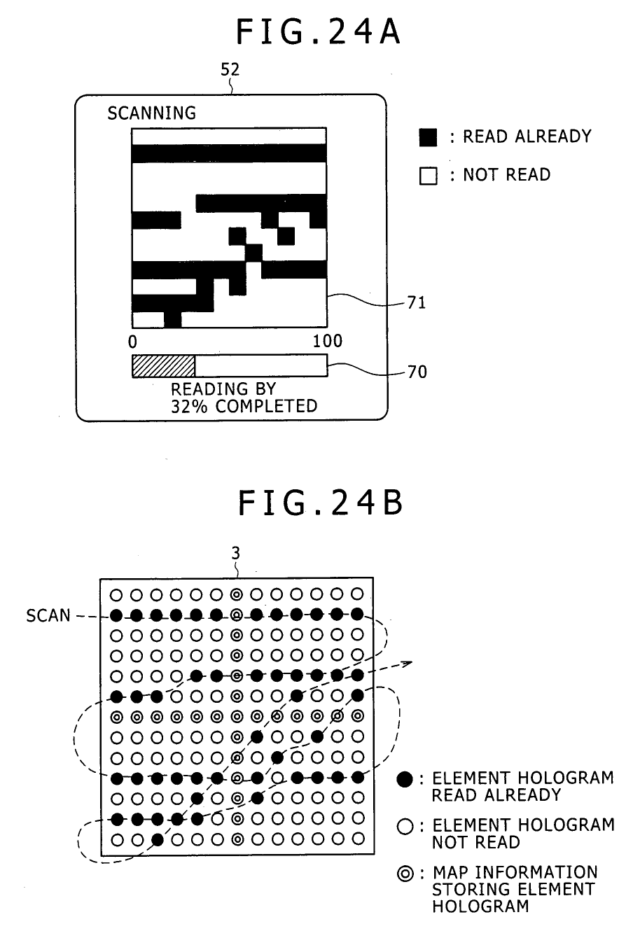

Now, an example wherein a position presentation image is displayed as a readout situation display upon reproduction (upon manual scanning) is described. The position presentation image is an image which indicates the position of an element hologram whose reading is completed on the hologram memory 3 as an image like a reading map display 71 hereinafter described, for example, with reference to FIGS. 24A and 24B.

First, a hologram memory 3 which is suitable for a system wherein the position presentation image is displayed by the hologram reader 6 is described.

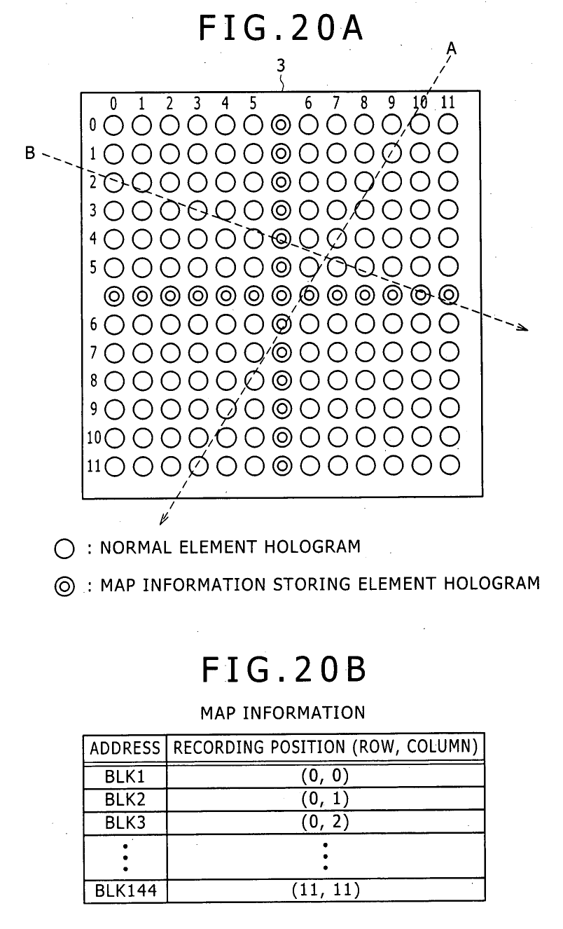

FIG. 20A shows element holograms on the hologram memory 3. Here, ◯ indicates a normal element hologram on which data of a data block BLK, that is, main data of a main object of recording and reproduction is recorded, and □ indicates an element hologram on which map information is recorded. In the following, for distinction in description, an element hologram of ◯ is referred to as “normal element hologram” and an element of □ is referred to as “map information storing element hologram”. The normal element hologram here is an element hologram same as any of element holograms of the examples described hereinabove with reference to FIGS. 1A to 19.

The map information is data by which at least locations of normal element holograms in which data of data blocks BLK are recorded on the hologram memory 3 and is data to be used in a process of the reading map display 71.

In this instance, where normal element holograms are arrayed in 12 rows×12 columns except map information storing element holograms, the map information storing element holograms are disposed so as to form a + mark at the center of the array. The map information storing element holograms have map information of the same substance recorded thereon. In other words, if at least one of the map information storing element holograms is read, then the hologram reader 6 can obtain map information of the hologram memory 3.

Then, the reason why the map information storing element holograms are disposed so as to form a + mark is that it is intended to make it possible to fetch the map information with certainty at an early stage after manual scanning is started. In other words, it is made possible to scan any of the map information storing element holograms at a point of time at which the manual scanning locus first crosses the hologram memory 3 once.

For example, even if manual scanning is performed in the direction indicated by an arrow mark A in the figure, or even if manual scanning is performed in the direction indicated by another arrow mark B, at lease one of the map information storing element holograms can be read in upon such manual scanning.

The map information recorded on the map information storing element holograms is, for example, such data as illustrated in FIG. 20B.

While, in the example of FIG. 20A, 144 normal element holograms are recorded in 12 rows having row numbers from the row number 0 to the row number 11 and 12 columns having column numbers from the column number 0 to the column number 11 except the map information storing element holograms, it is assumed that the normal element holograms represent data where original recording data are divided into and recorded as 144 data blocks BLK. In other words, the 144 normal element holograms have data of the different data blocks BLK from one another recorded thereon.

In this instance, the map information represents locations of the normal element holograms, in which data of the block numbers (BLK1, BLK2, . . . , BLK144) of the data blocks BLK of the original recording data are recorded, for example, in a row number and a column number. For example, the map information indicates that a normal element hologram in which the data block BLK1 is recorded is recorded in the 0th row of the 0th column, a normal element hologram in which the data block BLK2 is recorded is recorded in the 0th row of the first column, . . . .

If the hologram reader 6 fetches such map information as described above from the hologram memory 3, then the location on the hologram memory 3 of each of readout data read out from a normal element hologram and decoded and stored in the nonvolatile memory 32 can be discriminated from the data block number included in the header information of the readout data. Therefore, reading map display 71 which displays the portion of the normal element holograms which data are fetched already can be executed.

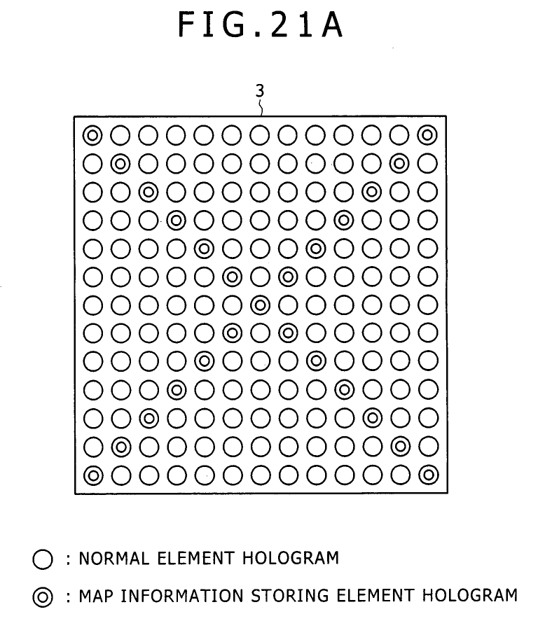

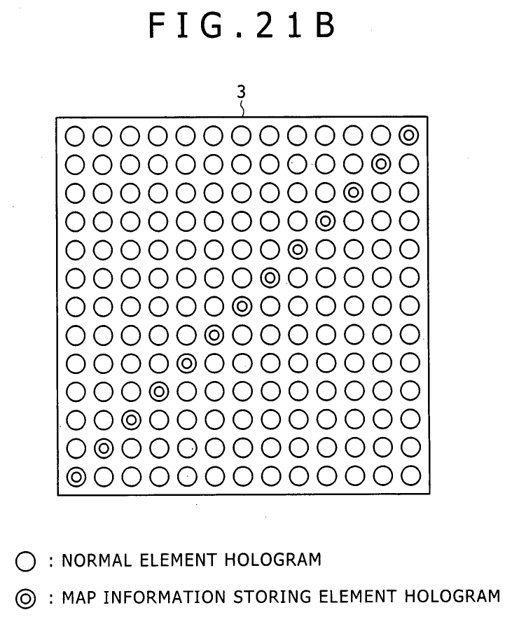

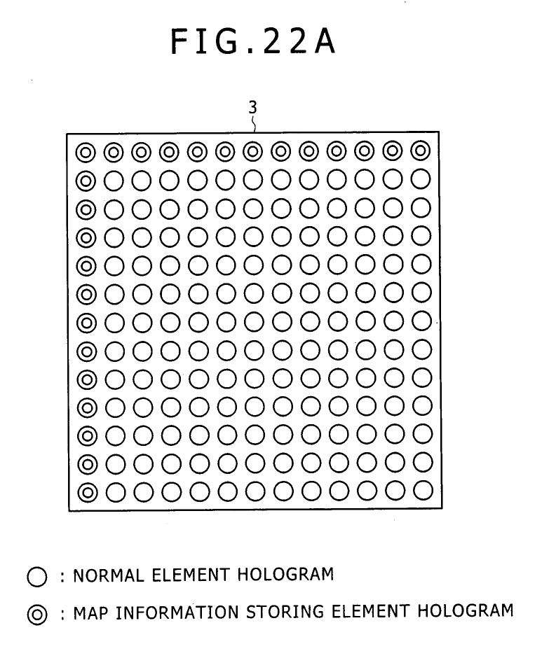

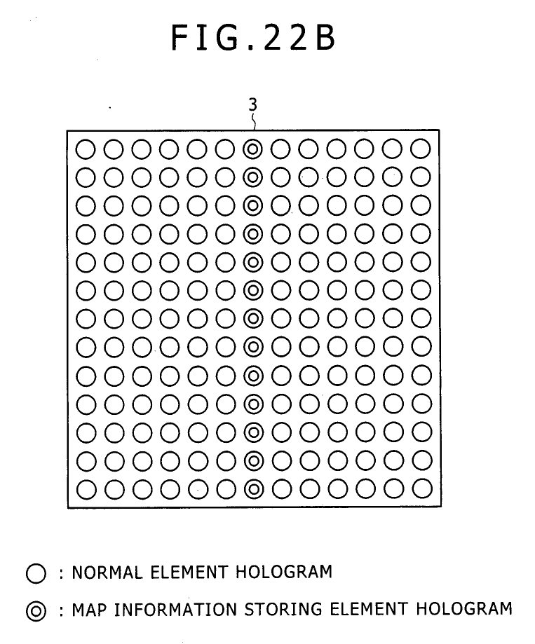

It is to be noted that, prior to description of action of the hologram reader 6, various suitable examples of arrangement of element holograms are described with reference to FIGS. 21A and 21B and FIGS. 22A and 22B.

FIG. 21A shows an example wherein map information storing element holograms are disposed in X-shaped arrangement on element holograms arrayed in m rows and n columns.

FIG. 21B shows an example wherein map information storing element holograms are disposed in an oblique direction from the right upper vertex to the left lower vertex on element holograms arrayed in m rows and n columns.

FIG. 22A shows an example wherein map information storing element holograms are disposed in the uppermost row and the left end column of element holograms disposed in m rows and n columns.

FIG. 22B shows an example wherein map information storing element holograms are disposed at all positions of one column of element holograms disposed in m rows and n columns.

In all of FIGS. 21A, 21B, 22A and 22B, a plurality of map information storing element holograms are disposed continuously on a line or lines such that, on an element hologram array of the hologram memory 3, the line or each of the lines extends from one end to the other end of the element hologram array.

If the map information storing element holograms are disposed in any of such manners as described above, then the hologram reader 6 can read in one of the map information storing element holograms almost with certainty immediately after manual scanning, in which the scanning locus is indefinite, is started. Consequently, display in which the map information is used can be performed while manual scanning is performed later.

It is to be noted that further various arrangement examples of map information storing element holograms may be possible. It is appropriate to arrange map information storing element holograms so as to assure a high probability in which they can be read in at an early stage after manual scanning is started.

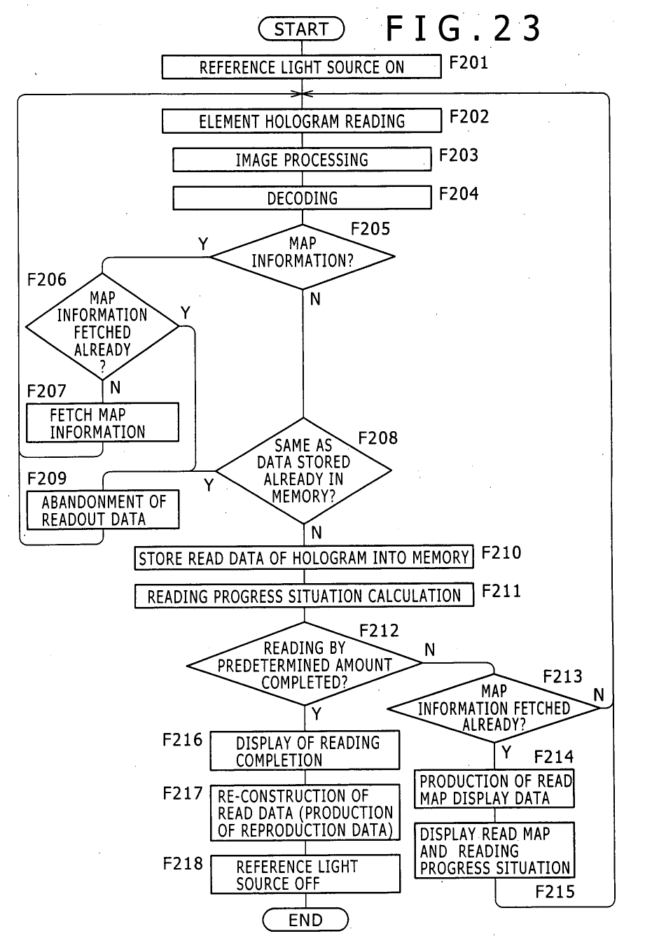

Action of the hologram reader 6 which executes reading map display is described with reference to FIGS. 23, 24A and 24B. FIG. 23 illustrates a process which is executed under the control of the system controller 51 upon data reproduction.

In order to start reproduction from the hologram memory 3, the system controller 51 issues an instruction to the light emission driving section 14 to cause the reference light source 16 to emit light at step F201. If the user performs manual scanning in this state, then the reproduction image light L5 of the element holograms is successively detected by the imager 12.

At step F202, the imager 12 and the hologram scan control section 15 act to fetch the reproduction image light L5 of a certain element hologram thereby to obtain digital data as a reproduction image signal (two-dimensional image signal). The two-dimensional image signal of the certain element hologram outputted from the hologram scan control section 15 is stored once into the information memory 31 by the memory controller 21.

If the system controller 51 confirms fetching of the reproduction image signal of the element hologram as the action at step F202, then it causes an image process at step F203 and a decoding process at step F204 to be executed.

In particular, at step F203, the system controller 51 controls the optical correction variable calculation section 22 and the geometrical distortion correction variable calculation section 23 to execute respective processes for the two-dimensional image signal fetched in the information memory 31.

At step F204, the system controller 51 controls the binarization section 24 and the decoding section 25 to execute respective processes for the two-dimensional image signal to obtain decoded data (readout data from the element hologram).

After the readout data of the certain one element hologram are decoded at step F204, the system controller 51 decides at step F205 whether or not the data is map information. In short, the system controller 51 decides whether the element hologram read at this time is a map information storing element hologram or a normal element hologram.

If the decoded data is not map information, in other words, if the read element hologram is a normal element hologram and the data is of a certain data block BLK of the recorded data, then the processing advances to step F208. Then, the memory controller 21 which receives the instruction from the system controller 51 decides whether or not the read data is stored already in the nonvolatile memory 32. For example, the memory controller 21 may confirm an address, a data block number and so forth included in the decoded readout data and confirm whether or not readout data of an address and a data block number same as those are stored in the nonvolatile memory 32.

If it is decided at step F208 that the decoded data is not stored in the nonvolatile memory 32 as yet, then the processing advances to step F210. At step F210, the memory controller 21 controls the decoded data to be stored as readout data from the certain one normal element hologram into the nonvolatile memory 32.

Then at step F211, the memory controller 21 calculates a progress situation of the data reading out. In this instance, not the map information is used, but, for example, a readout progress situation may be calculated similarly as at step F108 of FIG. 7. For example, the calculation of a progress situation may be performed such that what percent the progress situation is, is determined from the data size (or data block number) of the entire readout data stored already in the nonvolatile memory 32 and the data size of the entire original data to be reproduced (or the data block number of the entire recorded data).

At step F212, the system controller 51 decides whether or not reading of a predetermined amount of readout data is completed. This is a decision of whether the progress situation of reading calculated at step F211 reaches 100%.

If the data reading out from the hologram memory 3 does not reach a state of completion by 100%, then the processing advances to step F213, at which the system controller 51 decides whether or not map information is fetched already. If map information is not yet fetched, then the processing returns to step F202, at which a process regarding an element hologram from which reproduction image light is read is executed similarly.

On the other hand, if it is decided at step F208 that the decoded data is stored already in the nonvolatile memory 32, then the processing advances to step F209, at which the system controller 51 abandons the decoded data, that is, the readout data from the certain normal element hologram. Thereafter, the processing returns to step F202.

It is to be noted that, though not shown in FIG. 23, also when a decoding error occurs at step F204, the data should be abandoned and the processing should return to step F202.

If it is decided at step F205 that the decoded data is map information, then the processing advances to step F206, at which the system controller 51 decides whether or not map information is fetched already.

When map information is decoded for the first time, since map information is not fetched as yet, the processing advances to step F207, at which the decoded map information is fetched. For example, the decoded map information is stored into a predetermined region of the information memory 31, nonvolatile memory 32 or variable memory 26 so that it can be referred to later.

Then, the processing returns to step F202.

After the map information is fetched at step F207 once, even if reading of a map information storing element hologram is performed later and the processing advances to step F206, since the map information has been fetched already, the processing advances to step F209. Therefore, the processing may advance to step F209, at which the read data (map information) is abandoned, and then return to step F202.

After the map information is read in, a normal element hologram is read out, and when the processing advances to step F210→F211→F212→F213, it advances to step F214. At step F214, the system controller 51 uses the map information to produce read map display data. Then, the system controller 51 controls the display section 52 to display the read map and the progress situation. Then, the processing returns to step F215.

After the map information is fetched, every time data obtained by scanning and decoding a normal element hologram is stored into the nonvolatile memory 32, the display process at step F215 is performed. Therefore, as the scanning proceeds, the display of the read map and the progress situation proceeds such that the read portion increases gradually.

Display examples at steps F214 and F215 are shown in FIGS. 24A and 24B.

While a display example of the display section 52 is shown in FIG. 24A, a reading map display 71 and a progress situation bar 70 are displayed on the display section 52.

The progress situation bar 70 indicates a percentage of readout data read already calculated at step F211.

The reading map display 71 represents the plane of the hologram memory 3 with the display area thereof and indicates the position of each element hologram (readout data) read already as a portion of ▪ on the plane.

For example, in FIG. 24B, the locus of manual scanning on the hologram memory 3 is indicated by a broken line, and each normal element hologram read is indicated by while each normal element hologram which is not read as yet is indicated by ◯. At a point of time at which reading of element holograms of , that is, storage of decoded data into the nonvolatile memory 32, is completed when manual scanning is performed as indicated by a broken line, the reading map display 71 is performed as seen from FIG. 24A in response to the positions of the element holograms of .

As described above, in the map information of FIG. 20B, the location of each element hologram corresponding to the block number of the data block BLK of decoded readout data is stored.

Accordingly, if the system controller 51 acquires block numbers of readout data stored in the nonvolatile memory 32 and then determines the locations corresponding to the block numbers from the map information, then such reading map display 71 which displays the positions of the element holograms from which data are fetched already as seen in FIG. 24A can be executed.

As the processes till now are repeated, the normal element holograms on the hologram memory 3 are read out at random in response to the manual scanning of the user, and data of the data blocks BLK of FIG. 1C are stored in a random order into the nonvolatile memory 32.

If the reading process situation is calculated as 100% at step F211 and it is decided at step F212 that reading of the predetermined amount of data is completed, then the processing advances to step F217, at which reading completion display is performed on the display section 52. In other words, the progress situation bar 70 and the numerical value are displayed in a state of completion by 100%. The reading map display 71 displays a plane filled with ▪.

Further, at this time, a message of urging the user to end the manual scanning because of completion of the scanning may be displayed.

Then, at step F217, the system controller 51 issues an instruction to the memory controller 21 to re-construct the readout data stored in the nonvolatile memory 32. In particular, the system controller 51 extracts the data of the data blocks BLK and re-arranges the data in the order of the data block number to produce reproduction data.

Thereafter, the system controller 51 controls the light emission driving section 14 at step F218 to turn off the reference light source 16 to end the irradiation of the reproduction reference light L4. The reproduction process is ended therewith.

It is to be noted that, since the display of the progress situation bar 70 can be performed also at a point of time prior to reading in of map information, the display may be started when it is decided at step F213 that map information is not read in as yet.

According to the example of the process of FIG. 23 described above, in addition to the process described hereinabove with reference to FIG. 7, the reading map display 71 in which a position for which reading is completed is successively filled with ▪ as the manual scanning proceeds is executed.

By performing such display, the user can visually grasp the reading situation upon manual scanning, which is suitable in use. Further, according to the reading map display 71, since the user can roughly recognize the positions at which reading is completed or is not completed on the hologram memory 3, the user can perform manual scanning so as to aim at a non-read portion thereby to complete the manual scanning as efficiently as possible.

Incidentally, it is described hereinabove with reference to FIGS. 9 to 19 that, in order to raise the reading probability of data upon manual scanning, a plurality of element holograms of the same data substance may be recorded.

Where a plurality of element holograms of the same data substance are recorded in this manner, the reading map display 71 may be performed in the following manner.

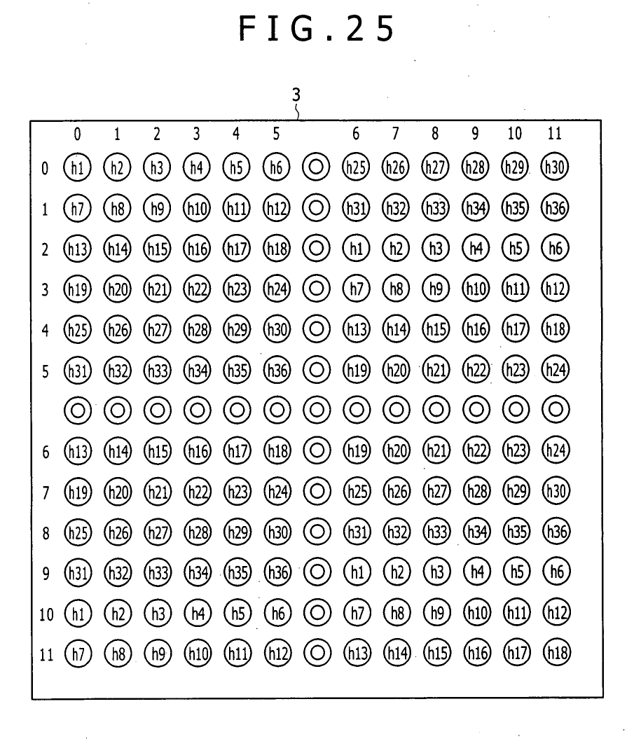

FIG. 25 shows the hologram memory 3 on which each of the element holograms h1, h2, . . . , h36 is recorded at four places. Further, map information storing element holograms indicted by □ are disposed in a cross shape.

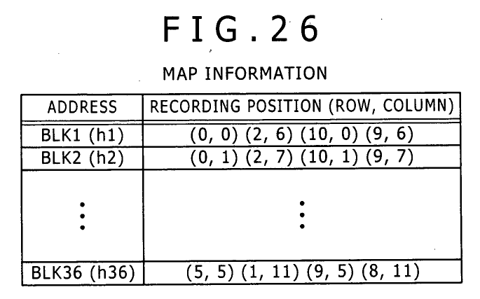

For example, where a plurality of normal element holograms of the same data substance are recorded in this manner, map information to be recorded on the map information storing element holograms has, for example, such a substance as illustrated in FIG. 26. In particular, although the map information is similar to that of FIG. 20B in that it has the substance which indicates recorded positions corresponding to the data block numbers, since data of each data block BLK is disposed on a plurality of normal element holograms, the location of each of the normal element holograms is indicated.

For example, in the example of FIG. 25, the four element holograms h1 on which data of the data block number BLK1 is recorded are recorded at locations of the 0th row and 0th column, the 2nd row and sixth column, the 10th row and 0th column and the 9th row and sixth column. Accordingly, the map information indicates information of the 0th row and 0th column, the 2nd row and sixth column, the 10th row and 0th column and the 9th row and sixth column coordinated with the data block number BLK1 as seen in FIG. 26.

The processes at step F214 and F215 on the hologram reader 6 side may be such that, with regard to each data block for which reading is completed, map information is referred to from the data block number, and all of the locations stored corresponding to the map information are displayed as already read locations. For example, if data of the data block number BLK1 is read out from the normal element hologram h1 in the 0th row and 0th column, such reading map display 41 that the four locations in the 0th row and 0th column, the 2nd row and 6th column, the 10th row and 0th column, and the 9th row and 6th column are displayed as ▪ is executed.

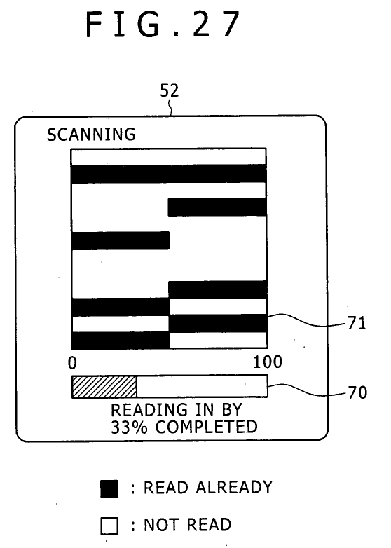

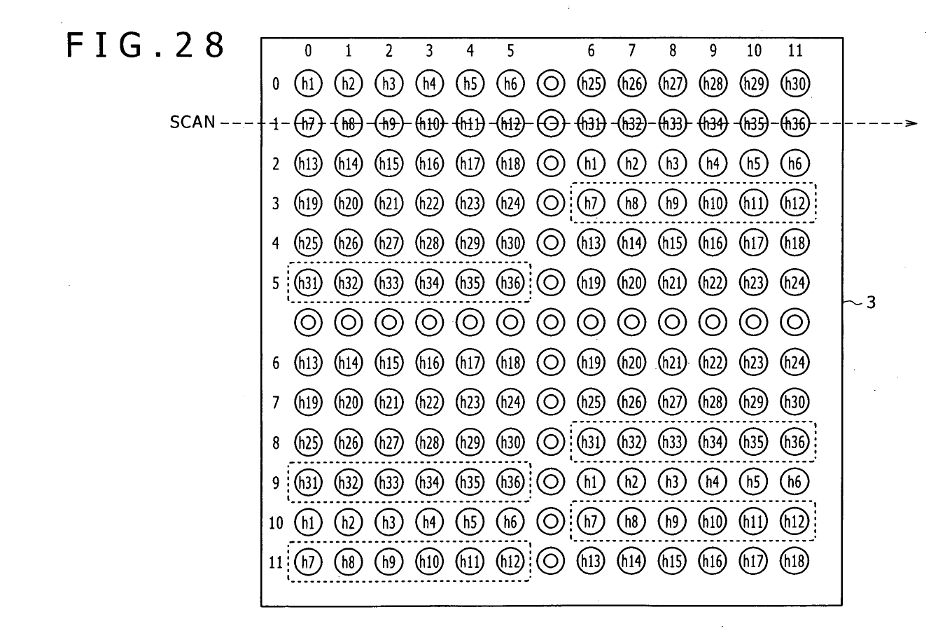

Display examples by this process are shown in FIGS. 27 and 28. While FIG. 28 shows the hologram memory 3 similar to that of FIG. 25, it is assumed that manual scanning is performed along a row of the row number 1 on the hologram memory 3 as indicated by a broken line.

In this instance, the normal element holograms h7, h8, h9, h10, h11, h12, h31, h32, h33, h34, h35 and h36 recorded on the row of the row number 1 are read out. However, it is considered that also recorded data of normal element holograms surrounded by broken lines which have the same data substances as those of the above-specified normal element holograms are read already.

Therefore, at a point of time at which scanning for one row is performed as seen in FIG. 28, the display section 52 may display that not only the scanned element holograms but also element holograms having the same data substances as those of the scanned element holograms are read already as seen in FIG. 27. In particular, if the recorded position corresponding to each of the data block numbers of data read referring to such map information as illustrated in FIG. 26 is displayed as ▪, then such reading map display 71 as seen in FIG. 27 is performed.

By this, even where a plurality of normal element holograms of the same data substance are recorded, a reading situation which the user wants to know can be represented appropriately by the reading map display 71.

Now, an example wherein the scanning position is indicated on the reading map display 71 described above is described.

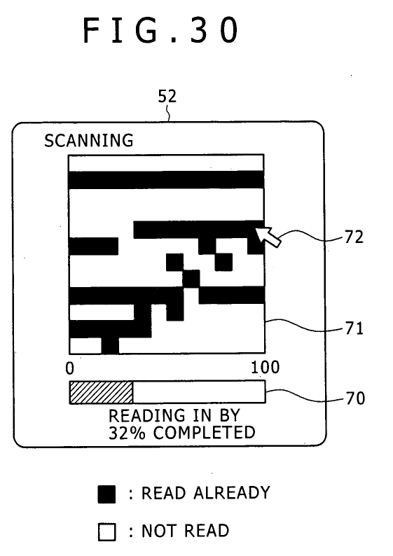

The display of the scanning position is a display indicating the reading position when the user is performing manual scanning, that is, the position at which the reproduction reference light L4 is irradiated. According to the display of the scanning position, for example, a scan marker 72 is displayed on the reading map display 71 as seen in FIG. 30. The scan marker 72 is displayed such that the display position is moved in response to the manual scanning of the user.

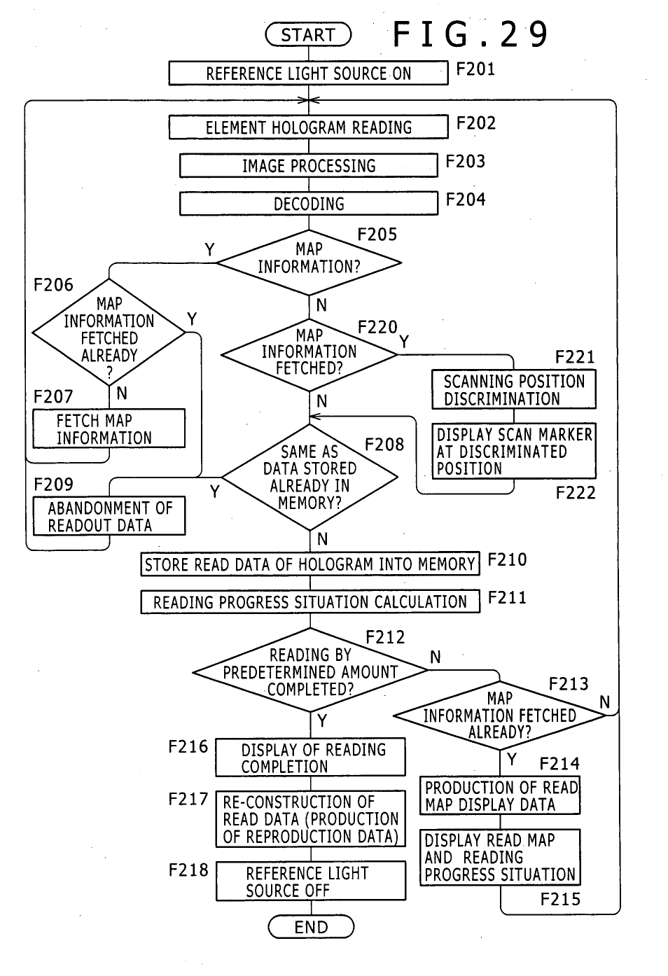

A process of the display of the scan marker 72 is illustrated in FIG. 29. It is to be noted that steps F201 to F218 of FIG. 29 are similar to those of FIG. 23 and overlapping description of the steps is omitted. In FIG. 29, steps F220, F221 and F222 are added to the process of FIG. 23.

If data from a certain normal element hologram is decoded and the processing advances from step F205 to F220, then the system controller 51 decides whether or not map information is fetched already at the point of time. This is a decision of whether or not the present point of time is after the process at step F207 is performed.

If the present point of time is before map information is fetched, then the processing advances to step F208.

If the processing advances to step F220 after map information is fetched, then the processing advances to step F221, at which the system controller 51 discriminates the scanning position. For this decision, such map information as illustrated in FIG. 20B should be referred to. In other words, based on the data block number of the decoded data, a row number and a column number of the read normal element hologram as the recording position on the hologram memory 3 are obtained from the map information.

Then at step F222, the system controller 51 causes the scan marker 72 to be displayed at a position corresponding to the discriminated row number and column number on the reading map display 71.

After this process, the processing advances to step F208.

Where the process of FIG. 29 is performed, the scan marker 72 is displayed together with the reading map display 71 as seen in FIG. 30, and besides the scan marker 72 is moved so as to indicate the locus of the manual scanning of the user.

The user can confirm from the scan marker 72 what location of the hologram memory 3 is being scanned. Accordingly, where the scan marker 72 is displayed on the reading map display 71, the user can easily perform manual scanning so as to aim at a position which is not read as yet. Consequently, the manual scanning can be proceeded efficiently and the usability is further augmented.

It is to be noted that the fact that, when a certain normal element hologram is read at step F202, the scan marker display process at steps F221 and F222 is performed prior to the discrimination process at step F208 signifies that the scan marker 72 is displayed so as to present the position of the normal element hologram irrespective of whether the normal element hologram has been read or not. As a result, the scan marker 72 is displayed so as to smoothly move in response to the manual scanning of the user.

Incidentally, where the address as a data block number and the recorded position in the map information coincide in a one-by-one corresponding relationship to each other as in the case of FIG. 20B, the scanning position, that is, the position of the normal element hologram read, can be discriminated immediately from the map position at step F221. However, where a plurality of normal element holograms of the same data substance are recorded, for the object of display of the scan marker 72, it is necessary to include such information as allows identification of the normal element holograms of the same data substance in the map information.

For example, in such a case of map information as seen in FIG. 26, when data of the data block number=BLK1 is decoded, the scanning position cannot be discriminated, that is, it cannot be discriminated to which one of the normal element holograms in the 0th row and 0th column, the 2nd row and 6th column, the 10th row and 0th column, and the 9th row and 6th column, the read out element hologram h1 corresponds.

Therefore, in order to decide the recorded position of each of the element holograms of the same data substance, for example, a sub address is added to the header and the map information of each of the element holograms.

For example, sub addresses AD1, AD2, AD3 and AD4 for identifying the four element holograms h1 are set together with the data block number BLK1.

Then, the data block number BLK1 and a sub address AD1 are recorded on the element hologram h1 in the 0th row and 0th column; the data block number BLK1 and a sub address AD2 are recorded on the element hologram h1 in the 2nd row and 6th column; the data block number BLK1 and a sub address AD3 are recorded on the element hologram h1 in the 10th row and 0th column; and the data block number BLK1 and a sub address AD4 are recorded on the element hologram h1 in the 9th row and 6th column.

The information is included in the map information in a manner wherein it can be discriminated. For example, the sub addresses AD1, AD2, AD3 and AD4 are recorded corresponding to the data block number BLK1, and information of the recorded positions of the 0th row and 0th column, the 2nd row and sixth column, the 10th row and 0th column and the 9th row and sixth column is recorded corresponding to the sub addresses AD1, AD2, AD3 and AD4, respectively.

By this, even where a plurality of normal element holograms of the same data substance are recorded, the scan marker 42 can be displayed correctly.

It is to be noted that, while the progress situation bar 70 is described hereinabove as one of readout situation displays, as a readout situation display, an image of some other shape such as a circular shape may be used in place of the progress situation bar 70 or only a percentage may be displayed in numerals. Further, a display system wherein not a liquid crystal display apparatus but a plurality of LEDs may be used and successively lit to represent the progress situation may be used. Also the reading map display may be made in various display forms similarly.

Further, in addition to or in place of the display section 52 on the body of the hologram reader 6, a display section of an external apparatus connected to the external apparatus interface 41 may be used to execute display of the progress situation.

Further, the substance of the map information to be used for the display process of the reading map display 71 may assume various forms, but must be configured only so as to at least allow confirmation of the position information of read data on the hologram memory 3. Then, the form of the map information, that is, the form for indicating the position information of an element hologram regarding each data is not limited to those of the examples of FIGS. 20B and 26, but any form may be assumed.

Furthermore, the map information may include management information such as the name, a data attribute, the total capacity, the data block number and so forth of original recording data. Particularly in this instance, it is possible to set the header of data to be recorded on each normal element hologram such that it is only necessary to place at least the address such as the data block number in the header.

Or, the header of data recorded on each normal element hologram may include location information such as the map information described above. In other words, each normal element hologram includes information of the recorded position of the normal element hologram itself. Where this configuration is employed, even if map information storing element holograms are not necessarily used, reading map display can be executed.

[5. Second Example of a Configuration of the Hologram Reader and a Reproduction Process Including Reading Progress Situation Sound Presentation]

In the examples described above, the progress situation bar 70 or the reading map display 71 is used to present the data reading out situation from the hologram memory 3 to the user. However, the data reading out situation may be presented to the user not by display but by sound.

The hologram reader 6 having a configuration (second configuration) which presents the data reading out situation by sound is shown in FIG. 31. It is to be noted that like elements to those of FIG. 6 are denoted by like reference symbols and description thereof is omitted.

This hologram reader 6 does not include a display section but includes a sound synthesis section 54 and a speaker 55. The sound synthesis section 54 produces a sound signal, for example, as message voice in accordance with an instruction of the system controller 51 and supplies the sound signal to the speaker 55 so as to be outputted as sound.

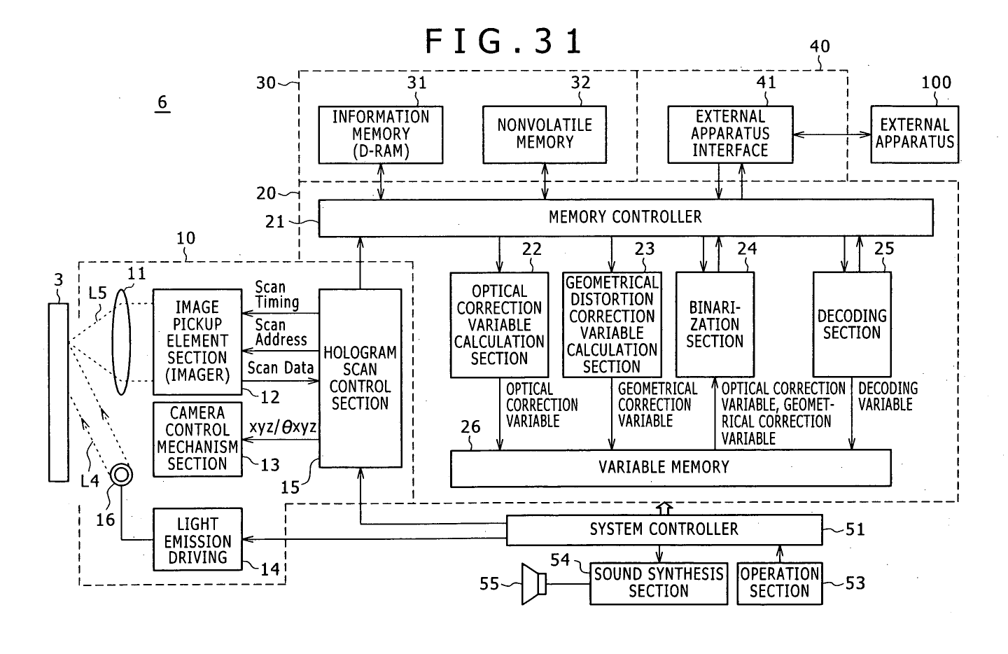

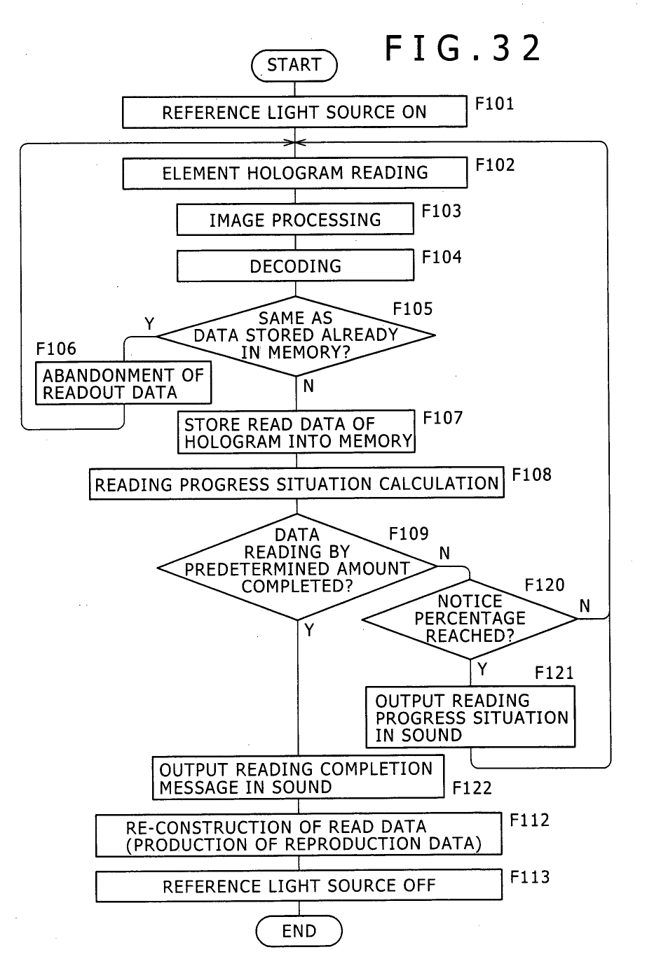

FIG. 32 illustrates a process where a data reading out situation is outputted in sound. It is to be noted that, since steps F101 to F109 and steps F112 and F113 shown in FIG. 32 are similar to those of FIG. 7, description of them is omitted.

Also in the process of FIG. 32, similarly as in the process of FIG. 7, the system controller 51 decides at step F109 whether or not data reading of a predetermined amount is completed. However, if reading of data of a predetermined amount is not completed as yet, then the processing advances to step F120. At step F120, it is decided whether or not the percentage as the progress situation calculated at step F108 reaches a percentage at which a notice to the user should be issued.

For example, as a percentage at which a notice is to be issued to the user, multiples of 10% are set. In particular, 10%, 20%, 30%, 40%, 50%, 60%, 70%, 80%, and 90% are set as notice percentages.

The process at step F120 decides whether or not the progress situation at the point of time reaches any of the notice percentages.

If it is not a timing at which one of the notice percentages is reached newly, then the system controller 51 immediately returns the processing to step F102 and continues the processing.

If the percentage of the progress situation calculated at step F108 reaches one of the notice percentages, then the processing advances from step F120 to step F121. Then, the system controller 51 issues an instruction to the sound synthesis section 54 to produce a sound signal representative of the notice percentage so that it is outputted in sound from the speaker 55.

By the process described, at a point of time at which the reading out progress situation reaches, for example, 30%, voice of “reading is completed by 30%” is outputted. Thereafter, at a point of time at which the reading progress situation reaches 40%, voice of “reading is completed by 40%” is outputted.

It is to be noted that the notice percentage may be set at equal distances to multiples of 5%, multiples of 25% or the like or may be set not at equal intervals. For example, the notice percentage may be set such that the distance between noticed percentages may become finer toward completion by 100%, for example, like 25%, 50%, 75%, 80%, 90% and 95%.

If it is decided at step F109 that reading of a predetermined amount of data is completed, then the processing advances to step F122. At this time, the system controller 51 issues an instruction to the sound synthesis section 54 to output a voice message of completion of reading. For example, such voice as “reading is completed by 100%. Please end scanning” is outputted.

Then, the data stored into the nonvolatile memory 32 are re-constructed to obtain reproduction data at step F112, and the reference light source 16 is turned off at step F113 thereby to end the reproduction process.

Also where a notice of a data reading out situation is issued in sound to the user as described above, the user can execute manual scanning while grasping the reading situation. This is preferable in use.

Further, where a display section is not provided but a notice is issued through a sound output, it is not necessary to assure a display section on a housing, and this is advantageous in miniaturization of the hologram reader 6.

Naturally, such an example may be available that a display section is provided such that display of the progress situation bar 70 or the reading map display 71 is executed as described hereinabove while a notice of a progress situation is issued through a sound output.

Incidentally, while an example wherein a notice of a percentage as a progress situation is given in sound, guide voice of manual scanning may be outputted.

If the map information for the reading map display 71 described hereinabove is used, then the user can decide what location on the hologram memory 3 is being scanned. For example, the user can discriminate also such a position as is not scanned readily.

For example, if such a situation that manual scanning of the user does not readily come to a right upper portion of the hologram memory 3 is discriminated, then such a process that message voice such as “please scan around the right upper corner” is outputted may be executed.

Also by such guide voice, the user can be urged to efficiently carry out manual scanning, and this is effective to reduction of the scanning time.

It is to be noted that, where a sound outputting function is provided as in the case of FIG. 31, electronic sound or a melody may be generated during execution of a reading process so that the user may be notified that scanning is being executed. For example, a melody is developed for a period of time from starting of reading till completion of reading. The user recognizes that the period of time within which such electronic sound or melody is developed is a period within which manual scanning should be performed. Also it is possible to urge the user to perform an appropriate manual scanning motion in this manner.

[6. Angle Multiplexed Recording and Reproduction of the Hologram Memory]

While basic recording and reproduction action of the hologram memory 3 is described above with reference to FIGS. 1A to 1C, significant increase of the capacity can be anticipated by recording element holograms in accordance with the angle multiplexing method. Here, the hologram memory 3 in an angle multiplexed recorded form is described.

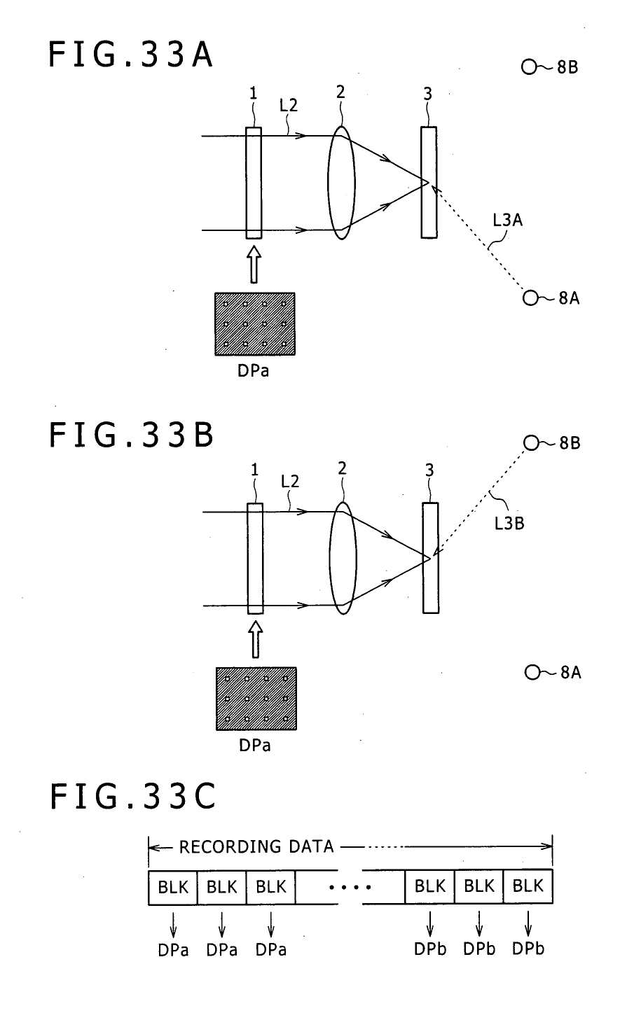

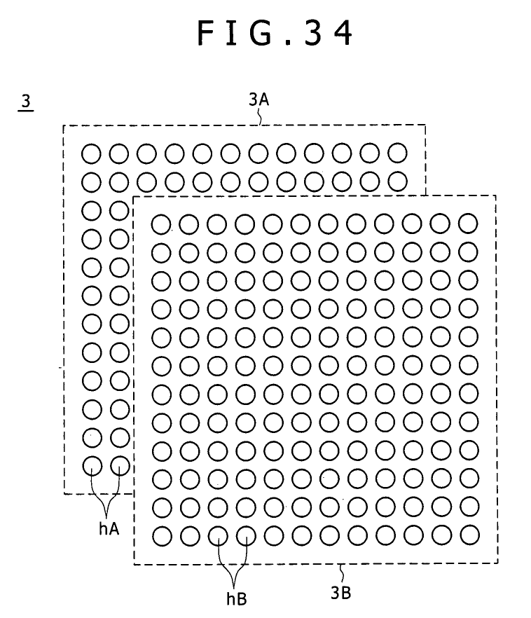

A manner of angle multiplexed recording is illustrated in FIGS. 33A to 33C. In this instance, as illustrated in FIGS. 33A to 33C, recording reference light is irradiated as recording reference beams L3A and L3B from the light source positions 8A and 8B at different angle states upon the hologram memory 3. It is to be noted that the light source positions 8A and 8B are set as positions from which reference light is irradiated upon the hologram memory 3 by a recording optical system, but this does not require arrangement of different light source elements individually at the positions. For example, the light source positions 8A and 8B may be changed over by changing the light path from a single light source.

FIG. 33C illustrates one recorded data, for example, as computer data or AV content data, and this is divided into data blocks BLK of predetermined bytes as described hereinabove with reference to FIGS. 1A to 1C. Thus, for example, as seen in FIGS. 1A to 1C, two-dimensional images DP produced by encoding the data of the front half data blocks BLK are denoted by DPa while two-dimensional images DP produced by encoding the data of the latter half data blocks BLK are denoted by DPb.

The two-dimensional images DPa and DPb are displayed individually on the liquid crystal panel 1 and recorded as element holograms as described hereinabove with reference to FIGS. 1A to 1C.

Here, when the data, for example, of the front half data blocks BLK of the recorded data are successively recorded, each of the two-dimensional images DPa of the data is supplied to the liquid crystal panel 1 so as to display a two-dimensional page data image as seen in FIG. 33A. At this time, object light L2 as the two-dimensional page data image passing through the liquid crystal panel 1 is condensed by the condenser lens 2 and irradiated as a spot on the hologram memory 3. During this period, the recording reference beam L3A of a first angle from the light source position 8A is provided to the hologram memory 3. By an inference fringe by the recording reference beam L3A and the object light L2, an element hologram regarding the two-dimensional image DPa (first element hologram) is recorded.

In this state, the data of the front half data blocks BLK are successively recorded as first element holograms.

Subsequently, when the data, for example, of the latter half data blocks BLK of the recording data are to be successively recorded, the two-dimensional image DPb regarding each of the data is supplied to the liquid crystal panel 1 so as to be displayed as seen in FIG. 33B. At this time, the object light L2 as the two-dimensional page data image passing through the liquid crystal panel 1 is condensed by the condenser lens 2 and irradiated as a spot on the hologram memory 3. Within this period, the recording reference beam L3B of the second angle from the light source position 8B is provided to the hologram memory 3. By an interference fringe by the recording reference beam L3B and the object light L2, an element hologram regarding the two-dimensional image DPb (second element hologram) is recorded.

In this state, the data of the latter half data blocks BLK are successively recorded as second element holograms.

By such recording action as described above, a first face 3A on which a large number of first element holograms hA are formed and a second face 3B on which a large number of second element holograms hB are formed are formed on the hologram memory 3 as seen in FIG. 3. In short, the hologram memory 3 on which element holograms are recorded in the angle multiplexed method on a two-dimensional plane is formed. The first element holograms hA are element holograms on which the two-dimensional images DPa are recorded while the second element holograms hB are element holograms on which the two-dimensional images DPb are recorded.

By irradiating the recording reference light beams at the first and second angles to perform recording in this manner, it is possible to record a large number of first element holograms hA on the plane of the hologram memory 3 and record a large number of second element holograms hB on the same plane.

It is to be noted that the face on which the large number of first element holograms hA are arrayed is represented as “first face” and the face on which the large number of second element holograms hB are arrayed is represented as “second face”. Although, in the hologram angle multiplexed recording, actually the “face” is not definitely separated physically, the term “face” is used for the convenience of description.

From the hologram memory 3 of such an angle multiplexed type as described above, reproduction image light recorded thereon can be detected when reproduction reference light is irradiated from an angle same as that upon recording. In other words, data recorded as element hologram can be reproduced.

Action upon reproduction from the hologram memory 3 on which the element holograms hA and hB are recorded is such as described below.

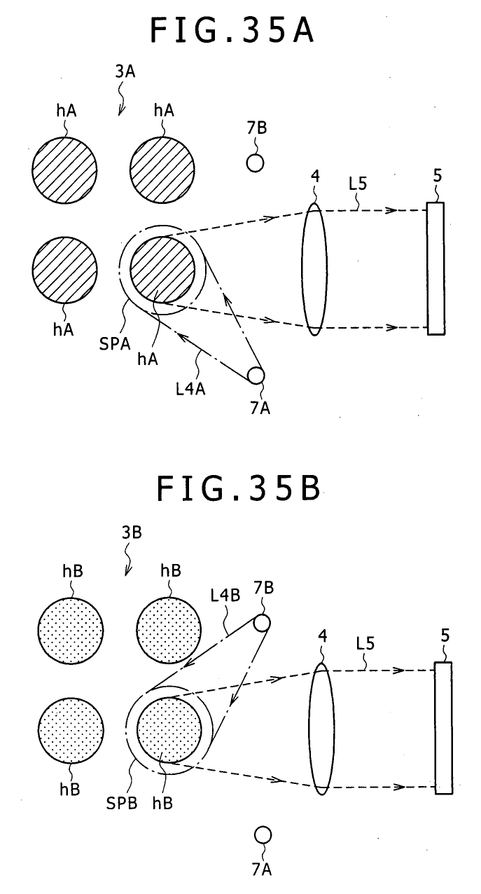

FIG. 35A illustrates a manner of reading out of an element hologram hA from the first face 3A of the hologram memory 3.

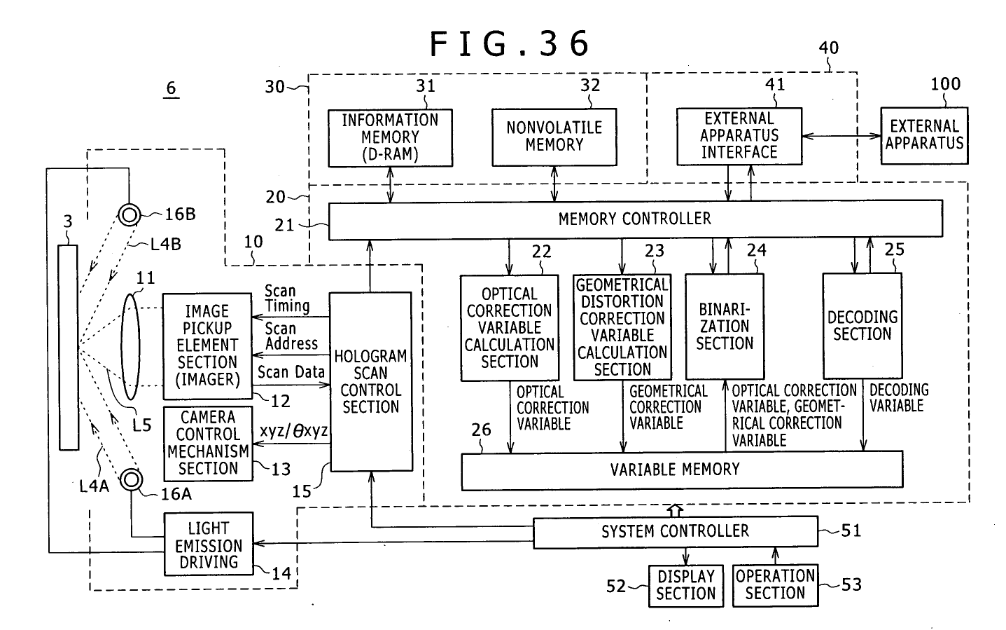

While, in FIGS. 35A and 35B, reference light sources 7A and 7B are shown, they correspond to light sources (reference light sources 16A and 16B) provided in the hologram reader 6 hereinafter described with reference to FIG. 36.

The reference light source 7A is disposed such that a reference light beam L4A is irradiated upon the hologram memory 3 at an angle similar to that of the light source position 8A upon recording. Meanwhile, the reference light source 7B is disposed such that a reference light beam L4B is irradiated upon the hologram memory 3 at an angle similar to that of the light source position 8B upon recording.

Upon reading of each of the first element holograms hA of the first face 3A, the reference light source 7A is turned on, and a spot SPA of the reference light beam L4A is irradiated upon the element hologram hA as seen in FIG. 35A. Also the element hologram hB of the second face 3B is recorded at the position same as that of the element hologram hA. However, when the reference light beam L4A is irradiated, only reference image light L5 of the element hologram hA is obtained, and this is detected by the imager 5.

On the other hand, upon reading of each of the second element holograms hB of the second face 3B, the reference light source 7B is turned on, and a spot SPB of the reference light beam L4B is irradiated upon the element hologram hB as seen in FIG. 35B. Consequently, reproduction image light of the element hologram hA is not obtained, but only reproduction image light L5 of the element hologram hB is obtained and this is detected by the imager 5.

[7. Third Example of a Configuration of the Hologram Reader and a Reproduction Process for Angle Multiplexed Recording]

An example of a configuration (third configuration example) of the hologram reader 6 of the embodiment for the hologram memory 3 on which element holograms are recorded in accordance with the angle multiplexing method as the first face 3A and the second face 3B as described above is shown in FIG. 36. It is to be noted that, in FIG. 36, like elements are denoted by like reference symbols and description thereof is omitted.

In this instance, in order to read data from an angle multiplexed recorded hologram memory 3, the hologram reader 6 includes a collimator lens 4, an imager 5, and two reference light sources 16A and 16B.

The reference light source 16A is disposed such that it irradiates a reference light beam L4A upon the hologram memory 3 at an angle equal to that of the recording reference beam L3A upon recording shown in FIGS. 33A to 33C.

Meanwhile, the reference light source 16B is disposed such that it irradiates a recording reference beam L4B upon the hologram memory 3 at an angle equal to that of the recording reference beam L3B upon recording shown in FIG. 33.

The reference light sources 16A and 16B each formed from, for example, an LED (Light Emitting Diode) or a semiconductor laser are driven by the light emission driving section 14 to emit light. When the hologram reader 6 performs reproduction of the hologram memory 3, the light emission driving section 14 drives the reference light source 16A or 16B to emit light in accordance with an instruction of the system controller 51.

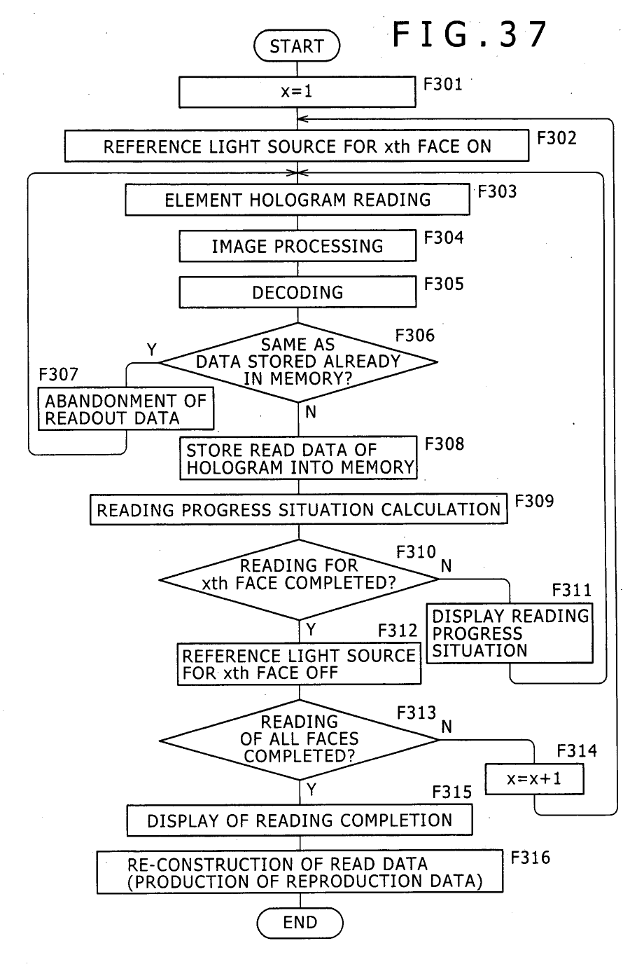

A process when data reproduction from the hologram memory 3 is to be performed by the hologram reader 6 is described with reference to FIG. 37. FIG. 37 illustrates a process executed under the control of the system controller 51 upon data reproduction.

For example, the user would move, after the user performs an operation to start reproduction from the operation section 53, the hologram reader 6 arbitrarily in an opposing relationship to the hologram memory 3 as seen in FIG. 4A, 4B or 5.

If the operation performed to start reproduction using the operation section 53 is detected, then the system controller 51 sets a variable x to x=1 at step F301 and then turns on the reference light source for the xth face at step F302. In particular, in order to read in the first face 3A first, the system controller 51 issues an instruction to the light emission driving section 14 to drive the reference light source 16A to emit light so that the reference light beam L4A can be irradiated upon the hologram memory 3.

In this state, the user would move the hologram reader 6 in an opposing relationship to the hologram memory 3 so that the reproduction image light L5 of the first element holograms hA recorded on the first face 3A is successively detected by the imager 12.

At step F303, the reproduction image light L5 of a certain element hologram is fetched by action of the imager 12 and the hologram scan control section 15. Consequently, digital data as a reproduction image signal (two-dimensional image signal) is obtained. The two-dimensional image signal of the certain element hologram hA outputted from the hologram scan control section 15 is stored once into the nonvolatile memory 32 by the memory controller 21.

After the system controller 51 confirms fetching of the reproduction signal of the element hologram as the action at step F303, it causes the image process at step S304 and the decoding process at step F305 to be executed.

At step F306, the system controller 51 decides whether or not the readout data obtained by the decoding process is same as the readout data stored in the nonvolatile memory 32. If the read out data are same, then the system controller 51 abandons the data decoded in the present cycle, whereafter the processing returns to step F303. If the readout data are not same, then the processing advances to step F308, at which the data decoded in the present cycle is stored as readout data from the certain element hologram hA into the nonvolatile memory 32.

The processes at steps F303, F304, F305, F306, F307 and F308 described above are similar to the processes at steps F102, F103, F104, F105, F106 and F107 of FIG. 7, respectively.

At step F309, the system controller 51 calculates the progress situation of data reading out. Also this is basically similar to that at step F108 of FIG. 7, and the calculation of the progress situation can determine from the data size of the entire data stored already in the nonvolatile memory 32 and the data size of the entire data to be reproduced (size of the entire original recording data) what percent the progress situation is. Or, the system controller 51 can determine from the entire data block number and the number of readout data (that is, data blocks) stored in the nonvolatile memory 32 what percent the progress situation of reading out is.

At step F310, the system controller 51 decides whether or not data reading by the necessary amount from the xth face is completed, that is, whether not all of data to be read out from the xth face are already decoded and stored in the nonvolatile memory 32.

It is to be noted that, for this decision, only it is necessary that, as header information of the element holograms of each face, the data size or the data block number of data recorded on the face be recorded. By comparing the data size or the data block number of the face with the data size or the data block number stored in the nonvolatile memory 32, it can be decided whether or not reading of the face being currently scanned is completed successfully.

If data reading from the element holograms of the first face 3A as a face being currently scanned is not completed, then the processing advances to step F311, at which the system controller 51 controls the display section 52 to display the reading progress situation. In this instance, the system controller 51 controls the display section 52 to execute display in response to the reading progress situation calculated at step F309.

Then, the processing returns to step F303 so that the process regarding another element hologram read subsequently as reproduction image light is executed similarly.

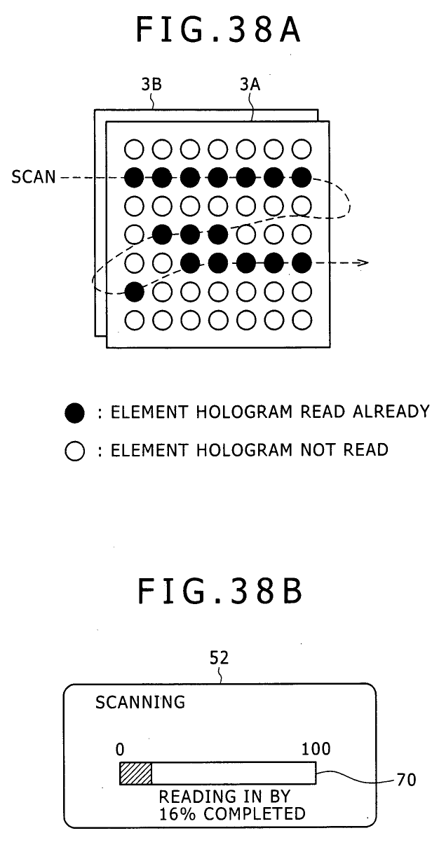

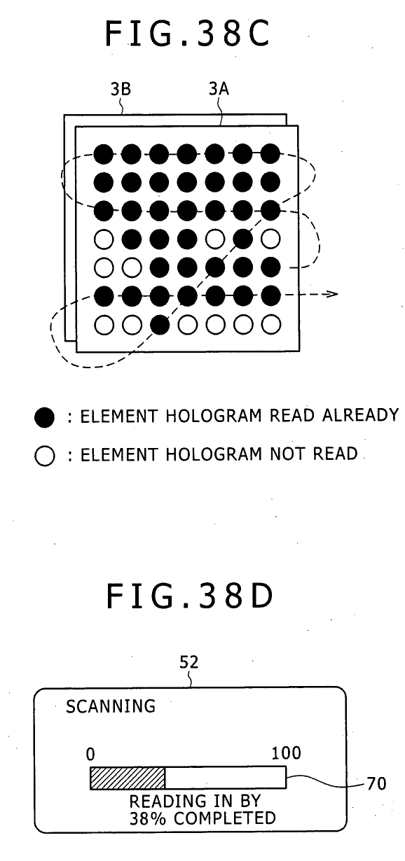

Examples of the display of the reading progress situation at step F311 are shown in FIGS. 38A to 38D. In FIG. 38A, element holograms on the first face 3A of the hologram memory 3 are represented by ◯ and . Further, the locus of manual scanning of the user is indicated by a broken line.

If the manual scanning is performed in such a manner as indicated by the broken line, then the element holograms indicated by are read. It is assumed that data of 49 data blocks BLK from among 98 data blocks BLK into which the recording data are divided are recorded as 49 element holograms indicated by ◯ or are recorded on the first face 3A. Further it is assumed that element holograms on which data of the remaining 49 data blocks BLK are recorded similarly are recorded on the second face 3B.

Thus, at a point of time at which reading of 16 element holograms of on the first face 3A is completed as seen in FIG. 38A, that is, at a point of time at which the 16th readout data is stored into the nonvolatile memory 32 at step F308, the reading progress situation calculated at step F309 is 16%.

In this instance, at step F311, for example, the progress situation bar 70 is displayed on the display section 52 to present the situation of completion of reading in by 16% to the user as seen in FIG. 38B.

Further, it is assumed that manual scanning is performed as indicated by a broken line in FIG. 38C continuously to the manual scanning of FIG. 38A. Up to this point of time, the element holograms read already which are indicated by reach 38%. In other words, data reading of 38% of data to be reproduced is completed. In this instance, by the process at step F311, the progress situation bar 70 and the display numerical value on the display section 52 exhibit a displaying state of completion of reading in by 38% as seen in FIG. 38D.

As manual scanning and the action at steps F303 to F309 are repetitively performed in this manner, the percentage display of the progress situation bar 40 advances on the display section 52. Thus, if the user observes the percentage display, it can recognize by what amount the user must further perform manual scanning.

If it is decided at step F310 that data reading of the required amount of data from the xth face, that is, the first face 3A, is completed, then the processing advances to step F312, at which the system controller 51 issues an instruction to the light emission driving section 14 to turn off the reference light source 16A.

Then, if there remains a face from which reading is not performed, then the processing advances from step F313 to step F314, at which the variable x is incremented, whereafter the processing returns to step F302. In this instance, the variable x is set to x=2 so that reproduction reference light corresponding to the second face 3B is turned on at step F302. In particular, the system controller 51 issues an instruction to the light emission driving section 14 to start emission of light from the reference light source 16B.

By performing the processes at steps F303 et seq. in a similar manner as described above while the reference light source 16B is kept to emit light, data reading is performed now from the element holograms hB of the second face 3B. Then, the readout data from the element holograms hB successively read out in a random order are cumulatively stored into the nonvolatile memory 32.

If it is decided at a certain point of time at step F310 that reading of the element holograms hB of the second face 3B is completed, then the reference light source 16B is turned off at step F312.

Where the hologram memory 3 is angle multiplexed recorded as two faces of the first face 3A and the second face 3B, it is decided at this point of time at step F313 that reading of all faces is completed.

In this instance, the processing advances to step F315, at which the system controller 51 controls the display section 52 to execute reading completion display. In short, the system controller 51 causes the progress situation bar 70 and the numerical value to be displayed in a state of completion by 100%. Further, at this time, a message of urging the user to end the manual scanning may be displayed so as to notify the user of completion of scanning.

Then at step F316, the system controller 51 issues an instruction to the memory controller 21 to re-construct the readout data stored in the nonvolatile memory 32. In particular, at this point of time, since the predetermined amount of data, that is, data of all data blocks which form the original recording data, are stored in the nonvolatile memory 32, the data of the data blocks BLK are extracted and arranged in the order of the data block number to produce reproduction data. For example, reproduction data as content data are produced. The reproduction data are thereafter outputted from the external apparatus interface 41 to the external apparatus 100.

The reproduction from the hologram memory 3 is completed therewith, and the system controller 51 ends the reproduction process.

As can be recognized from the process described above, the hologram reader 6 of the present example successively stores readout data of the read element holograms into the nonvolatile memory 32 irrespective of the order of reading in of the element holograms on each of the first face 3A and the second face 3B of the hologram memory 3. Further, at this time, the progress situation of the scanning (data reading) may be displayed on the display section 52.

Then, at a point of time at which the scanning of the first face 3A and the second face 3B ends and reading out of the predetermined amount of element holograms is completed, data are re-constructed to produce original data such as content data, that is, reproduction data.

By performing such a process as described above, it becomes possible to perform data reproduction from the hologram memory 3 by manual scanning similarly as in the first and second configuration examples described hereinabove. Further, since a scanning mechanism is unnecessary, the hologram reader 6 can be formed in a simple configuration, and reduction in cost can be implemented. Further, also enhancement of the feeling in use can be anticipated by the progress situation display.

Then, since the hologram reader 6 of the present example is ready particularly for angle multiplexed recording, it is suitable to implement a system wherein, for example, computer data, AV content data or like data are recorded on the hologram memory 3 whose capacity is increased by angle multiplexed recording on the first face 3A and the second face 3B and the hologram memory 3 is distributed widely such that a general user can acquire the data recorded on the hologram memory 3 using the hologram reader 6.

Incidentally, according to the third configuration example shown in FIG. 36, in order to reproduce the hologram memory 3 wherein element holograms hA and hB are angle multiplexed recorded on the first face 3A and the second face 3B, respectively, the two reference light sources 16A and 16B are provided in the hologram reader 6 and changed over to successively reproduce the faces.

On the other hand, also with a configuration wherein one reference light source 16 is disposed fixedly as in the first configuration example of FIG. 6, reproduction ready for angle multiplexed recording can be performed.

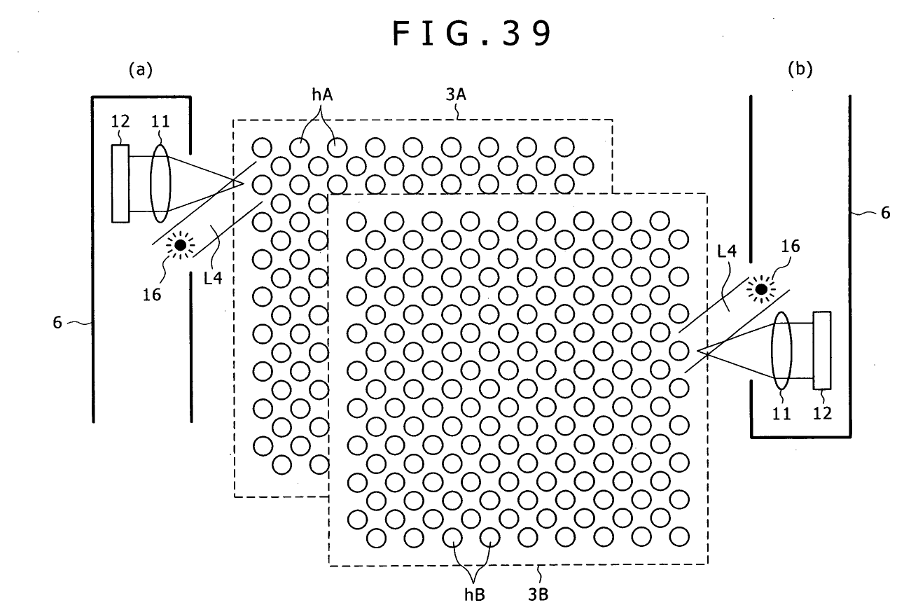

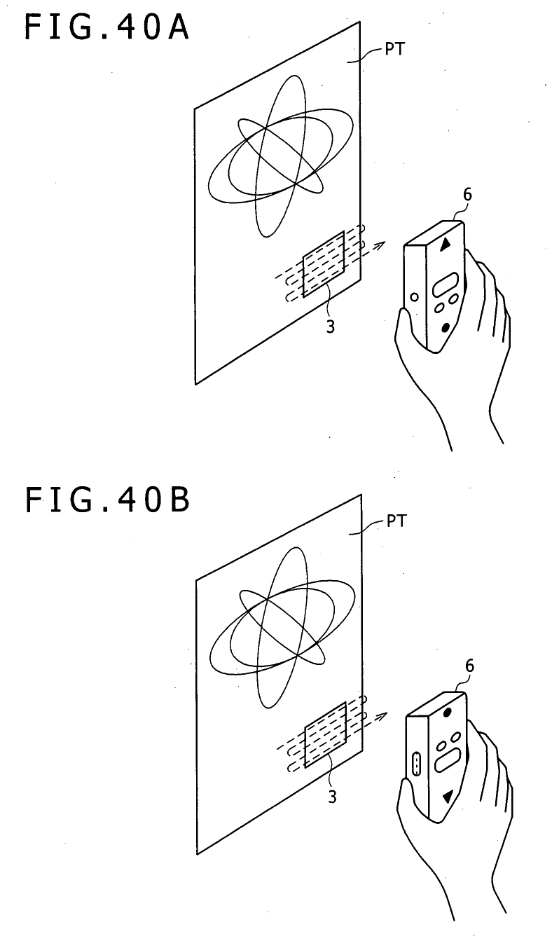

For example, action of performing data reading out from the first face 3A and the second face 3B of the hologram memory 3 by means of the hologram reader 3 which has only one reference light source 16 fixedly therein as seen in FIG. 6 is illustrated in FIGS. 39, 40A and 40B.

The hologram reader 6 of (a) of FIG. 39 indicates a state wherein reproduction reference light L4 from the reference light source 16 is irradiated upon the hologram memory 3 at a first angle at which the first element holograms hA of the first face 3A can be read out.

Meanwhile, in the hologram reader 6 of (b) of FIG. 39, reproduction reference light L4 from the reference light source 16 is irradiated similarly upon the hologram memory 3. However, the hologram reader 6 of (b) of FIG. 39 indicates a state wherein, since the upward or downward direction of the hologram reader 6 itself changes, the reproduction reference light L4 is irradiated upon the hologram memory 3 at a second angle at which the second element holograms hB of the second face 3B can be read out.

In short, even if the reference light source 16 is disposed fixedly in the hologram reader 6, if the posture direction of the hologram reader 6 is reversed, then the angle state of the reproduction reference light L4 to be irradiated upon the hologram memory 3 can be changed over between the first angle and the second angle.

In particular, if the user holds and operates the hologram reader 6 so as to be opposed to the hologram memory 3 as seen in FIG. 40A, then the reproduction reference light L4 is irradiated at the first angle upon the hologram memory 3, and by performing manual scanning in this state, data can be read out from the first face 3A.

Then, the user would re-hold the hologram reader 6 inversely as seen in FIG. 40B. Consequently, the reproduction reference light L4 is irradiated at the second angle upon the hologram memory 3, and by performing manual scanning in this state, data can be read out from the second face 3B.

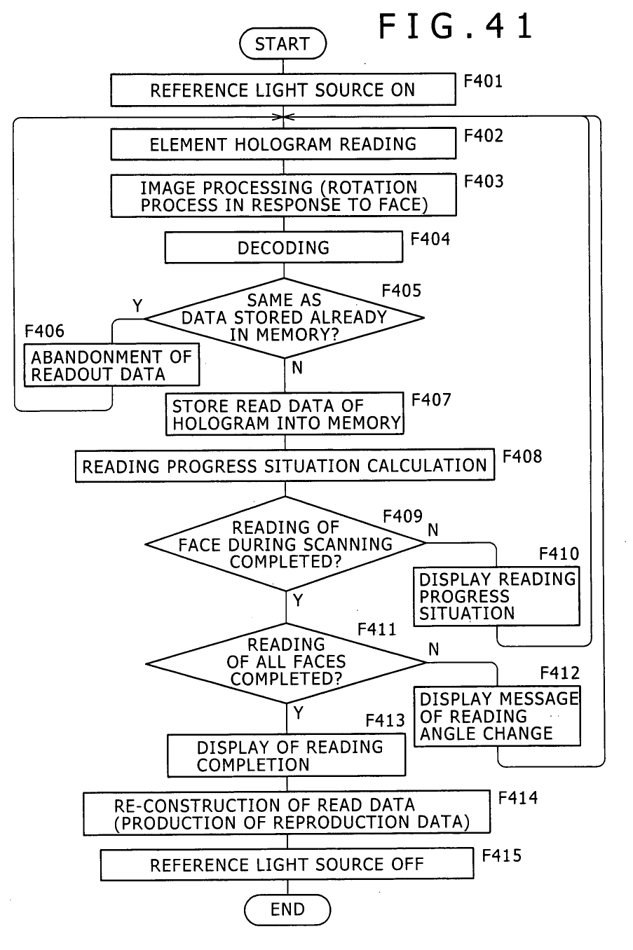

A process when data reproduction from the hologram memory 3 in an angle multiplexed recorded state is performed by means of the hologram reader 6 which has the single reference light source 16 disposed fixedly is described with reference to FIG. 41. FIG. 41 illustrates a process to be executed under the control of the system controller 51 upon data reproduction.

Upon starting of reproduction, the system controller 51 issues an instruction to the light emission driving section 14 at step F401 to drive the reference light source 16 to emit light so that the reproduction reference light L4 can be irradiated upon the hologram memory 3.

In this state, the user wound hold the hologram reader 6 in such a directionality as seen in FIG. 40A and perform manual scanning with the hologram reader 6 opposed to the hologram memory 3. It is to be noted that there is no problem even if, at this time, the user holds the hologram reader 6 in the opposite direction as seen in FIG. 40B. In whichever one of the directionalities the user starts manual scanning, this merely provides a difference in which one of the first face 3A and the second face 3B is read first.

For example, if it is assumed that, when the user holds the hologram reader 6 in the directionality of FIG. 40A, the reproduction reference light L4 is irradiated upon the hologram memory 3 in a state of the first angle, then the reproduction image light L5 of the first element holograms hA recorded on the first face 3A is successively detected by the imager 12 by manual scanning.

The processes at steps F402 to F410 are similar to those at steps F303 to F311 of FIG. 37. In particular, data reading out, for example, from the element hologram hA of the first face 3A is performed by the processes at steps F402 to F410, and readout data from the first element holograms hA successively read out in a random order are cumulatively stored into the nonvolatile memory 32.

Then, if it is decided at step F409 that data reading out from the face being scanned is completed, then the processing advances to step F411, at which it is decided whether or not data reading from all faces is completed.

Then, if there remains a face from which reading is not performed, then the processing advances to step F412, at which the system controller 51 controls the display section 52 to display a message of the change of the reading angle.

For example, a message such as “Please re-hold the hologram reader inversely to perform scanning” is displayed. Then, the processing returns to step F402.

The user would re-hold the hologram reader 6, for example, from the state of FIG. 40A to the state of FIG. 40B in accordance with the message display described above. Consequently, the reproduction reference light L4 is placed into a state wherein it is irradiated in a state of the second angle upon the hologram memory 3, and the reproduction image light L5 of the second element holograms hB recorded on the second face 3B is successively detected by the imager 5 by manual scanning.

If the processes at steps F402 et seq. are performed similarly as described above in this state, then data reading out now from the second element holograms hB of the second face 3B is successively performed. Then, readout data from the second element holograms hB successively read out in a random order are cumulatively stored into the hologram memory 3.

If it is decided at a certain point of time at step F409 that data reading out from a face being scanned is completed, then the processing advances to step F411.

Where the hologram memory 3 is of the type wherein it is angle multiplexed recorded on two faces of the first face 3A and the second face 3B thereof, reading of all faces is completed at F411 at this point of time.

In this instance, the processing advances to step F413, at which reading completion display is performed by the display section 52. In short, the progress situation bar 70 and the numerical value are displayed in a state of completion by 100%. Further, at this time, a message of urging the user to end the manual scanning may be displayed so as to notify the user of completion of scanning.

Then at step F414, the system controller 51 issues an instruction to the memory controller 21 to re-construct the readout data stored in the nonvolatile memory 32. In particular, since, at this point of time, the predetermined amount of data, that is, data of all data blocks which form the original recording data, are stored in the nonvolatile memory 32, the data of the data blocks BLK are extracted and arranged in the order of the data block number to produce reproduction data. For example, reproduction data as content data are produced. The reproduction data are outputted, for example, from the external apparatus interface 41 to the external apparatus 100.

The system controller 51 issues an instruction to the light emission driving section 14 to turn off the reference light source 16 at step F415. The reproduction from the hologram memory 3 is completed therewith, and the system controller 51 ends the reproduction process.

As can be recognized from the process described above, according to the hologram reader 6 of the present example, the user is urged to change the holding manner of the hologram reader 6, and the user would perform re-holding midway of manual scanning in accordance with the instruction. Consequently, while the hologram reader 6 has only one reference light source 16, it can perform data reproduction from the hologram memory 3 having data angle multiplexed recorded on the first face 3A and the second face 3B.

Consequently, further simplification of the configuration as the hologram reader can be implemented.

It is to be noted that, where the user changes the holding direction upon manual scanning in this manner, an additional process is required for the image process at step F403.

For example, if it is assumed that scanning of the first face 3A is performed in the state of FIG. 40A and the scanning of the second face 3B is performed in the state of FIG. 40B, then the reproduction image detected by the imager 12 is directed in the opposite vertical direction depending upon whether it originates from the first element holograms hA of the first face 3A or from the second element holograms hB of the second face 3B.

Accordingly, for example, when the second face 3B is scanned, it is necessary to perform a vertically reversing process for the detected image of reproduction image light of the second element holograms hB at step F403.

It is to be noted, however, that, if the two-dimensional images DPb are inverted in advance upon recording of the second element holograms hB of the second face 3B upon production of the hologram memory 3, then the vertically reversing process is unnecessary.

Furthermore, the vertically reversing process is eliminated also where the two-dimensional images DP are formed in an upwardly and downwardly rotationally symmetrical state.

It is to be noted that, while, in the foregoing description, the hologram memory 3 wherein element holograms are angle multiplexed recorded on two faces as the first face 3A and the second face 3B is taken as an example, also a hologram reader can be implemented which is ready for a hologram memory in which a greater number of faces such as third and fourth faces are multiplexed recorded by further different reference light angles. In this instance, a number of reference light sources of FIG. 36 equal to the number of faces may be prepared and changed over for every face to be scanned.

Further, also where a single reference light source 16 is provided as seen in FIG. 6, if it is supposed that the hologram reader 6 is re-held in four directions by the user, then a system can be constructed which uses a hologram memory which multiplexed recorded up to the fourth face thereof.

Further, where a plurality of reference light sources are provided as seen in FIG. 36 and changed over to perform reading out of element holograms of the different faces, although, in the process of FIG. 37, such changeover as to turn off the reference light source 16A and turn on the reference light source 16B at a point of time at which, for example, reading of the first face 3A is completed is performed, various examples may be possible as the changeover timing of the reference light sources.

For example, it is an appropriate changeover method to successively change over the reference light sources 16A and 16B to emit light after every predetermined short interval of time of 0.1 second, 0.5 seconds or 1 second. For example, within one swing in a process of manual scanning of a user, typically within one swing in the leftward and rightward directions, such a situation that the forward stroke and the reverse stroke of the scanning locus are substantially same as each other may possibly occur. If the reference light sources 16A and 16B are successively changed over in a short interval of time, then the possibility that the element holograms hA and hB at substantially same positions on a plane on the first face 3A and the second face 3B can be read on the forward stroke and the reverse stroke may increase. Consequently, increase in efficiency in scanning can be anticipated.

Further, the reference light sources 16A and 16B may be changed over at intervals of, for example, approximately 3 seconds or the like.

Furthermore, the reference light sources 16A and 16B may be changed over in response to the amounts of or ratio between readout data of the two-dimensional image DPa and readout data of the two-dimensional image DPb from among the readout data stored in the nonvolatile memory 32.

Anyway, only it is necessary to finally establish a state wherein a predetermined amount of data with which reproduction data can be constructed in the nonvolatile memory 32 is stored in the nonvolatile memory 32, and for example, the reading order or reading time period of the first face 3A and the second face 3B, that is, the timing of changeover control of the reference light sources 16A and 16B, can be set among various choices.

Also it is possible to provide the sound synthesis section 54 and the speaker 55 as seen in FIG. 31 in addition to or in place of the display section 52 so that various sound outputting can be executed.

For example, if a message for re-holding is displayed and voice of the message is outputted at step of FIG. 41, then the user can recognize the re-holding timing readily, and this is preferable in use. Or, when a message is displayed at step F412, it is possible to output electronic sound, melody sound, effect sound or the like to call attention of the user so that the user can become aware of the re-holding timing.

Naturally, only a voice message may be issued to notify the user of re-holding without performing message display.

[8. Fourth Example of a Configuration of the Hologram Reader and a Reproduction Process Including a Mixing Strategy]

Where the user manually performs scanning of element holograms on the hologram memory 3 as in the examples described above, the same element hologram is sometimes read by a plural number of times. In this instance, readout data of the data substance same as the data substance of readout data fetched already in the nonvolatile memory 32 is obtained. Also where a plurality of element holograms on which two-dimensional images DP of the same data substance are recorded exist on the hologram memory 3, readout data of the data substance same as the data substance of readout data fetched already in the nonvolatile memory 32 is sometimes obtained.

In the examples described hereinabove, where readout data of the substance same as the substance of recorded data stored already is obtained, it is abandoned. Here, however, an example is described wherein the two readout data of the same substance are compared with each other and that one of the readout data which has better quality is stored into the nonvolatile memory 32.

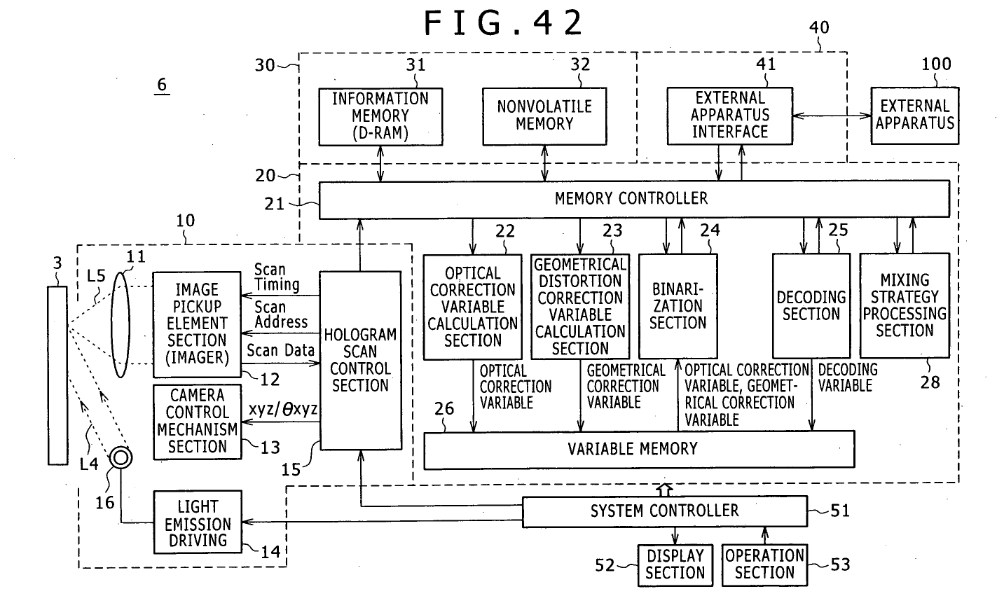

FIG. 42 shows the hologram reader 6 as a fourth configuration example. This hologram reader 6 includes a mixing strategy processing section 28 in addition to the first configuration example of FIG. 6. Like elements are denoted by like reference symbols, and description thereof is omitted.

The mixing strategy processing section 28 compares, when decoded data obtained by the decoding section 25 has the same substance as that of decoded data stored already in the nonvolatile memory 32 of the memory section 30, the decoded data with each other and selects that one of the decoded data which has better quality. Then, the selected decoded data is stored into the nonvolatile memory 32.

Similarly as in the configuration of FIG. 6, the decoding section 25 performs a decoding process and an error correction process for a binarized two-dimensional image signal, that is, data obtained from one element hologram to decode original data to obtain readout data.

The decoding section 25 passes the decoded readout data to the memory controller 21. The memory controller stores the decoded data into the nonvolatile memory 32.

It is to be noted, however, that, if the readout data decoded by the decoding section 25 is stored already in the nonvolatile memory 32, a quality comparison process between the data decoded in the present cycle and the data stored in the nonvolatile memory 32 is performed by the mixing strategy processing section 28. For example, a number of errors to be corrected are compared with when the error correction process of decoding. Then, if it is decided that the data stored in the nonvolatile memory 32 includes a smaller number of errors to be corrected and has higher quality, then the decoded data in the present cycle is abandoned. On the other hand, if the data decoded in the present cycle includes a smaller number of errors to be corrected and has higher quality, then the data is stored in an overwriting manner into the nonvolatile memory 32. In other words, the stored data in the nonvolatile memory 32 is rewritten.

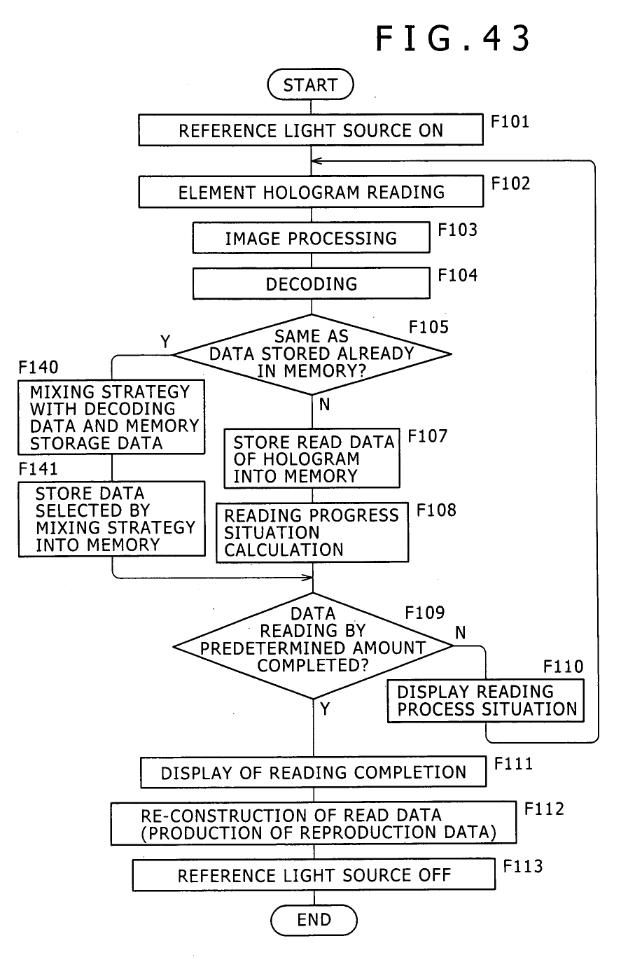

A process when the hologram reader 6 performs data reproduction from the hologram memory 3 is illustrated in FIG. 43. It is to be noted that processes at steps F101 to F113 in FIG. 43 are similar to those in FIG. 7, and therefore, overlapping description is omitted.

The process in FIG. 43 is different from the process in FIG. 7 in that processes at steps F140 and F141 are performed in place of the process at step F106 of FIG. 7.

If it is decided at step F105 that readout data obtained by decoding by the decoding section 25 has the same substance as that of the data stored already in the nonvolatile memory 32, then the processing advances to step F140.

As described hereinabove, such a situation that data recorded by the decoding section 25 has the same substance as that of data stored already in the nonvolatile memory 32 occurs where reading out of the same element hologram is performed already or where a plurality of element holograms on which the same data substance is recorded are recorded on the hologram memory 3 and the same data is read out already from an element hologram different from the element hologram read out in the presence cycle.

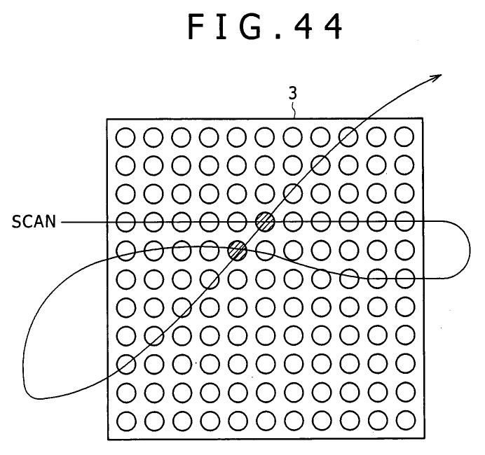

As described hereinabove, when manual scanning is performed, element holograms to be scanned are quite indefinite, and the same element hologram may be scanned by a plural number of times. For example, FIG. 44 illustrates an example wherein element holograms indicated by ◯ are arrayed on the hologram memory 3, and it is assumed that the manual scanning by the user of the hologram memory 3 exhibits such a locus as indicated by an arrow mark. In this instance, while two-dimensional images of those element holograms which lie on the scanning locus are successively read in and decoded, for example, those element holograms which are indicated by slanting lines in FIG. 44 are read twice. For example, if a certain element hologram is read in twice in such a situation as just described, then data decoded for the second time has the same substance as that of the data stored already in the nonvolatile memory 32.

Further, as described hereinabove with reference to FIGS. 9 to 19, there is an idea that, in a system wherein element holograms are read in stochastically which manual scanning is supposed, a plurality of element holograms of the same data are recorded so that an element hologram of each data block can be read in as rapidly as possible.

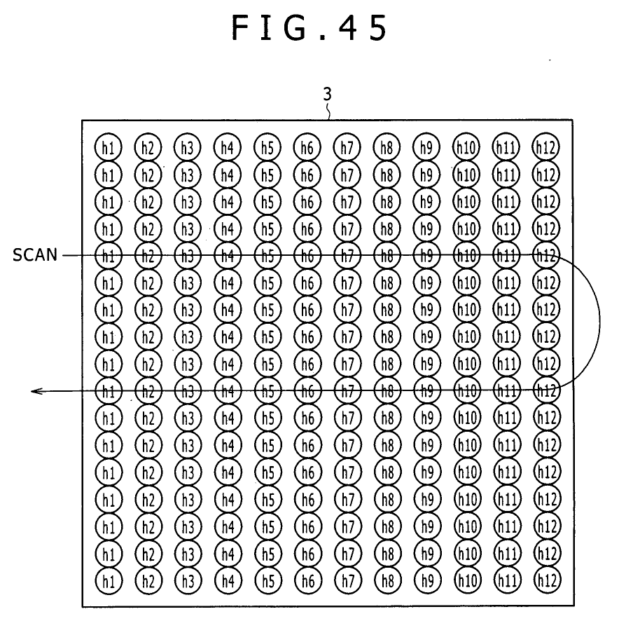

FIG. 45 illustrates an arrangement of element holograms described hereinabove with reference to FIG. 17. For example, it is assumed that the user first performs scanning in a rightward direction as indicated by an arrow mark with respect to the hologram memory 3 and then scans so as to return in the leftward direction. Consequently, upon the leftward returning scanning, element holograms of the same data substance as that of the element holograms already read in once are read in.

For example, in such a situation as just described, such a situation occurs that decoded data has the same substance as that of data stored already in the nonvolatile memory 32.

It is to be noted that, also in the case of an automatic scanning method, if a plurality of element holograms of the same substance are recorded, then such a situation occurs that readout data of the same substance are decoded by a plural number of times.

If it is decided at step F105 of FIG. 43 that decoded readout data has the same substance as that of the readout data stored in the nonvolatile memory 32 and the processing advances to step F140, then a comparison process between the readout data is performed by the mixing strategy processing section 28.

In particular, the mixing strategy processing section 28 performs such a process as to compare the number of errors to be corrected in the readout data decoded by the decoding section 25 at step F104 and the number of errors to be corrected obtained when the readout data stored in the nonvolatile memory 32 as data of the same data block number are decoded with each other to decide which one of the readout data has higher quality.

Then at step F141, the memory controller 21 controls so that the readout data selected as readout data having higher quality based on the decision is stored as data of the data block number into the nonvolatile memory 32.

In particular, if it is decided that the readout data stored in the nonvolatile memory 32 have a smaller number of errors to be corrected and have higher quality, then the memory controller 21 abandons the readout data decoded in the present cycle.

On the other hand, if the readout data decoded in the present cycle has a smaller number of errors to be corrected and has higher quality, then the memory controller 21 stores the readout data decoded in the present cycle in an overwriting manner into the nonvolatile memory 32 to rewrite the data on the nonvolatile memory 32.

Through the processes described above, the processing advances to step F109.

It is to be noted that the comparison in quality between the decoded data may be performed by a technique other than the comparison of the numbers of errors to be corrected.

As in the process of FIG. 43, if readout data of the data substance same as that of readout data stored in the nonvolatile memory 32 is obtained, then the two readout data are compared with each other in quality, and a selected one of the readout data is stored into the nonvolatile memory 32. Therefore, readout data of higher quality are stored into the nonvolatile memory 32, and as a result, reproduction of high quality can be re-constructed.

Particularly in the case of manual scanning, although it is somewhat unavoidable that reading in of an element hologram of the same data substance occurs, the action described above does not waste the decoded data in such an instance and therefore is considered effective to achievement of higher quality of reproduction data.

[9. Fifth Example of a Configuration of the Hologram Reader and a Reproduction Process Including an External Parity Process]

Now, an example wherein, since redundant data is included in a two-dimensional image DP recorded as an element hologram, the redundant data is included in readout data from the two-dimensional image DP and the hologram reader 6 can produce another reproduction data based on redundant data of a plurality of readout data is described.

On each of the element holograms of the hologram memory 3, such a two-dimensional image DP as shown in FIG. 3 is recorded. The two-dimensional image DP is obtained by dividing recording data of an original AV content, computer data/program or the like and converting data of one of the data blocks into a two-dimensional image. For example, header information including an address, management information and so forth is added to data of one block and then error correction parities (internal parities) are added, and then an encoding process such as an interleaving process is performed, whereafter the encoded data is converted into a two-dimensional image pattern.

Here, the present example is characterized in that one two-dimensional image DP includes external parities in addition to data (hereinafter referred to as main data) of one data block, header information and internal parities.

The internal parities are parities used for error correction process of main data and header information included in the two-dimensional image DP while the external parities are parities used for data restoration between a plurality of element holograms. For example, if 10 element holograms are determined as a data restoration unit according to the external parities, then if the external parities recorded, for example, on eight ones of the element holograms are collected, then the data (main data and header information) of the remaining two element holograms can be restored.

It is to be noted that, in the following description, a plurality of element holograms which make a data restriction unit according to external parities are referred to as “external parity block” for the convenience of description.

Here, a circumstance of a case wherein external parities are not added is described prior to description of a data configuration which includes external parities in the element hologram of the present example.

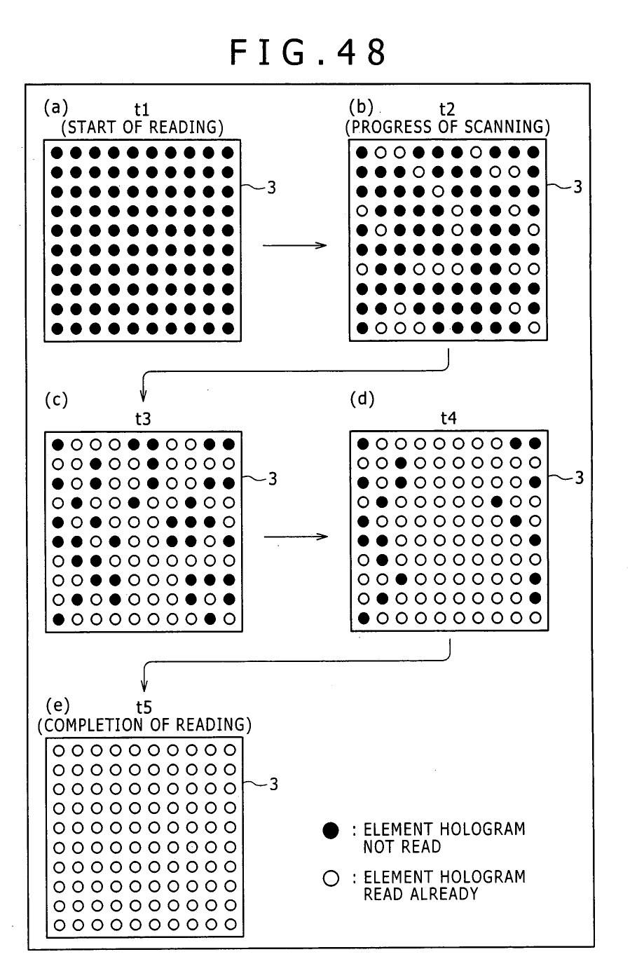

It is presupposed that reading of the element holograms is performed by manual scanning described hereinabove. In the manual scanning, the user moves the hologram reader 6 with respect to the hologram memory 3 to perform reading of the element holograms. However, because the locus of movement by the user is unstable and only those element holograms almost just on which the scanning locus passes can be read, the element holograms are scanned stochastically as described hereinabove. Consequently, such a case occurs that too much time is required to fully read the data of all of the element holograms on the hologram memory 3. This arises from the difference between the reading efficiency immediately after the reading is started and reading efficiently at the last stage. This is described with reference to FIG. 48.

FIGS. 48(a), 48(b), 48(c), 48(d) and 48(e) illustrate a manner of reading of the element holograms of the hologram memory 3. The mark represents an element hologram which is not read as yet, and the mark ◯ represents an element hologram which is read already.

FIG. 48(a) illustrates a state by manual scanning at a reading starting time point t1, and all element holograms of the hologram memory 3 are in a non-read state. After manual scanning is started, those element holograms just on which the reproduction reference light passes are successively read, and read element holograms gradually increase as seen in FIG. 48(b). Since all element holograms are initially in a non-read state, the element holograms are read efficiently even by indefinite manual scanning.

Then, as the manual scanning is continued, element holograms which are read already gradually increase as seen from a t2 time point of FIG. 48(b), a t3 time point of FIG. 48(c) and a t4 time point of FIG. 48(d). However, as the number of element holograms in a non-read state decreases, the reading efficiency drops. For example, where element holograms in a non-read state decrease as seen in FIG. 48(d), a situation wherein the locus of the reproduction reference light upon manual scanning does not readily hit upon element holograms in a non-read state is entered. Then, considerable time is required from the t4 time point of FIG. 48(d) to the t5 time point of FIG. 48(e) at which the reading is completed.

In other words, although, immediately after reading is started, element holograms can be read at a high speed, since element holograms to be read gradually decrease and besides the element holograms in a non-read state are scattered at various locations, also the reading speed drops suddenly. Thus, much time is required before all element holograms are read finally.

Against the situation that the reading efficiency drops very much in the rear half of reading and much time is required before the scanning is completed in this manner, according to the present example, external parities are added as information to be recorded in the element holograms so that the scanning can be completed in short time.

The external parities are parities with which data of another element hologram can be restored, and if external parities are added by 20%, for example, to 10 element holograms, then if eight ones of the 10 element holograms are read, then data of the remaining two element holograms can be restored even if reading of them is not performed. As described above, the reading efficiency drops in the proximity of completion. Accordingly, in this instance, although long time is required for reading of the remaining two element holograms, since reading for the long period of time can be eliminated, the total scanning time can be reduced significantly.

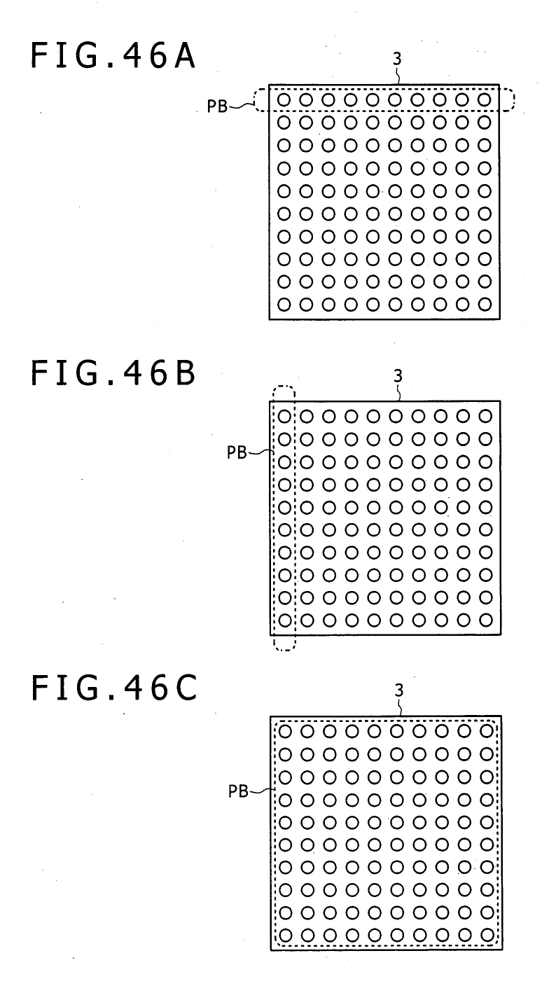

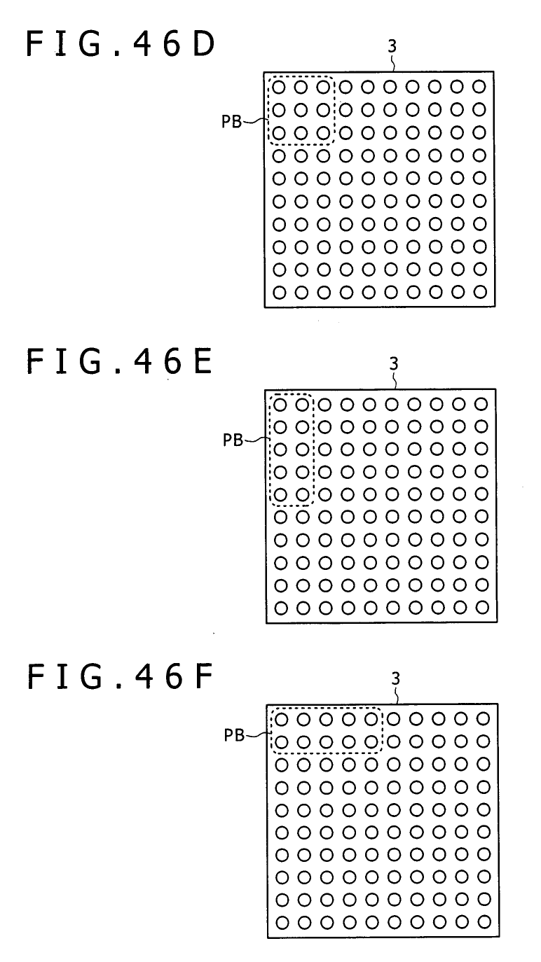

Particular examples are described with reference to models shown in FIGS. 46A to 46F wherein element holograms are arrayed in the vertical and horizontal directions on the hologram memory 3.

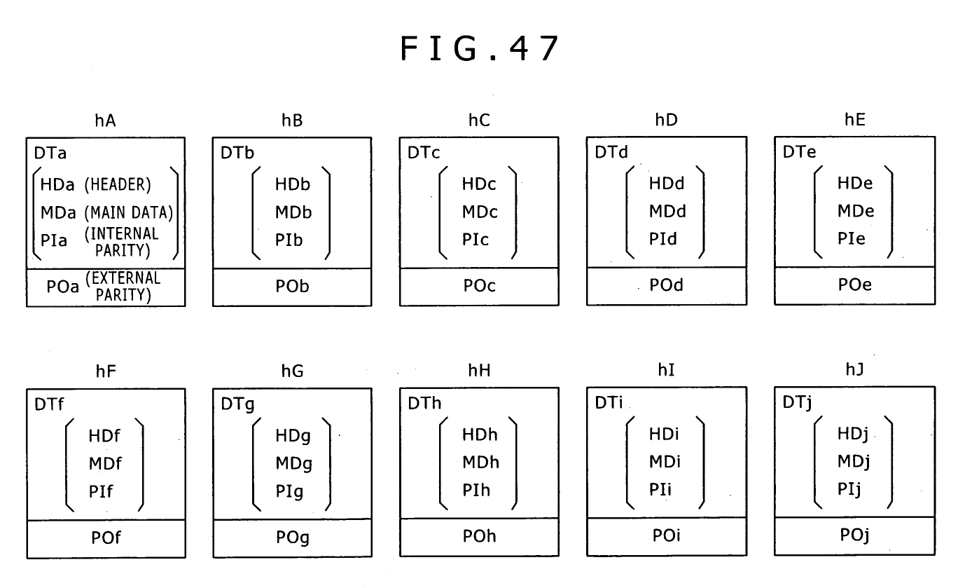

While, in FIG. 46A, 10×10 element holograms indicated by ◯ are arrayed in the vertical and horizontal directions, an external parity block PB is formed for each row, for example, as indicated by a broken line. In particular, a group of 10 element holograms in each row is set as an external parity block PB, and to each of the element holograms in the external parity block PB, external parities of a predetermined % are added so that, at a point of time when reading of n element holograms is completed, decoded data from the remaining (10−n) element holograms can be obtained.

Where the 10 element holograms which form the external parity blocks PB are represented as element holograms hA, hB, hC, hD, hE, hF, hG, hH, hI and hJ, the substance of information recorded as two-dimensional images DP in the element holograms hA, hB, hC, hD, hE, hF, hG, hH, hI and hJ is illustrated in FIG. 47.

On the element hologram hA, main data MDa which is data of one block of original recording data (content data or the like), a header HDa added to the data block and including a data block number, an attribute and so forth and internal parities PIa added for an error correction process for the main data MDa and the header HDa had are recorded as hologram unit data DTa to be recorded using the element hologram hA.

Then, on the element hologram hA, the external parities POa are recorded in addition to the hologram unit data DTa including the header HDa, main data MDa and internal parities PIa. In short, a data sequence including the header HDa, main data MDa, internal parities PIa and external parities POa undergoes a predetermined encoding process and then is converted into a two-dimensional image DP and recorded as the element hologram hA.

On the element hologram hB, as the hologram unit data DTb which is recorded using the element hologram hB, hologram unit data DTb including a header HDb, main data MDb and internal parities PIb is recorded, and external parities POb are recorded similarly.

Also on the element hologram hC, as the hologram unit data DTc which is recorded using the element hologram hC, hologram unit data DTc including a header HDc, main data MDc and internal parities PIc is recorded, and external parities POc are recorded similarly.

This similarly applies also to the element holograms hD, hE, hF, hG, hH, hI and hJ.

Here, the hologram unit data DTa, DTb, DTc, DTd, DTe, DTf, DTg, DTh, DTi, DTj and the external parities POa, POb, POc, POd, POe, POf, POg, POh, POi, POj of the element holograms hA, hB, . . . , hJ have, for example, the following relationships.

DTa=(POb/9)+(POc/9)+(POd/9)+(POe/9)+(POf/9)+(POg/9)+(POh/9)+(POi/9)+(POj/9)

DTb=(POa/9)+(POc/9)+(POd/9)+(POe/9)+(POf/9)+(POg/9)+(POh/9)+(POi/9)+(POj/9)

DTc=(POa/9)+(POb/9)+(POd/9)+(POe/9)+(POf/9)+(POg/9)+(POh/9)+(POi/9)+(POj/9)

DTd=(POa/9)+(POb/9)+(POc/9)+(POe/9)+(POf/9)+(POg/9)+(POh/9)+(POi/9)+(POj/9)

DTe=(POa/9)+(POb/9)+(POc/9)+(POd/9)+(POf/9)+(POg/9)+(POh/9)+(POi/9)+(POj/9)

DTf=(POa/9)+(POb/9)+(POc/9)+(POd/9)+(POe/9)+(POg/9)+(POh/9)+(POi/9)+(POj/9)

DTg=(POa/9)+(POb/9)+(POc/9)+(POd/9)+(POe/9)+(POf/9)+(POh/9)+(POi/9)+(POj/9)

DTh=(POa/9)+(POb/9)+(POc/9)+(POd/9)+(POe/9)+(POf/9)+(POg/9)+(POi/9)+(POj/9)

DTi=(POa/9)+(POb/9)+(POc/9)+(POd/9)+(POe/9)+(POf/9)+(POg/9)+(POh/9)+(POj/9)

DTj=(POa/9)+(POb/9)+(POc/9)+(POd/9)+(POe/9)+(POf/9)+(POg/9)+(POh/9)+(POi/9)

In particular, if the hologram unit data DTa of the element hologram hA is taken as an example, the hologram unit data DTa can be produced using the external parities POb to POj recorded in the element holograms hB to hJ. In other words, if the element holograms hB to hJ are read in successfully, then even if the element hologram hA is not read as yet, the hologram unit data DTa of the element hologram hA can be restored.

Similarly, for example, the hologram unit data DTb of the element hologram hB can be produced using the external parities POa and POc to POj recorded in the element holograms hA and hC to hJ. In other words, if the element holograms hA and hC to hJ are read in successfully, then even if the element hologram hB is not read as yet, the hologram unit data DTb of the element hologram hB can be restored.

In particular, in this instance, at a point of time at which reading of nine element holograms is completed in the external parity block PB composed of 10 element holograms, hologram unit data of the remaining one element hologram can be restored, and a state of completion of reading of the 10 element holograms can be established.

Naturally, if the redundancy of the external parities POa, POb, POc, POd, POe, POf, POg, POh, POi, POj is raised, then the restoration efficiency can be further raised. For example, if the external parities POa, POb, POc, POd, POe, POf, POg, POh, POi, POj which have a redundancy of 20% are added, then at a point of time at which reading of eight element holograms is completed in the external parity block PB composed of 10 element holograms, hologram unit data of the remaining two element holograms can be restored.

Then, in the present example, even if reading of all element holograms of an external parity block PB is not completed, by restoring data of the remaining element holograms from the predetermined amount of external parities in this manner, the reading efficiency can be raised significantly by the external parities.

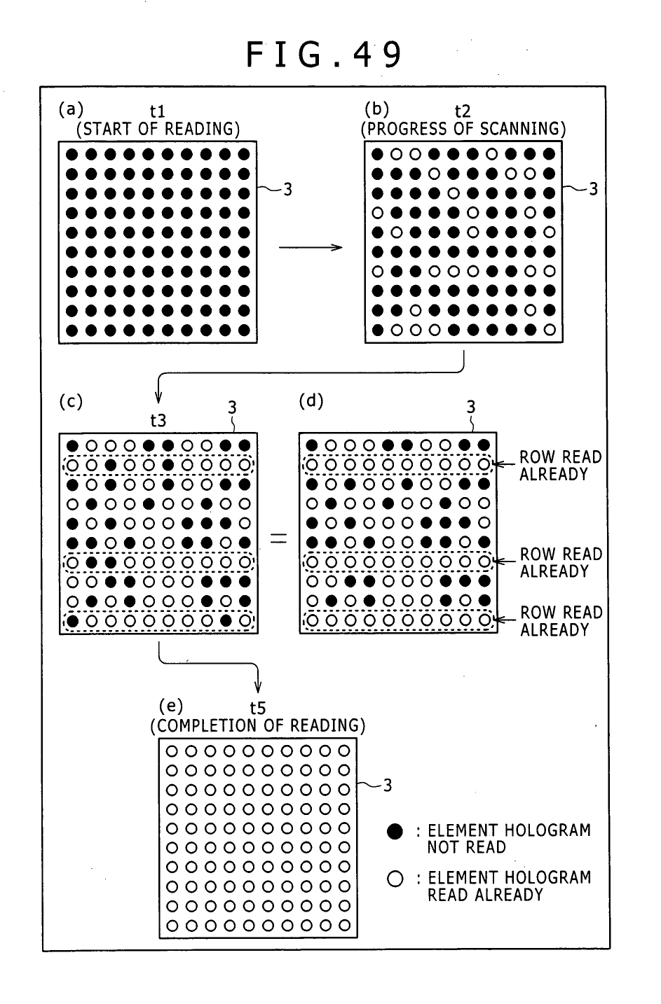

FIG. 49 illustrates a scanning progress situation. Here, it is assumed that one external parity block PB is formed from 10 element holograms in a unit of a row as seen in FIG. 46A and external parities POa, POb, POc, POd, POe, POf, POg, POh, POi, POj of a redundancy of 20% are added to the individual element holograms.

Similarly as in the cases of FIGS. 8A to 8D, reading of the element holograms is performed efficiently at the first stage from time t1 to time t2 after scanning is started as seen in FIGS. 49(a) and 49(b).

Here, it is assumed that such a reading situation as seen in FIG. 49(c) is exhibited at time t3. At this time, in three rows each surrounded by a broken line, eight element holograms of external parity blocks each composed of 10 element holograms are in a read state. Consequently, in those rows, the hologram unit data DTa of the remaining two element holograms can be restored using the external parities (POa, . . . , POj) extracted from the element holograms read already. Accordingly, with the reading state of FIG. 49(c), it can be determined that reading of all 10 element holograms of the three rows is completed as seen in FIG. 49(d).

Also after then, at a point of time at which reading of eight element holograms from among 10 element holograms in any row is completed successfully, it can be determined that reading of the 10 element holograms is completed. Therefore, a state of completion of reading of FIG. 49(e) can be reached rapidly. When compared with the case described hereinabove with reference to FIG. 48, element hologram reading in a situation wherein a small number of remaining non-read element holograms exist discretely and the reading efficiency is lowest can be eliminated. Consequently, the time before reading is completed can be reduced significantly.

It is to be noted that, while the foregoing description relates to an example wherein an external parity block PB is set for each row on the hologram memory 3 as seen in FIG. 46A, various setting examples of the external parity block PB may be possible. In each of FIGS. 46B, 46C, 46D, 46E and 46F, a broken line indicates element holograms which form an external parity block PB.

FIG. 46B shows an example wherein an external parity block PB is set for each column.

FIG. 46C shows an example wherein an external parity block PB is set to a group of all element holograms on the hologram memory 3.

FIG. 46D shows an example wherein an external parity block PB is set to a group of element holograms positioned by 3×3 in the vertical and horizontal directions.

FIG. 46E shows an example wherein an external parity block PB is set to a group of element holograms positioned by 5×2 in the vertical and horizontal directions.

FIG. 46F shows an example wherein an external parity block PB is set from a group of element holograms positioned by 2×5 in the vertical and horizontal directions.

In what manner an external parity block PB should be set may be determined taking various conditions such as the number and arrangement state of element holograms on the hologram memory 3, the scanning method to be adopted, the directionality of the scanning locus and a preferable redundancy into consideration.

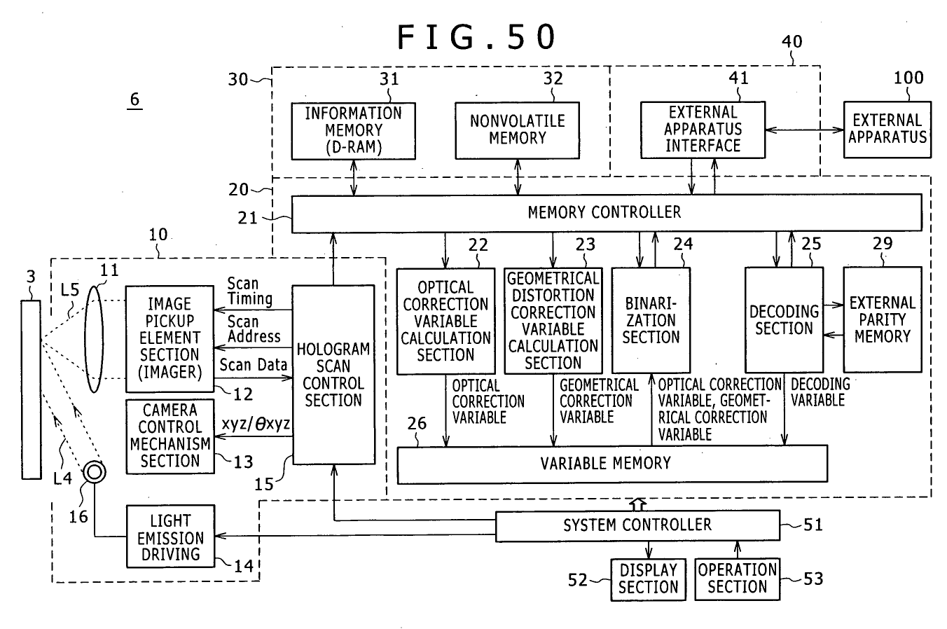

As the hologram reader 6 which performs decoding using such external parities as described above, an example of a fifth configuration of the hologram reader 6 is shown in FIG. 50. This corresponds to the first configuration example of FIG. 6 to which an external parity memory 29 is added. Like elements are denoted by like reference symbols, and description thereof is omitted.

The external parity memory 29 stores, when external parities are extracted by the decoding process of the decoding section 25, the external parities.

The decoding section 25 performs a decoding process and an error correction process for a binarized two-dimensional image signal, that is, data obtained from one element hologram to decode the original data. Further, the decoding section 25 transfers external parities extracted in the course of the decoding process to the external parity memory 29 so as to be stored into the external parity memory 29.

Further, after a predetermined amount of external parities in the external parity block PB is stored into the external parity memory 29, the decoding section 25 reads out the external parities and decodes hologram unit data regarding non-read element holograms in the external parity block PB.

The decoding section 25 passes the decoded data (readout data) to the memory controller 21. The memory controller 21 stores the readout data into the nonvolatile memory 32.

As two-dimensional image signals obtained from the element holograms of the hologram memory 3 are successively decoded by the decoding section 25 and cumulatively stored into the nonvolatile memory 32, original data recorded on the hologram memory 3, for example, AV content data, computer data or the like, are finally constructed on the nonvolatile memory 32.

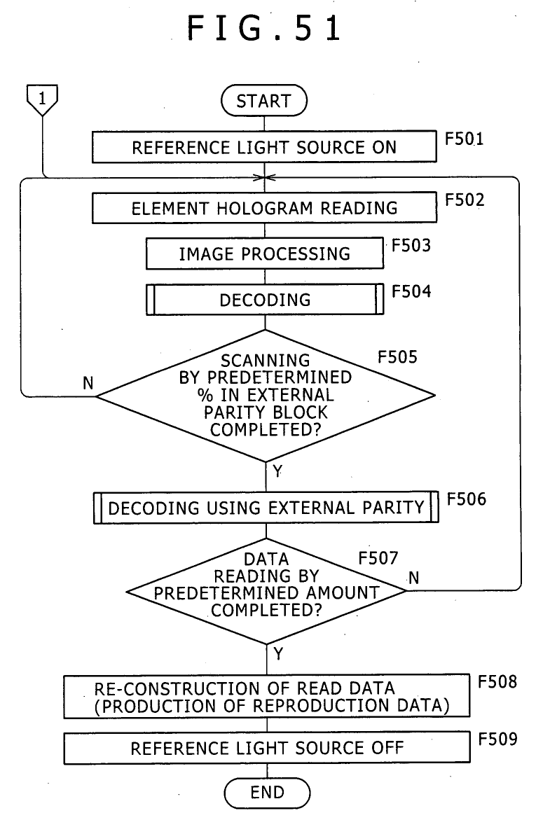

A process upon reproduction by the hologram reader 6 is described with reference to FIG. 51. FIG. 51 illustrates processes executed by the components of the configuration of FIG. 50 under the control of the system controller 51. However, steps F501, F502 and F503 are similar to steps F101, F102 and F103 of FIG. 7, respectively, and description thereof is omitted.

At step S504, a two-dimensional image signal binarized by the binarization section 24 is supplied to the decoding section 25, by which a decoding process such as decoding and error correction or the like is performed.

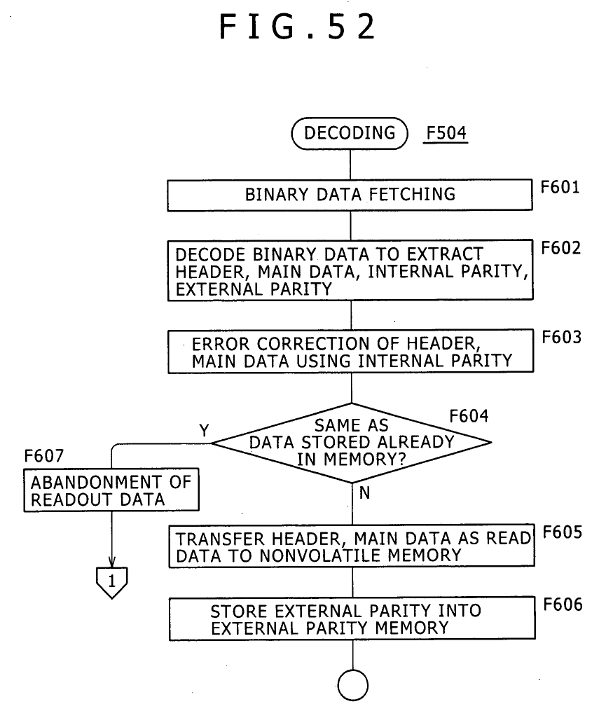

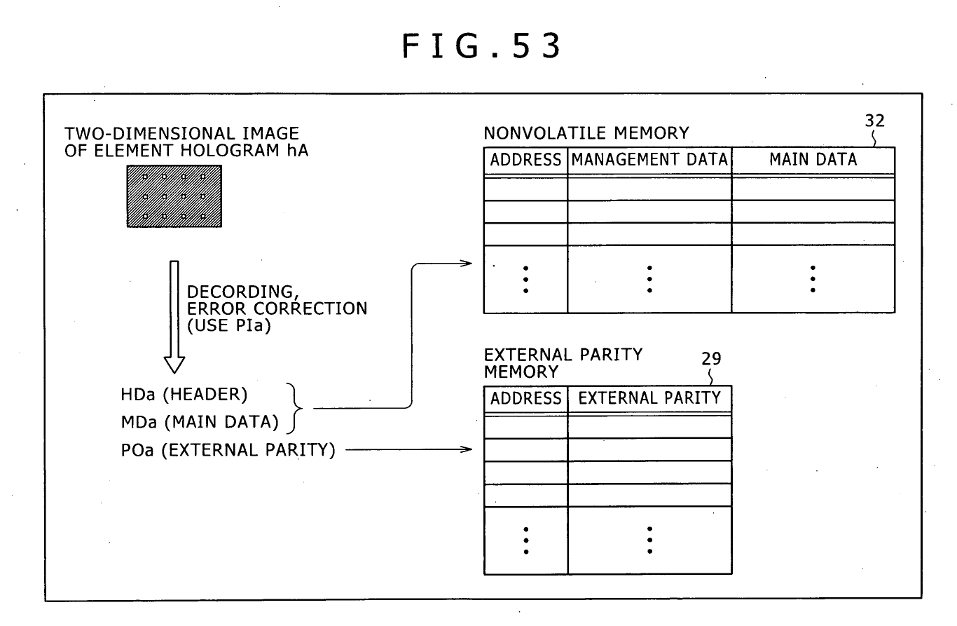

The decoding process at step F504 is described in detail with reference to FIGS. 52 and 53.

At step F601 of FIG. 52, the decoding section 25 fetches the signal binarized by the decoding section 25. In particular, the signal is a binary signal obtained by converting a two-dimensional image signal into a data stream of binary values of “1” and “0”.

At step F602, the decoding section 25 performs a decoding process for the binary signal to obtain data recorded as a two-dimensional image DP. If it is assumed that a header, main data and internal parities as hologram unit data are recorded and also external parities are recorded on an element hologram as described hereinabove with reference to FIG. 47, then data components as the header, main data, internal parities and external parities are extracted by the decoding process.

At step F603, the decoding section 25 uses the internal parities to perform an error correction process for the header and main data.

At step F604, the memory controller 21 decides whether or not data same as the header and the main data obtained by the processes at steps F602 and F603 of the decoding section 25 are stored already as readout data from an element hologram in the nonvolatile memory 32. Then, if the same readout data are stored already, then the memory controller 21 abandons, at step F607, the data decoded in the present cycle, whereafter the processing returns to step F502 of FIG. 51.

If it is decided at step F604 that the same readout data are not stored in the nonvolatile memory 32 as yet, then the memory controller 21 transfers, at step F605, the header and the main data after the error correction process as readout data from the element hologram to the nonvolatile memory 32 so as to be stored.

Further, at step F606, the decoding section 25 stores the external parities extracted by the decoding process into the external parity memory 29.

The decoding process at step F504 of FIG. 51 is ended therewith.

A flow of the decoding process at step F504 (F601 to F606) is schematically illustrated in FIG. 53. For example, if image pickup of the element hologram hA is performed and a binary signal of the same is supplied to the decoding section 25, then the header HDa, main data MDa, internal parities PIa and external parities POa are extracted by the decoding process. The header HDa and the main data MDa are error corrected using the internal parities PIa and then stored as decoded data into the nonvolatile memory 32. The nonvolatile memory 32 stores management data and the main data MDa based on an address information included in the header HD, for example, a data block number or the like. The management data is various kinds of information other than the address information in the header HD and includes, for example, a data block size, a total data size, a data block number, a data format and so forth.

Meanwhile, the external parities POa are stored into the external parity memory 29 together with address information included in the header HD. It is to be noted that, where the number of the external parity block PB is included in the header information, also the external parity block number is stored as an address.

After such a decoding process as described above is completed, then it is decided at step F505 of FIG. 51 whether or not scanning by a predetermined % is completed in the external parity block PB.

This is a decision of whether or not reading in of a predetermined number of element holograms of a certain external parity block PB is completed. For example, in a case wherein one external parity block PB is formed from 10 element holograms, if external parities of a redundancy of 20% are added to each element hologram, then the decision is a decision of whether or not reading of eight element holograms in the external parity block PB is completed.

This decision may be made referring to the external parity memory 29. For example, with regard to the element hologram whose external parities are extracted and stored into the external parity memory 29 at the immediately preceding step F504 and which is a processing object at present, the external parity block number in which the element hologram is included is discriminated first. The external parity block number can be discriminated, for example, from address information. Then, it is searched based on the address information how many external parities, which have been read out from the element holograms which belong to the same external parity block PB, are stored.

By searching the external parity memory 29 in this manner, it can be discriminated whether or not reading of a number of element holograms greater than the predetermined number is performed and an amount of external parities greater than the predetermined amount is stored already.

If it is decided at the point of time of step F505 that scanning of the predetermined number of element holograms in the certain external parity block PB is not completed, then the processing returns to step F502.

On the other hand, if it is decided at step F505 that scanning of the predetermined number of element holograms in the external parity block PB is completed, that is, reading of, for example, eight element holograms from among 10 external parity blocks PB is completed, then the decoding section 25 performs the decoding process at step F506.

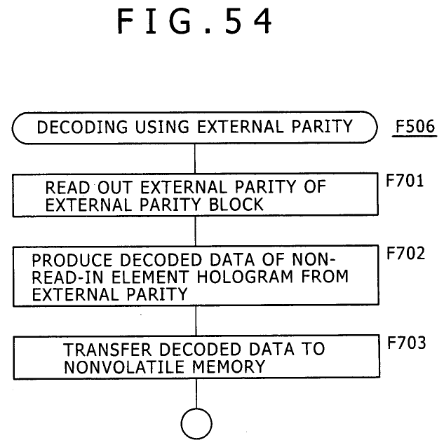

The decoding process at step F506 is a process of restoring hologram unit data of a non-read element hologram using external parities. An example of a detailed process at step F506 is illustrated in FIG. 54.

First at step F701, the decoding section 25 reads out the external parities stored as an external parity block PB with regard to which it is decided at step F505 that reading by the predetermined % is completed from the external parity memory 29.

At step F702, the decoding section 25 produces hologram unit data of non-read element holograms, that is, headers and main data, from the readout external parities and determines the hologram unit data as decoded data of the non-read element holograms. For example, where the external parities POa to POj are set as described hereinabove with reference to FIG. 47, hologram unit data of the non-read element holograms can be decoded.

At step F703, the decoding section 24 transfers the decoded data (header and main data) to the nonvolatile memory 32 through the memory controller 21 so as to be stored.

By such processes as just described, readout data of the non-read element holograms are produced using the external parities and are stored into the nonvolatile memory 32.

Then at step F507 of FIG. 51, it is decided whether or not the scanning is completed, that is, whether or not readout data of all element holograms are obtained.

The decision of completion of scanning at step F507 may be based on a decision of whether or not the entire original content data or the like recorded on the hologram memory 3 are stored successfully in the nonvolatile memory 32, and may be performed by a process same as that at step F109 of FIG. 7.

If it is not decided at step F507 that the scanning is completed, then the processing returns to step F501 so that the processes described above are repeated. In other words, the reproduction process regarding the other element holograms is successively executed similarly.

If it is decided at step F507 that the scanning is completed, that is, readout data of all element holograms are obtained, then the system controller 51 controls, at step F508, the memory controller 21 to re-construct the readout data stored in the nonvolatile memory 32 to produce reproduction data similarly as at step F112 of FIG. 7.

The reproduction data are thereafter transferred to the external apparatus 100 through the external apparatus interface 41 so that the user can use the reproduction data on the external apparatus 100.

Then, the system controller 51 ends the irradiation of the reproduction reference light L4 from the reference light source 16 at step F509.

By such a process as described above, information recorded on element holograms which are not used for image pickup can be decoded using external parities. Accordingly, even if reading scanning is not completed with regard to all element holograms on the hologram memory 3, content data or the like recorded on the hologram memory 3 can be obtained. Therefore, the required time for scanning can be reduced and rapid data acquisition from the hologram memory 3 can be implemented. Particularly where a system wherein element holograms are successively read from element holograms by manual scanning of a user, the reduction effect of the reading time is noticeable. Thus, the system is suitable for enhancement of the usability.

Although a manner of scanning where external parities are not added and a manner of scanning where external parities are added as in the present example are described with reference to FIGS. 48 and 49 and it is described that scanning can be completed rapidly in the case of the present example, reduction of the scanning time can actually be implemented in the following manner.

As an example, data tabulation was performed with regard to cases wherein external parities were added by 10% and 20% to element holograms.

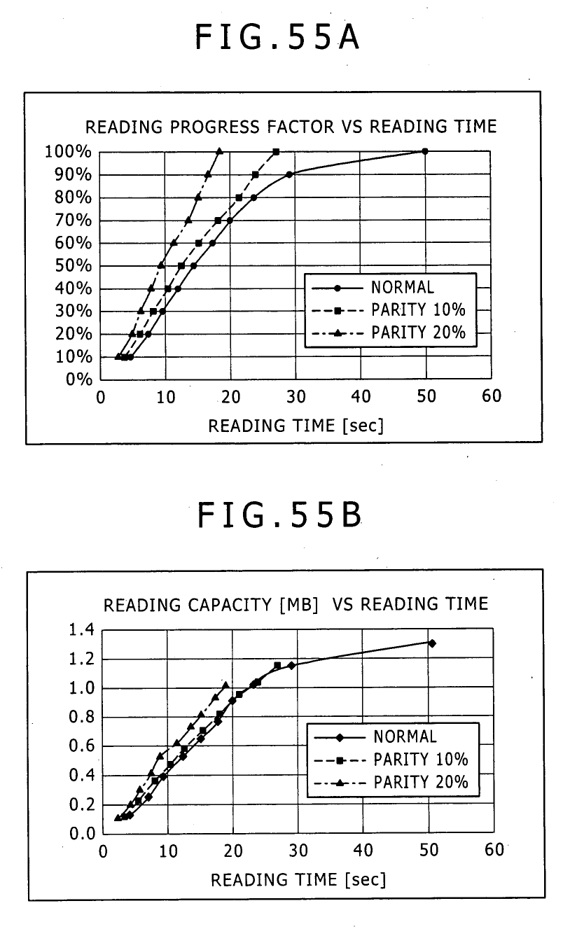

First, a relationship between the reading progress factor and the reading time is illustrated in FIG. 55A. A curve represented as “Normal” in the figure illustrates the relationship where external parities are not added, that is, the relationship in the case described hereinabove with reference to FIG. 48.

In this instance, around a timing at which the reading progress factor reaches 80%, the reading time becomes longer (the reading speed drops).

On the other hand, it can be recognized that, where external parities are added by 10% and 20%, data are read at a fixed reading speed from the top to the end of the reading. Therefore, the time required to read all element holograms can be reduced.

Further, a relationship between the reading capacity and the reading time is illustrated in FIG. 55B. Where external parities are added, the total capacity by which data can be recorded on the hologram memory decreases by an amount equal to that of the added external parities. However, the reading time can be reduced.

Where the reading time where external parities are added by 10% and the reading time in the Normal case (with no parities added) are compared with each other, for an initial period after scanning is started, data are read at a substantially equal pace in time. However, in the Normal case (with no parities added), the reading speed decreases considerably around 1.0 [MB] while, in the case of the external parities by 10%, the equal reading speed continues to the last end.

Meanwhile, in the case of the external parities by 20%, the reading speed itself is higher, and the reading speed continues to the last end similarly as in the case of the external parities by 10%. Consequently, it can be recognized that the reading efficiency where external parities are added is significantly higher than that where external parities are not added.

From the foregoing, as described hereinabove with reference to FIGS. 48 and 49, particularly according to the present example, the reading efficiency does not drop in the latter half of scanning. Accordingly, it is recognized that the scanning time can be reduced effectively when compared with an alternative case wherein external parities are not added.

It is to be noted that, although the foregoing effects are noticeable particularly in the case of manual scanning, also in the case of automatic scanning, the reduction effect of the scanning time by external parities can be achieved.

Also in the case of automatic scanning, since decoded data of all element programs can be obtained at a point of time at which reading of all element holograms in an external parity block PB is not performed, increase in efficiency of scanning can be achieved.

Furthermore, in both of the cases of manual scanning and automatic scanning, external parity blocks PB can be used not only to obtain decoded data of non-read element holograms but also to reproduce decoded data from element holograms with which an error occurs in decoding by some reason. Accordingly, even if a decoding error occurs, the element hologram need not be read in again. Also this is advantageous in increase in efficiency of scanning and reduction in time.

It is to be noted that, while the configuration example of FIG. 50 includes the external parity memory 29, it is otherwise possible to provide the independent external parity memory 29 but provide a region for storing external parities at part of the information memory 31 or the nonvolatile memory 32 such that the region is accessed by the decoding section 25.

Although various embodiments are described above, various modifications may be made to the recording data structure of element holograms of the hologram memory 3 and the configuration and the processing procedure of the hologram reader 6 described hereinabove in connection with the embodiments within the scope of the subject matter of the present invention.

1. A reproduction apparatus for reproducing, from a hologram recording medium on which imaged digital data are recorded as a plurality of element holograms in the form of interference fringes obtained by interference between object light of the digital data and recording reference light, comprising:
reference light irradiation means configured to irradiate reproduction reference light on the hologram recording medium;
readout means configured to detect a reproduction image obtained from the element holograms by the irradiation of the reproduction reference light and produce readout data based on the detected reproduction image;
storage means configured to store the readout data produced by said readout means;
discrimination means configured to discriminate whether or not storage of the readout data produced by said readout means into said storage means is to be permitted;
reproduction data production means configured to produce reproduction data from the readout data stored in said storage means; and
control means configured to control so that, where the storage of the readout data into said storage means is permitted by said discrimination means, the readout data are stored into said storage means and control said reproduction data production means to produce reproduction data from the readout data stored in said storage means.

2. The reproduction apparatus according to claim 1, wherein, where it is decided by said discrimination means that the readout data are not stored in said storage means as yet, said control means controls so that the readout data are stored into said storage means.

3. The reproduction apparatus according to claim 2,
wherein the readout data have predetermined discrimination information applied thereto, and
said discrimination means discriminates based on the discrimination information whether or not the readout data are readout data stored already in said storage means.

4. The reproduction apparatus according to claim 1,
wherein a user moves said reproduction apparatus to displace the relative position of said reproduction apparatus relative to the hologram recording medium so that the reproduction reference light is successively irradiated from said reference light irradiation means upon the hologram recording medium, and
it is discriminated by said discrimination means whether or not the storage of the readout data produced from a reproduction image of the element hologram upon which the reproduction reference light is irradiated into said storage means is to be permitted.

5. The reproduction apparatus according to claim 1, wherein each of the readout data has predetermined discrimination information applied thereto.

6. The reproduction apparatus according to claim 1, wherein the readout data include redundancy data such that different readout data can be produced based on the redundancy data of a plurality of ones of the readout data.

7. The reproduction apparatus according to claim 1, further comprising reproduction data production means configured to produce, where it is decided that the amount of the readout data stored in said storage means exceeds a predetermined amount, reproduction data based on the readout data stored in said storage means.

8. The reproduction apparatus according to claim 7,
wherein the readout data include redundancy data such that different readout data can be produced based on the redundancy data of a plurality of ones of the readout data, and
said reproduction apparatus further comprises readout data production means configured to produce different readout data based on the redundancy data of a plurality of ones of the redundancy data stored in said storage means and write the produced readout data into said storage means.

9. The reproduction apparatus according to claim 7, further comprising:
readout ratio calculation means configured to calculate a ratio of the readout data stored in said storage means to the predetermined amount with which the production of the reproduction data is to be started; and
presentation means configured to perform presentation based on a result of the calculation by said readout ratio calculation means.

10. The reproduction apparatus according to claim 7, further comprising display means configured to display a map of the hologram recording medium,
wherein said displaying means displaying the map on which substantial positions of the readout data stored in said storage means can be discriminated.

11. The reproduction apparatus according to claim 10, wherein a plurality of element holograms of the same data substance are recorded on the hologram recording medium, and
said display means displays the map on which also substantial positions of the element holograms, on which the same data as the readout data are recorded, can be discriminated.

12. The reproduction apparatus according to claim 1, further comprising error rate comparison means configured to compare the error rate of the readout data produced by said readout means and the error rate of the readout data stored already in said storage means,
wherein said discrimination means discriminating, based on a result of the comparison by said error rate comparison means, whether or not storage of the readout data produced by said readout means into said storage means is to be permitted.

13. The reproduction apparatus according to claim 1, wherein a plurality of element holograms of the same data substance are recorded on the hologram recording medium.

14. The reproduction apparatus according to claim 1, wherein the hologram recording medium has recorded thereon first element holograms which are formed using recording reference light irradiated at a first angle and second element holograms which are formed using recording reference light irradiated at a second angle, and
said reproduction apparatus further comprises reference light irradiation angle control means configured to change over the irradiation angle of the reproduction reference light by said reference light irradiation means between the first angle and the second angle, and besides
said readout means detects the reproduction image obtained from the first element holograms when the reproduction reference light of the first angle is irradiated from said reference light irradiation means, but detects the reproduction image obtained from the second element holograms when the reproduction reference light of the second angle is irradiated from said reference light irradiation means.

15. The reproduction apparatus according to claim 1, wherein the hologram recording medium has recorded thereon first element holograms which are formed using recording reference light irradiated at a first angle and second element holograms which are formed using recording reference light irradiated at a second angle,
said reproduction apparatus further comprises notification means configured to issue a notification for urging the user to change the irradiation angle of the reproduction reference light from said reference light irradiation means to the hologram recording medium,
wherein said reference light irradiation means being configured so as to irradiate the reproduction reference light at an angle, and
said readout means being operable to detect the reproduction image obtained from the first element holograms when the reproduction reference light of the first angle is irradiated from said reference light irradiation means, but detect the reproduction image obtained from the second element holograms when the reproduction reference light of the second angle is irradiated from said reference light irradiation means.

16. A reproduction method for reproducing, from a hologram recording medium on which imaged digital data are recorded as a plurality of element holograms in the form of interference fringes obtained by interference between object light of the digital data and recording reference light, comprising:
a step of irradiating reproduction reference light on the hologram recording medium;
a step of detecting a reproduction image obtained from the hologram recording medium by the irradiation of the reproduction reference light and producing readout data based on the detected reproduction image;
a step of discriminating whether or not storage of the produced readout data into a memory is to be permitted;
a step of storing the produced readout data into the memory when the storage into the memory is permitted; and
a step of producing reproduction data from the readout data stored in the memory.

17. The reproduction method according to claim 16, wherein, where it is decided that the readout data are not stored in the memory as yet, the readout data are stored into the memory.

18. The reproduction method according to claim 16, wherein, where it is decided that the amount of the readout data stored in the memory exceeds a predetermined amount, reproduction data are produced based on the readout data stored in the memory.

19. The reproduction method according to claim 16, wherein the readout data include redundancy data such that different readout data can be produced based on the redundancy data of a plurality of ones of the readout data, and
said reproduction method further comprises a step of producing different readout data based on the redundancy data of a plurality of ones of the readout data stored in the memory and writing the produced readout data into the memory.

20. A reproduction apparatus, wherein reproduction reference light is irradiated on a hologram recording medium on which imaged digital data are recorded as a plurality of element holograms in the form of interference fringes obtained by interference between object light of the digital data and recording reference light; a reproduction image obtained from the hologram recording medium by the irradiation of the reproduction reference light is detected; readout data are produced based on the detected reproduction image; the readout data are stored into a memory where there is the necessity to store the produced readout data into the memory; and, where a predetermined amount or more of the data is accumulated in the memory, reproduction data are produced from the readout data accumulated in said memory and then reproduced.
